(19) United States
(12) Patent Application Publication
(10) Pub. No.: US 2020/0144619 A1
(43) Pub. Date: May 7, 2020

(54) CARBON MATERIALS FOR IMPROVING PERFORMANCE OF LEAD ACID BATTERIES

(71) Applicant: BASF SE, Ludwigshafen (DE)

(72) Inventors: Phil Hamilton, Seattle, WA (US); Virginia Katherine Alspaugh, Seattle, WA (US); Adam Strong, Lake Forest Park, WA (US); Benjamin E. Kron, Seattle, WA (US); Aaron M. Feaver, Seattle, WA (US)

(21) Appl. No.: 16/561,879

(22) Filed: Sep. 5, 2019

Related U.S. Application Data
(60) Provisional application No. 62/727,359, filed on Sep. 5, 2018.
(60) Provisional application No. 62/826,503, filed on Mar. 29, 2019.

(51) Int. Cl. H01M 4/56; H01M 4/20; H01M 4/1393

(52) U.S. Cl. CPC H01M 4/56; H01M 2300/0011; H01M 4/1393; H01M 4/20

(57) ABSTRACT

A composition comprising a lead species (e.g., leady oxide, porous metallic lead, metallic lead, lead sulfate) a carbon material and an expander are described herein. Also disclosed are electrodes, devices (e.g., batteries) including the same. Methods for making and using the disclosed novel composition are also detailed herein.

### BACKGROUND

### Technical Field

The present application relates to compositions comprising carbon materials in lead acid batteries and other related energy storage systems. The compositions comprising the carbon materials disclosed herein have improved electrochemical properties. Also disclosed are methods for making and using the same.

### Description of the Related Art

In efforts to increase the electrochemical properties of lead-acid batteries, carbon has been added to negative active materials (NAM) during paste preparation in a variety of forms including carbon nanotubes, carbon black, and activated carbon. One drawback to adding carbon material is that if the carbon contains impurities may lead to undesirable gas evolution, water loss, and ultimately battery failure.

Conventional lead-acid energy storage devices employing carbon may provide some improvement and advantages over conventional lead-acid devices but suffer from limited active life, energy capacity and power performance. Negative electrodes often deteriorate upon multiple charge/discharge cycles resulting in reduced charge acceptance, increased battery resistance and loss of capacity. Additionally, low surface area in lead electrodes may limit the power performance and cycle life of conventional lead-acid batteries.

Although the need for improved carbon materials for use in lead-acid batteries has been recognized, there is an unmet need for carbon materials that overcome the aforementioned limitations while maintaining desirable or improved performance characteristics. The present disclosure fulfills these needs and provides further related advantages.

### BRIEF SUMMARY

In general terms, the current disclosure is directed to compositions comprising lead and carbon materials as well as devices for energy storage (e.g., batteries) that include the same. Applicant has discovered that the compositions provided by the present disclosure provide significant advantages over conventional lead acid batteries or other lead acid batteries that include carbon materials. Specifically, the compositions and batteries disclosed herein provide, among other superior qualities, better static charge acceptance, have a better hybrid pulse power profile, and reduced recharge times.

The carbon materials of the present disclosure are highly pure, have a high specific surface area, and high pore volume. Compositions of lead and carbon materials exhibit desirable electrochemical properties suitable for use in a variety of energy storage devices. The compositions of the present disclosure also comprise certain additives.

In particular, one embodiment provides a composition comprising leady oxide, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns and an expander.

Another embodiment provides a composition comprising porous metallic lead, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns and an expander.

Yet another embodiment provides a composition comprising metallic lead, lead sulfate, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns and an expander.

Electrodes and electrical energy storage devices comprising the disclosed compositions, and use of the disclosed compositions for storage and distribution of electrical energy is also provided (e.g., lead acid batteries and cells thereof).

These and other aspects of the invention will be apparent upon reference to the following detailed description. To this end, various references are set forth herein which describe in more detail certain background information, procedures, compounds and/or compositions, and are each hereby incorporated by reference in their entirety.

### BRIEF DESCRIPTION OF THE DRAWINGS

In the figures, identical reference numbers identify similar elements. The sizes and relative positions of elements in the figures are not necessarily drawn to scale and some of these elements are enlarged and positioned to improve figure legibility. Further, the particular shapes of the elements as drawn are not intended to convey any information regarding the actual shape of the particular elements, and have been solely selected for ease of recognition in the figures.

FIG. 1 shows current plotted against discharge time for cells including Carbon Material 1.

FIG. 2 shows the peak current after a constant voltage charging for cells prepared with Carbon Material 1 and Carbon Material 2.

FIG. 3 depicts the Hybrid Pulse Power Characterization (HPPC) test showing charge/discharge cycles as a cell prepared with Carbon Material 1 slowly discharges.

FIG. 4 shows charge and discharge power performance of various compositions comprising Carbon Material 1 (including variable concentrations of carbon black [N220] and polyaspartic acid [PAA]) across various states of charge.

FIGS. 5A and 5B show results for the Motive Recharge test for a cell prepared with Carbon Material 1.

FIG. 6 shows the end of discharge voltage and the maximum charge current across an increasing number of cycles for the High Rate Partial State of Charge (HRPSoC) test using a cell prepared with Carbon Material 1.

FIG. 7 displays results for a HRPSoC test for cells containing different concentrations of Carbon Material 1 and Carbon Material 2.

FIG. 8 illustrates the HRPSoC results testing charge times for devices with and without Carbon Material 1.

FIG. 9 shows a plot of the number of cycles vs. the net capacity for samples tested for frequency regulation with no added carbon material, having Carbon Material 1, and having Carbon Material 1 and polyaspartic acid.

FIG. 10 depicts results for the Motive Power Recharge Test for compositions with and without Carbon Material 1.

FIGS. 11A and 11B show how an increase in the concentration of Carbon Material 2 results in a corresponding increase in cycle life and overvoltage gassing currents.

FIG. 12 shows the electrode polarization for the constant current High Rate of Partial State of Charge test for electrodes prepared with and without Carbon Material 1.

FIG. 13 depicts the reference voltages for the CV-HRPSoC test for samples prepared with and without Carbon Material 1.

FIG. 14 shows the state of charge as a function of the number of cycles for Test Samples I-1 to I-6.

FIG. 15 illustrates Test Sample III-2's total voltage through one loop with 25 cycles followed by a capacity test starting at 70 hours.

FIG. 16 shows a recharge time and retained capacity plotted against the cycle number for Test Sample III-2.

FIGS. 17A and 17B illustrate electrode voltages for Test Sample III-2 measured by reference electrode for the first and last loop of motive cycling.

FIGS. 18A and 18B show the cycles per loop and discharge Ah per loop for Test Samples III-2 and III-3.

FIG. 19 illustrates the total Amp-hours discharged over the course of the Motive Cycle Test for Test Samples III-1 and III-2.

FIG. 20 shows the normalized maximum and minimum recharge times for Test Samples III-1 and III-2.

FIG. 21 shows the average retained capacity for Test Samples III-1 and III-2.

FIG. 22 depicts a plot of the PAM normalized capacity against the total number of cycles for samples containing Carbon Material 1, Agglomerated Carbon 1 and no carbon additives.

FIG. 23 illustrates the total voltage, current and % of capacity for cells with and without Carbon Material 1.

FIG. 24 gives the current during a static charge acceptance test over time with an inset showing the an initial current spike for samples prepared with and without Carbon Material 1.

FIG. 25 shows the motive recharge current and capacity for NAM cells prepared with and without Carbon Material 1.

FIG. 26 depicts the gassing from open circuit voltage to 2.7 V for cells containing NAMs with and without Carbon Material 1.

FIG. 27 shows a charge and discharge current profile for NAMs prepared with and without Carbon Material 1.

FIGS. 28A and 28B show cycle numbers plotted against recharge time and discharge voltage for NAMs prepared with and without Carbon Material 1.

FIGS. 29A and 29B provide the state of charge stabilization mechanism during the last step of the IEC 61427-2 protocol used for Frequency Regulation tests.

FIGS. 30A and 30B shows the total cell voltage during the Frequency Regulation testing (Unbalanced Version).

FIG. 31 shows the net capacity (top) and the calculated state of charge (bottom) for cells containing Test Samples V-1, V-2 and V-3.

FIG. 32 shows the extra recharge time required as a function of the cycle number for Test Sample V-1.

FIG. 33 shows a plot of the net capacity (upper panel) and the state of charge (lower panel) as a function of the number of cycles for Test Sample V-1.

FIGS. 34A, 34B and 34C are pictures of electrodes that have been cured (34A), formed (34B) and cycled (34C).

FIG. 35 shows the sample mass effect on incremental pore volumes for cured samples containing Carbon Material 1.

FIG. 36 shows the form factor effect on incremental pore volumes NAM containing Carbon Material 1.

FIG. 37 is an illustration showing the pore width as it relates to degassing parameters used to prepare NAM Test Samples VI-3, VI-4 and VI-5.

FIG. 38 shows a correlation between carbon loading and specific surface area (upper panel) and pore volumes (lower panel) of the resultant cured NAM.

FIG. 39 shows the incremental volume plotted against pore width for Test Samples VI-6-VI-11.

FIG. 40 shows specific surface area (upper panel) and pore volume (lower panel) of NAM with various carbon types at different loadings.

FIG. 41 provides a comparison of cured NAMs having 1.0 wt % of various carbon types.

FIG. 42 shows current, NAM voltage, PAM voltage and total voltage during a gassing scan at open circuit voltage for cells containing Carbon Material 1.

FIG. 43 show NAM voltage, PAM voltage, and total voltage for symmetric constant current HRPSoC testing of cells containing Carbon Material 1.

FIG. 44 show NAM voltage, PAM voltage, and total voltage for asymmetric constant current HRPSoC testing of cells containing Carbon Material 1

FIG. 45 show NAM voltage, PAM voltage, and total voltage for 60 second 2C discharge/60 second 2.4 V charge HRPSoC testing of cells containing Carbon Material 1.

FIG. 46 shows results for the experiment described in Example 8

FIGS. 47A and 47B show the retained cell capacity as a function of total drive time and cell voltage for a single discharge cycle, respectively, for cells prepared according to Example 9.

FIG. 48 depicts the drive time for a battery having a reduced weight.

### DETAILED DESCRIPTION

In the following description, certain specific details are set forth in order to provide a thorough understanding of various embodiments. However, one skilled in the art will understand that the invention may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

In the present description, any concentration range, percentage range, ratio range, or integer range is to be understood to include the value of any integer within the recited range and, when appropriate, fractions thereof (such as one tenth and one hundredth of an integer), unless otherwise indicated. Also, any number range recited herein relating to any physical feature, such as polymer subunits, size, or thickness, are to be understood to include any integer within the recited range, unless otherwise indicated. As used herein, the terms “about” and “approximately” mean±20%, ±10%, ±5% or ±1% of the indicated range, value, or structure, unless otherwise indicated. It should be understood that the terms “a” and “an” as used herein refer to “one or more” of the enumerated components. The use of the alternative (e.g., “or”) should be understood to mean either one, both, or any combination thereof of the alternatives.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

### Definitions

As used herein, and unless the context dictates otherwise, the following terms have the meanings as specified below.

“Absolute value” refers to the magnitude of a real number without regard to its sign. For example, a current of −5 mA/mg corresponds to an absolute value of 5 mA/mg.

“Carbon material” refers to a material or substance comprised substantially of carbon. Carbon materials include ultrapure as well as amorphous and crystalline carbon materials. Examples of carbon materials include, but are not limited to, activated carbon, pyrolyzed dried polymer gels, pyrolyzed polymer cryogels, pyrolyzed polymer xerogels, pyrolyzed polymer aerogels, activated dried polymer gels, activated polymer cryogels, activated polymer xerogels, activated polymer aerogels and the like.

“Amorphous” refers to a material, for example an amorphous carbon material, whose constituent atoms, molecules, or ions are arranged randomly without a regular repeating pattern. Amorphous materials may have some localized crystallinity (i.e., regularity) but lack long-range order of the positions of the atoms. Pyrolyzed and/or activated carbon materials are generally amorphous.

“Crystalline” refers to a material whose constituent atoms, molecules, or ions are arranged in an orderly repeating pattern. Examples of crystalline carbon materials include, but are not limited to, diamond and graphene.

“Synthetic” refers to a substance which has been prepared by chemical means rather than from a natural source. For example, a synthetic carbon material is one which is synthesized from precursor materials and is not isolated from natural sources.

“Impurity” or “impurity element” refers to an undesired foreign substance (e.g., a chemical element) within a material which differs from the chemical composition of the base material. For example, an impurity in a carbon material refers to any element or combination of elements, other than carbon, which is present in the carbon material. Impurity levels are typically expressed in parts per million (ppm).

“PIXE impurity” or “PIXE element” is any impurity element having an atomic number ranging from 11 to 92 (i.e., from sodium to uranium). The phrases “total PIXE impurity content” and “total PIXE impurity level” both refer to the sum of all PIXE impurities present in a sample, for example, a polymer gel or a carbon material. Electrochemical modifiers are not considered PIXE impurities as they are a desired constituent of the carbon materials. For example, in some embodiments an element may be intentionally added to a carbon material, for example lead, and will not be considered a PIXE impurity, while in other embodiments the same element may not be desired and, if present in the carbon material, will be considered a PIXE impurity. PIXE impurity concentrations and identities may be determined by proton induced x-ray emission (PIXE).

“TXRF impurity” or “TXRF element” refers to any impurity or any element as detected by total X-ray reflection fluorescence (TXRF). The phrases “total TXRF impurity content” and “total TXRF impurity level” both refer to the sum of all TXRF impurities present in a sample, for example, a polymer gel or a carbon material. Electrochemical modifiers are not considered TXRF impurities as they are a desired constituent of the carbon materials. For example, in some embodiments an element may be intentionally added to a carbon material, for example lead, and will not be considered a TXRF impurity, while in other embodiments the same element may not be desired and, if present in the carbon material, will be considered a TXRF impurity.

“Ultrapure” refers to a substance having a total PIXE impurity content or a total TXRF impurity content of less than 0.010%. For example, an “ultrapure carbon material” is a carbon material having a total PIXE impurity content of less than 0.010% or a total TXRF impurity content of less than 0.010% (i.e., 1000 ppm).

“Ash content” refers to the nonvolatile inorganic matter which remains after subjecting a substance to a high decomposition temperature. Herein, the ash content of a carbon material is calculated from the total PIXE impurity content as measured by proton induced x-ray emission or the total TXRF impurity content as measured by total X-ray reflection fluorescence, assuming that nonvolatile elements are completely converted to expected combustion products (i.e., oxides).

“Polymer” refers to a macromolecule comprised of two or more structural repeating units.

“Synthetic polymer precursor material” or “polymer precursor” refers to compounds used in the preparation of a synthetic polymer. Examples of polymer precursors that can be used in certain embodiments of the preparations disclosed herein include, but are not limited to, aldehydes (i.e., HC(═O)R, where R is an organic group), such as for example, methanal (formaldehyde); ethanal (acetaldehyde); propanal (propionaldehyde); butanal (butyraldehyde); glucose; benzaldehyde and cinnamaldehyde. Other exemplary polymer precursors include, but are not limited to, phenolic compounds such as phenol and polyhydroxy benzenes, such as dihydroxy or trihydroxy benzenes, for example, resorcinol (i.e., 1,3-dihydroxy benzene), catechol, hydroquinone, and phloroglucinol. Mixtures of two or more polyhydroxy benzenes are also contemplated within the meaning of polymer precursor.

“Monolithic” refers to a solid, three-dimensional structure that is not particulate in nature.

“Sol” refers to a colloidal suspension of precursor particles (e.g., polymer precursors), and the term “gel” refers to a wet three-dimensional porous network obtained by condensation or reaction of the precursor particles.

“Polymer gel” refers to a gel in which the network component is a polymer; generally a polymer gel is a wet (aqueous or non-aqueous based) three-dimensional structure comprised of a polymer formed from synthetic precursors or polymer precursors.

“Sol gel” refers to a sub-class of polymer gel where the polymer is a colloidal suspension that forms a wet three-dimensional porous network obtained by reaction of the polymer precursors.

“Polymer hydrogel” or “hydrogel” refers to a subclass of polymer gel or gel wherein the solvent for the synthetic precursors or monomers is water or mixtures of water and one or more water-miscible solvent.

“Carbon hydrogel” refers to a sub-class of a hydrogel wherein the synthetic polymer precursors are largely organic in nature.

“RF polymer hydrogel” refers to a sub-class of polymer gel wherein the polymer was formed from the catalyzed reaction of resorcinol and formaldehyde in water or mixtures of water and one or more water-miscible solvent.

“Acid” refers to any substance that is capable of lowering the pH of a solution. Acids include Arrhenius, Brønsted and Lewis acids. A “solid acid” refers to a dried or granular compound that yields an acidic solution when dissolved in a solvent. The term “acidic” means having the properties of an acid.

“Base” refers to any substance that is capable of raising the pH of a solution. Bases include Arrhenius, Brønsted and Lewis bases. A “solid base” refers to a dried or granular compound that yields basic solution when dissolved in a solvent. The term “basic” means having the properties of a base.

“Mixed solvent system” refers to a solvent system comprised of two or more solvents, for example, two or more miscible solvents. Examples of binary solvent systems (i.e., containing two solvents) include, but are not limited to: water and acetic acid; water and formic acid; water and propionic acid; water and butyric acid and the like. Examples of ternary solvent systems (i.e., containing three solvents) include, but are not limited to: water, acetic acid, and ethanol; water, acetic acid and acetone; water, acetic acid, and formic acid; water, acetic acid, and propionic acid; and the like. The present invention contemplates all mixed solvent systems comprising two or more solvents.

“Miscible” refers to the property of a mixture wherein the mixture forms a single phase over certain ranges of temperature, pressure, and composition.

“Catalyst” is a substance which alters the rate of a chemical reaction. Catalysts participate in a reaction in a cyclic fashion such that the catalyst is cyclically regenerated. The present disclosure contemplates catalysts which are sodium free. The catalyst used in the preparation of a ultrapure polymer gel as described herein can be any compound that facilitates the polymerization of the polymer precursors to form an ultrapure polymer gel. A “volatile catalyst” is a catalyst which has a tendency to vaporize at or below atmospheric pressure. Exemplary volatile catalysts include, but are not limited to, ammoniums salts, such as ammonium bicarbonate, ammonium carbonate, ammonium hydroxide, and combinations thereof. Generally such catalysts are used in the range of molar ratios of 10:1 to 2000:1 phenolic compound: catalyst. Typically, such catalysts can be used in the range of molar ratios of 20:1 to 200:1 phenolic compound: catalyst. For example, such catalysts can be used in the range of molar ratios of 25:1 to 100:1 phenolic compound: catalyst.

“Solvent” refers to a substance which dissolves or suspends reactants (e.g., ultrapure polymer precursors) and provides a medium in which a reaction may occur. Examples of solvents useful in the preparation of the gels, ultrapure polymer gels, ultrapure synthetic carbon materials and ultrapure synthetic amorphous carbon materials disclosed herein include, but are not limited to, water, alcohols and mixtures thereof. Exemplary alcohols include ethanol, t-butanol, methanol and mixtures thereof. Such solvents are useful for dissolution of the synthetic ultrapure polymer precursor materials, for example dissolution of a phenolic or aldehyde compound. In addition, in some processes such solvents are employed for solvent exchange in a polymer hydrogel (prior to freezing and drying), wherein the solvent from the polymerization of the precursors, for example, resorcinol and formaldehyde, is exchanged for a pure alcohol. In one embodiment of the present application, a cryogel is prepared by a process that does not include solvent exchange.

“Dried gel” or “dried polymer gel” refers to a gel or polymer gel, respectively, from which the solvent, generally water, or mixture of water and one or more water-miscible solvents, has been substantially removed.

“Pyrolyzed dried polymer gel” refers to a dried polymer gel which has been pyrolyzed but not yet activated, while an “activated dried polymer gel” refers to a dried polymer gel which has been activated.

“Cryogel” refers to a dried gel that has been dried by freeze drying.

“RF cryogel” refers to a dried gel that has been dried by freeze drying wherein the gel was formed from the catalyzed reaction of resorcinol and formaldehyde.

“Pyrolyzed cryogel” is a cryogel that has been pyrolyzed but not yet activated.

“Activated cryogel” is a cryogel which has been activated to obtain activated carbon material.

“Xerogel” refers to a dried gel that has been dried by air drying, for example, at or below atmospheric pressure.

“Pyrolyzed xerogel” is a xerogel that has been pyrolyzed but not yet activated.

“Activated xerogel” is a xerogel which has been activated to obtain activated carbon material.

“Aerogel” refers to a dried gel that has been dried by supercritical drying, for example, using supercritical carbon dioxide.

“Pyrolyzed aerogel” is an aerogel that has been pyrolyzed but not yet activated.

“Activated aerogel” is an aerogel which has been activated to obtain activated carbon material.

“Activate” and “activation” each refer to the process of heating a raw material or carbonized/pyrolyzed substance at an activation dwell temperature during exposure to oxidizing atmospheres (e.g., carbon dioxide, oxygen, steam or combinations thereof) to produce an “activated” substance (e.g., activated cryogel or activated carbon material). The activation process generally results in a stripping away of the surface of the particles, resulting in an increased surface area. Alternatively, activation can be accomplished by chemical means, for example, by impregnation of carbon-containing precursor materials with chemicals such as acids like phosphoric acid or bases like potassium hydroxide, sodium hydroxide or salts like zinc chloride, followed by carbonization. “Activated” refers to a material or substance, for example a carbon material, which has undergone the process of activation.

“Carbonizing”, “pyrolyzing”, “carbonization” and “pyrolysis” each refer to the process of heating a carbon-containing substance at a pyrolysis dwell temperature in an inert atmosphere (e.g., argon, nitrogen or combinations thereof) or in a vacuum such that the targeted material collected at the end of the process is primarily carbon. “Pyrolyzed” refers to a material or substance, for example a carbon material, which has undergone the process of pyrolysis.

“Dwell temperature” refers to the temperature of the furnace during the portion of a process which is reserved for maintaining a relatively constant temperature (i.e., neither increasing nor decreasing the temperature). For example, the pyrolysis dwell temperature refers to the relatively constant temperature of the furnace during pyrolysis, and the activation dwell temperature refers to the relatively constant temperature of the furnace during activation.

“Pore” refers to an opening or depression in the surface, or a tunnel in a carbon material, such as for example activated carbon, pyrolyzed dried polymer gels, pyrolyzed polymer cryogels, pyrolyzed polymer xerogels, pyrolyzed polymer aerogels, activated dried polymer gels, activated polymer cryogels, activated polymer xerogels, activated polymer aerogels and the like. A pore can be a single tunnel or connected to other tunnels in a continuous network throughout the structure.

“Pore structure” refers to the layout of the surface of the internal pores within a carbon material, such as an activated carbon material. Components of the pore structure include pore size, pore volume, surface area, density, pore size distribution and pore length. Generally the pore structure of activated carbon material comprises micropores and mesopores.

“Mesopore” generally refers to pores having a diameter between about 30 angstroms and about 300 angstroms while the term “micropore” refers to pores having a diameter less than about 30 angstroms. Mesoporous carbon materials comprise greater than 50% of their total pore volume in mesopores while microporous carbon materials comprise greater than 50% of their total pore volume in micropores.

“Mesopore volume” refers to the pore volume residing in mesopores. Likewise, “micropore volume” refers to the pore volume residing in micropores.

“Surface area” refers to the total specific surface area of a substance measurable by the BET technique. Surface area is typically expressed in units of m²/g. The BET (Brunauer/Emmett/Teller) technique employs an inert gas, for example nitrogen, to measure the amount of gas adsorbed on a material and is commonly used in the art to determine the accessible surface area of materials.

“Connected” when used in reference to mesopores and micropores refers to the spatial orientation of such pores.

“Effective length” refers to the portion of the length of the pore that is of sufficient diameter such that it is available to accept salt ions from the electrolyte.

“Electrode” refers to a conductor through which electricity enters or leaves an object, substance or region.

“Binder” refers to a material capable of holding individual particles of a substance (e.g., a carbon material) together such that after mixing a binder and the particles together the resulting mixture can be formed into sheets, pellets, disks or other shapes. Non-exclusive examples of binders include fluoro polymers, such as, for example, PTFE (polytetrafluoroethylene, Teflon), PFA (perfluoroalkoxy polymer resin, also known as Teflon), FEP (fluorinated ethylene propylene, also known as Teflon), ETFE (polyethylenetetrafluoroethylene, sold as Tefzel and Fluon), PVF (polyvinyl fluoride, sold as Tedlar), ECTFE (polyethylenechlorotrifluoroethylene, sold as Halar), PVDF (polyvinylidene fluoride, sold as Kynar), PCTFE (polychlorotrifluoroethylene, sold as Kel-F and CTFE), trifluoroethanol and combinations thereof.

“Leady oxide” refers to a mixture of lead oxide powder and metallic lead particles. Leady oxide may also be referred to as leady litharge or battery oxide and may include primary or secondary lead and may have varying degrees of purity. Leady oxide may be processed in a number of ways, including Barton or ball milling processes. Leady oxide may include orthorhombic PbO and tetragonal PbO.

“Porous metallic lead” refers to lead in elemental form (i.e., metallic lead) having any acceptable oxidation state (e.g., II or IV) having a pore structure.

“Lead sulfate” or “lead(II) sulfate” refers to a chemical compound with a chemical formula Pb SO₄ which is typically a white solid, appearing white in its microcrystalline form.

“Carbon black” refers to a material that is a paracrystalline carbon form having a particle size ranging from 0.02 to 0.35 microns (20 to 350 nm). Carbon black typically has a high surface area/volume ratio. Commercial carbon black may include, but is not limited to Agglomerated Carbon 2.

“Expander” refers to an additive used for adjusting the electrochemical and physical properties of a composition. Expander may include but is not limited to barium sulfate, strontium sulfate, lignin (e.g., synthetic lignin, naturally occurring lignin or combinations thereof), sulfonated naphthalene condensate,

A “C-rate” is a measure of the rate at which a cell or battery is discharged relative to its maximum capacity. For example, a 1C or 1/C rate means that a discharge current will be discharge the entire cell or battery in 1 hour. For a battery with a capacity of 100 Amp-hours (Ah), it would equate to a discharge current of 100 Amps.

“State of charge” or “SoC” refers to a cell or battery at a percentage of the cell or battery's total capacity. A cell or battery at a 30% state of charge would be charged to only 30% of that cell or battery's total capacity. For example, a cell or battery with a capacity of 100 Amp-hours at a 30% state of charge would mean the battery has a capacity of 30 Amp-hours. When a cell or battery has less than 100% SoC it is referred to as being in a “partial state of charge” or “PSoC” or a percentage of the state of charge (e.g., 30% state of charge).

“Inert” refers to a material that is not active in the electrolyte of an electrical energy storage device, that is it does not absorb a significant amount of ions or change chemically, e.g., degrade.

“Conductive” refers to the ability of a material to conduct electrons through transmission of loosely held valence electrons.

“Current collector” refers to a part of an electrical energy storage and/or distribution device which provides an electrical connection to facilitate the flow of electricity in to, or out of, the device. Current collectors often comprise metal and/or other conductive materials and may be used as a backing for electrodes to facilitate the flow of electricity to and from the electrode.

“Electrolyte” means a substance containing free ions such that the substance is electrically conductive. Electrolytes are commonly employed in electrical energy storage devices. Examples of electrolytes include, but are not limited to, sulfuric acid.

“Elemental form” refers to a chemical element having an oxidation state of zero (e.g., metallic lead).

“Oxidized form” form refers to a chemical element having an oxidation state greater than zero.

“Total Pore Volume” refers to single point nitrogen sorption.

“DFT Pore Volume” refers to pore volume within certain pore size ranges calculated by density functional theory from nitrogen sorption data.

“Charge acceptance” related specifically to lead acid battery and related systems, wherein “charge acceptance” generally refers to the quantity of charge passed during a potentiostatic hold.

“Cycle life” refers generally to the number of cycles of energy storage and discharge for a given energy storage system, for example a lead acid battery, between a upper and lower bounds of said device's energy storage capability, before exhibiting a undesirable drop in energy storage capability.

### A. Compositions—Lead, Carbon Black, Carbon Material and Expander

The present disclosure is directed to compositions comprising lead (e.g., leady oxide, porous metallic lead, metallic lead, lead sulfate, etc.), carbon materials, carbon black, and expander (e.g., lignin, BaSO₄) for use in lead acid electrodes and related battery systems. The carbon materials of the present disclosure provide certain electrochemical enhancements, including, but not limited to, increased charge acceptance, improved cycle life, increased recharge efficiency and lower recharge times compared to previously known compositions.

The compositions can be mixed together using a variety of methods known in the art, including mechanical mixing. Carbon material can be provided as a powder comprising carbon particles, and this powder can be blended with other components to create a mixture. Additionally, the composition can be combined with sulfuric acid and/or water to form a paste. Accordingly, in some embodiments, the composition further comprises water. In some embodiments, the composition further comprises sulfuric acid.

The mass or weight percent of carbon materials as a percentage of the total mass or weight of the composition can be varied from 0.01% to 99.9%. In other various embodiments, the mass or weight percent of carbon materials as a percentage of the total mass or weight of the composition can be varied from about 0.01% to about 20%, for example from about 0.1% to about 15%, from about 0.1% to about 10%, from about 0.5% to about 10%, from about 0.5% to about 9%, from about 0.5% to about 8%, from about 0.5% to about 7%, from about 0.5% to about 6%, from about 0.5% to about 5.0%, from about 0.5% to about 4.5%, from about 0.5% to about 4.0%, from about 0.5% to about 3.5%, from about 0.5% to about 3.0%, from about 0.5% to about 2.5%, from about 0.5% to about 2.0%, from about 0.5% to about 1.5% or from about 0.5% to about 1.0%. In some embodiments, the lower limit of the mass or weight percent of carbon materials as a percentage of the total mass or weight of the composition is about 0.1%, 0.2%, 0.3%, 0.5%, 0.75%, 1.0%, 1.5%, 2.0%, 2.5%, 3.0%, 3.5%, 4.0%, 4.5%, or 5.0%. In some embodiments, the upper limit of the mass or weight percent of carbon materials as a percentage of the total mass or weight of the composition is about 1.0%, 1.5%, 2.0%, 2.5%, 3.0%, 3.5%, 4.0%, 4.5%, 5.0%, 5.5%, 6%, 7%, 8%, 9%, 10%, 11%, 12%, 13%, 14%, 15%, 20%, 25%, 30%, 35%, 40%, 45%, 50%, 60%, 70%, 80%, 90%, or 99%.

In some embodiments, the lead species (i.e., leady oxide, porous metallic lead, metallic lead or lead sulfate) may include various types of lead. For example, the lead speciess may comprise elemental lead, oxidized lead and/or lead salts. In certain embodiments, the lead species comprise lead (II) oxide, lead (IV) oxide, lead acetate, lead carbonate, lead sulfate, lead orthoarsenate, lead pyroarsenate, lead bromide, lead caprate, lead carproate, lead caprylate, lead chlorate, lead chloride, lead fluoride, lead nitrate, lead oxychloride, lead orthophosphate sulfate, lead chromate, lead chromate, basic, lead ferrite, lead sulfide, lead tungstate or combinations thereof.

The compositions described herein may further comprise a solvent (e.g., electrolyte), a binder, or combinations thereof. In certain embodiments the compositions are in the form of a paste. The compositions can be prepared by admixing the carbon material, lead species, and expander. Compositions may optionally include solvent (e.g., electrolyte), binder, or combinations thereof. The density of the composition or paste may vary from about 2.0 g/cc to about 8 g/cc, from about 3.0 g/cc to about 7.0 g/cc or from about 4.0 g/cc to about 6.0 g/cc. In still other embodiments, the density of the composition is from about 3.5 g/cc to about 4.0 g/cc, from about 4.0 g/cc to about 4.5 g/cc, from about 4.5 g/cc to about 5.0 g/cc, from about 5.0 g/cc to about 5.5 g/cc, from about 5.5 g/cc to about 6.0 g/cc, from about 6.0 g/cc to about 6.5 g/cc, or from about 6.5 g/cc to about 7.0 g/cc. In some embodiments, the composition has a density greater than about 5 g/cc.

The purity of composition can contribute to the electrochemical performance of the same. In this regard, the purity is determined by methods known in the art. Exemplary methods to determine purity include PIXE analysis and TXRF. For the purpose of the current disclosure, impurities are described with respect to the composition excluding any lead or expander content. Below and through this disclosure, all descriptions of impurity apply to PIXE, TXRF, or other impurity method determinations as known in the art. In some embodiments, impurities are measures by PIXE. In other embodiments, impurities are measured by TXRF.

In some embodiments, the composition comprises a total impurity content of elements (excluding any lead and those contributed by the expander) of less than 500 ppm and an ash content (excluding any lead and those contributed by the expander) of less than 0.08%. In further embodiments, the composition comprises a total impurity content of all other elements of less than 300 ppm and an ash content of less than 0.05%. In other further embodiments, the composition comprises a total impurity content of all other elements of less than 200 ppm and an ash content of less than 0.05%. In other further embodiments, the composition comprises a total impurity content of all other elements of less than 200 ppm and an ash content of less than 0.025%. In other further embodiments, the composition comprises a total impurity content of all other elements of less than 100 ppm and an ash content of less than 0.02%. In other further embodiments, the composition comprises a total impurity content of all other elements of less than 50 ppm and an ash content of less than 0.01%.

The amount of individual impurities present in the disclosed compositions can be determined by proton induced x-ray emission. Individual impurities may contribute in different ways to the overall electrochemical performance of the disclosed compositions. Thus, in some embodiments, the level of sodium present in the composition is less than 1000 ppm, less than 500 ppm, less than 100 ppm, less than 50 ppm, less than 10 ppm, or less than 1 ppm. In some embodiments, the level of magnesium present in the composition is less than 1000 ppm, less than 100 ppm, less than 50 ppm, less than 10 ppm, or less than 1 ppm. In some embodiments, the level of aluminum present in the composition is less than 1000 ppm, less than 100 ppm, less than 50 ppm, less than 10 ppm, or less than 1 ppm. In some embodiments, the level of silicon present in the composition is less than 500 ppm, less than 300 ppm, less than 100 ppm, less than 50 ppm, less than 20 ppm, less than 10 ppm or less than 1 ppm. In some embodiments, the level of phosphorous present in the composition is less than 1000 ppm, less than 100 ppm, less than 50 ppm, less than 10 ppm, or less than 1 ppm. In some embodiments, the level of sulfur present in the composition is less than 1000 ppm, less than 100 ppm, less than 50 ppm, less than 30 ppm, less than 10 ppm, less than 5 ppm or less than 1 ppm. In some embodiments, the level of chlorine present in the composition is less than 1000 ppm, less than 100 ppm, less than 50 ppm, less than 10 ppm, or less than 1 ppm. In some embodiments, the level of potassium present in the composition is less than 1000 ppm, less than 100 ppm, less than 50 ppm, less than 10 ppm, or less than 1 ppm. In other embodiments, the level of calcium present in the composition is less than 100 ppm, less than 50 ppm, less than 20 ppm, less than 10 ppm, less than 5 ppm or less than 1 ppm. In some embodiments, the level of chromium present in the composition is less than 1000 ppm, less than 100 ppm, less than 50 ppm, less than 10 ppm, less than 5 ppm, less than 4 ppm, less than 3 ppm, less than 2 ppm or less than 1 ppm. In other embodiments, the level of iron present in the composition is less than 50 ppm, less than 20 ppm, less than 10 ppm, less than 5 ppm, less than 4 ppm, less than 3 ppm, less than 2 ppm or less than 1 ppm. In other embodiments, the level of nickel present in the composition is less than 20 ppm, less than 10 ppm, less than 5 ppm, less than 4 ppm, less than 3 ppm, less than 2 ppm or less than 1 ppm. In some other embodiments, the level of copper present in the composition is less than 140 ppm, less than 100 ppm, less than 40 ppm, less than 20 ppm, less than 10 ppm, less than 5 ppm, less than 4 ppm, less than 3 ppm, less than 2 ppm or less than 1 ppm. In yet other embodiments, the level of zinc present in the composition is less than 20 ppm, less than 10 ppm, less than 5 ppm, less than 2 ppm or less than 1 ppm. In yet other embodiments, the sum of all other impurities (excluding the lead and those contributed by the expander) present in the composition is less than 1000 ppm, less than 500 pm, less than 300 ppm, less than 200 ppm, less than 100 ppm, less than 50 ppm, less than 25 ppm, less than 10 ppm or less than 1 ppm. As noted above, in some embodiments other impurities such as hydrogen, oxygen and/or nitrogen may be present in levels ranging from less than 10% to less than 0.01%.

In some embodiments, the composition comprises undesired impurities near or below the detection limit of the proton induced x-ray emission analysis. For example, in some embodiments the composition comprises less than 50 ppm sodium, less than 15 ppm magnesium, less than 10 ppm aluminum, less than 8 ppm silicon, less than 4 ppm phosphorous, less than 3 ppm sulfur, less than 3 ppm chlorine, less than 2 ppm potassium, less than 3 ppm calcium, less than 2 ppm scandium, less than 1 ppm titanium, less than 1 ppm vanadium, less than 0.5 ppm chromium, less than 0.5 ppm manganese, less than 0.5 ppm iron, less than 0.25 ppm cobalt, less than 0.25 ppm nickel, less than 0.25 ppm copper, less than 0.5 ppm zinc, less than 0.5 ppm gallium, less than 0.5 ppm germanium, less than 0.5 ppm arsenic, less than 0.5 ppm selenium, less than 1 ppm bromine, less than 1 ppm rubidium, less than 1.5 ppm strontium, less than 2 ppm yttrium, less than 3 ppm zirconium, less than 2 ppm niobium, less than 4 ppm molybdenum, less than 4 ppm, technetium, less than 7 ppm rubidium, less than 6 ppm rhodium, less than 6 ppm palladium, less than 9 ppm silver, less than 6 ppm cadmium, less than 6 ppm indium, less than 5 ppm tin, less than 6 ppm antimony, less than 6 ppm tellurium, less than 5 ppm iodine, less than 4 ppm cesium, less than 4 ppm barium, less than 3 ppm lanthanum, less than 3 ppm cerium, less than 2 ppm praseodymium, less than 2 ppm, neodymium, less than 1.5 ppm promethium, less than 1 ppm samarium, less than 1 ppm europium, less than 1 ppm gadolinium, less than 1 ppm terbium, less than 1 ppm dysprosium, less than 1 ppm holmium, less than 1 ppm erbium, less than 1 ppm thulium, less than 1 ppm ytterbium, less than 1 ppm lutetium, less than 1 ppm hafnium, less than 1 ppm tantalum, less than 1 ppm tungsten, less than 1.5 ppm rhenium, less than 1 ppm osmium, less than 1 ppm iridium, less than 1 ppm platinum, less than 1 ppm silver, less than 1 ppm mercury, less than 1 ppm thallium, less than 1.5 ppm bismuth, less than 2 ppm thorium, or less than 4 ppm uranium.

In some specific embodiments, the composition comprises less than 100 ppm sodium, less than 300 ppm silicon, less than 50 ppm sulfur, less than 100 ppm calcium, less than 20 ppm iron, less than 10 ppm nickel, less than 140 ppm copper, less than 5 ppm chromium and less than 5 ppm zinc as measured by proton induced x-ray emission. In other specific embodiments, the composition comprises less than 50 ppm sodium, less than 30 ppm sulfur, less than 100 ppm silicon, less than 50 ppm calcium, less than 10 ppm iron, less than 5 ppm nickel, less than 20 ppm copper, less than 2 ppm chromium and less than 2 ppm zinc.

In other specific embodiments, the composition comprises less than 50 ppm sodium, less than 50 ppm silicon, less than 30 ppm sulfur, less than 10 ppm calcium, less than 2 ppm iron, less than 1 ppm nickel, less than 1 ppm copper, less than 1 ppm chromium and less than 1 ppm zinc.

In some other specific embodiments, the composition comprises less than 100 ppm sodium, less than 50 ppm magnesium, less than 50 ppm aluminum, less than 10 ppm sulfur, less than 10 ppm chlorine, less than 10 ppm potassium, less than 1 ppm chromium and less than 1 ppm manganese.

In other embodiments, the composition comprises less than 5 ppm chromium, less than 10 ppm iron, less than 5 ppm nickel, less than 20 ppm silicon, less than 5 ppm zinc, and bismuth, silver, copper, mercury, manganese, platinum, antimony and tin are not detected as measured by proton induced x-ray emission.

In other embodiments, the composition comprises less than 75 ppm bismuth, less than 5 ppm silver, less than 10 ppm chromium, less than 30 ppm copper, less than 30 ppm iron, less than 5 ppm mercury, less than 5 ppm manganese, less than 20 ppm nickel, less than 5 ppm platinum, less than 10 ppm antimony, less than 100 ppm silicon, less than 10 ppm tin and less than 10 ppm zinc as measured by proton induced x-ray emission.

In other embodiments, the composition comprises less than 5 ppm chromium, 10 ppm iron, less than 5 ppm nickel, less than 20 ppm silicon, less than 5 ppm zinc and bismuth, silver, copper, mercury, manganese, platinum, antimony and tin are not detected as measured by proton induced x-ray emission as measured by proton induced x-ray emission.

In some embodiments, the carbon material comprises less than 30 ppm iron, less than 30 ppm copper, less than 20 ppm nickel, less than 20 ppm manganese, and less than 10 ppm chlorine as determined by TXRF. In some embodiments, the carbon material has a total impurity content of less than 1000 ppm as determined by TXRF. In some embodiments, the carbon material has a total impurity content of less than 500 ppm as determined by TXRF. In some embodiments, the carbon material has a total impurity content of less than 300 ppm as determined by TXRF. In certain embodiments, the carbon material has a total impurity content of less than 200 ppm as determined by TXRF. In some embodiments, the carbon material has a total impurity content of less than 100 ppm as determined by TXRF. In some embodiments, the impurities are elements having an atomic number ranging from 11 to 92. In certain specific embodiments, the ash content of the carbon material is less than 0.03% as calculated from total reflection x-ray fluorescence. In some embodiments, the ash content of the carbon material is less than 0.01% as calculated from total reflection x-ray fluorescence.

### B. Carbon Materials

Certain embodiments of the present disclosure provide carbon material comprising an optimized pore size distribution, desirable surface area, and/or particle sizes. These characteristics contribute to the superior performance of lead acid batteries comprising the carbon materials. For example, in some embodiments, the carbon material comprises an optimized blend of micropores and mesopores, a relatively high surface area and optimum particle size.

Purity is also a parameter that accounts for high performance of the carbon materials in the compositions detailed herein. Thus, in other embodiments, the carbon material comprises a total of less than 500 ppm of all elements having atomic numbers ranging from 11 to 92, as measured by total reflection x-ray fluorescence (TXRF). The high purity, optimized micropore/mesopore distribution, surface area, and particle size make the carbon materials ideal for use in lead pastes (i.e., to be incorporated into lead acid batteries). Advantageously, embodiments disclosed herein provide compositions comprising such carbon materials having high purity, optimized micropore/mesopore distributions, desirable high surface area and relatively large particle sizes.

Additionally, the carbon material may provide other characteristics that are advantageous when incorporated in to the compositions of this disclosure. For example, in certain embodiments, nitrogen or a functional group containing nitrogen is present on an edge site, for example a graphitic edge plane or other defect present in the carbon surface. In certain embodiments, the carbon material has less than 10% nitrogen content, for example less than about 5% nitrogen content, less than about 3% nitrogen content, less than about 2% nitrogen content, less than about 1% nitrogen content, less than about 0.5% nitrogen content, less than about 0.3% nitrogen content, less than about 0.2% nitrogen content, less than about 0.1% nitrogen content, less than about 0.05% nitrogen content, less than about 0.02% nitrogen content, less than about 0.01% nitrogen content.

In some embodiments, the surface functionality of the carbon material can be ascertained by and related to pH. For such embodiments, the pH of the carbon can be greater than pH 6.0, greater than pH 7.0, greater than pH 8.0, greater than pH 9.0, greater than pH 10.0, greater than pH 11.0.

In certain embodiments, the carbon material exhibits a pH between pH 6.0 and pH 11.0, between pH 6.0 and pH 10.0, between pH 7.0 and pH 9.0, between pH 8.0 and pH 10.0, between pH 7.0 and pH 9.0, or between pH 8.0 and pH 9.0.

In some embodiments, the carbon material is hydrophobic (e.g., having a non-polar surface area). The extent of hydrophobicity can be measured by methods known in the art, for example by calorimetry coupled with n-butanol adsorption. The non-polar surface area of the carbon can be varied, for example, the total surface area can comprise a non-polar surface greater than 30%, greater than 40%, greater than 50%, greater than 60%, greater than 70%, greater than 80%, or greater than 90% of the total surface area.

The disclosed methods produce carbon materials comprising specific micropore structure, which is typically described in terms of fraction (percent) of total pore volume residing in either micropores or mesopores or both. Accordingly, in some embodiments the pore structure of the carbon materials comprises from 10% to 90% micropores. In some other embodiments the pore structure of the carbon materials comprises from 20% to 80% micropores. In other embodiments, the pore structure of the carbon materials comprises from 30% to 70% micropores. In other embodiments, the pore structure of the carbon materials comprises from 40% to 60% micropores. In other embodiments, the pore structure of the carbon materials comprises from 40% to 50% micropores. In other embodiments, the pore structure of the carbon materials comprises from 43% to 47% micropores. In certain embodiments, the pore structure of the carbon materials comprises about 45% micropores.

In some other embodiments the pore structure of the carbon materials comprises from 20% to 50% micropores. In still other embodiments the pore structure of the carbon materials comprises from 20% to 40% micropores, for example from 25% to 35% micropores or 27% to 33% micropores. In some other embodiments, the pore structure of the carbon materials comprises from 30% to 50% micropores, for example from 35% to 45% micropores or 37% to 43% micropores. In some certain embodiments, the pore structure of the carbon materials comprises about 30% micropores or about 40% micropores.

In one particular embodiment, the carbon materials have a pore structure comprising micropores, mesopores and a total pore volume, and wherein from 20% to 90% of the total pore volume resides in micropores, from 10% to 80% of the total pore volume resides in mesopores and less than 10% of the total pore volume resides in pores greater than 30 nm. For example, from 20% to 90%, from 25% to 80%, from 25% to 75%, from 25% to 70%, from 25% to 60%, from 27% to 55% of the total pore volume resides in micropores (e.g., about 30% or about 50%). In some embodiments, from 10% to 75%, from 20% to 75%, from 30% to 75%, from 40% to 75%, from 45% to 75% or from 47% to 75% of the total pore volume resides in mesopores (e.g., about 70% or about 50%).

In some other embodiments the pore structure of the carbon materials comprises from 40% to 90% micropores. In still other embodiments the pore structure of the carbon materials comprises from 45% to 90% micropores, for example from 55% to 85% micropores. In some other embodiments, the pore structure of the carbon materials comprises from 65% to 85% micropores, for example from 75% to 85% micropores or 77% to 83% micropores. In yet other embodiments the pore structure of the carbon materials comprises from 65% to 75% micropores, for example from 67% to 73% micropores. In some certain embodiments, the pore structure of the carbon materials comprises about 80% micropores or about 70% micropores.

The mesoporosity of the carbon materials contributes to high ion mobility and low resistance. In some embodiments, the pore structure of the carbon materials comprises from 10% to 90% mesopores. In some other embodiments, the pore structure of the carbon materials comprises from 20% to 80% mesopores. In other embodiments, the pore structure of the carbon materials comprises from 30% to 70% mesopores. In other embodiments, the pore structure of the carbon materials comprises from 40% to 60% mesopores. In other embodiments, the pore structure of the carbon materials comprises from 50% to 60% mesopores. In other embodiments, the pore structure of the carbon materials comprises from 53% to 57% mesopores. In other embodiments, the pore structure of the carbon materials comprises about 55% mesopores.

In some other embodiments the pore structure of the carbon materials comprises from 50% to 80% mesopores. In still other embodiments the pore structure of the carbon materials comprises from 60% to 80% mesopores, for example from 65% to 75% mesopores or 67% to 73% mesopores. In some other embodiments, the pore structure of the carbon materials comprises from 50% to 70% mesopores, for example from 55% to 65% mesopores or 57% to 53% mesopores. In some certain embodiments, the pore structure of the carbon materials comprises about 30% mesopores or about 40% mesopores.

In some other embodiments the pore structure of the carbon materials comprises from 10% to 60% mesopores. In some other embodiments the pore structure of the carbon materials comprises from 10% to 55% mesopores, for example from 15% to 45% mesopores or from 15% to 40% mesopores. In some other embodiments, the pore structure of the carbon materials comprises from 15% to 35% mesopores, for example from 15% to 25% mesopores or from 17% to 23% mesopores. In some other embodiments, the pore structure of the carbon materials comprises from 25% to 35% mesopores, for example from 27% to 33% mesopores. In some certain embodiments, the pore structure of the carbon materials comprises about 20% mesopores and in other embodiments the carbon materials comprise about 30% mesopores.

In some embodiments the pore structure of the carbon materials comprises from 10% to 90% micropores and from 10% to 90% mesopores. In some other embodiments the pore structure of the carbon materials comprises from 20% to 80% micropores and from 20% to 80% mesopores. In other embodiments, the pore structure of the carbon materials comprises from 30% to 70% micropores and from 30% to 70% mesopores. In other embodiments, the pore structure of the carbon materials comprises from 40% to 60% micropores and from 40% to 60% mesopores. In other embodiments, the pore structure of the carbon materials comprises from 40% to 50% micropores and from 50% to 60% mesopores. In other embodiments, the pore structure of the carbon materials comprises from 43% to 47% micropores and from 53% to 57% mesopores. In other embodiments, the pore structure of the carbon materials comprises about 45% micropores and about 55% mesopores.

In still other embodiments, the pore structure of the carbon materials comprises from 40% to 90% micropores and from 10% to 60% mesopores. In other embodiments, the pore structure of the carbon materials comprises from 45% to 90% micropores and from 10% to 55% mesopores. In other embodiments, the pore structure of the carbon materials comprises from 40% to 85% micropores and from 15% to 40% mesopores. In yet other embodiments, the pore structure of the carbon materials comprises from 55% to 85% micropores and from 15% to 45% mesopores, for example from 65% to 85% micropores and from 15% to 35% mesopores. In other embodiments, the pore structure of the carbon materials comprises from 65% to 75% micropores and from 15% to 25% mesopores, for example from 67% to 73% micropores and from 27% to 33% mesopores In some other embodiments, the pore structure of the carbon materials comprises from 75% to 85% micropores and from 15% to 25% mesopores, for example from 83% to 77% micropores and from 17% to 23% mesopores. In other certain embodiments, the pore structure of the carbon materials comprises about 80% micropores and about 20% mesopores, or in other embodiments, the pore structure of the carbon materials comprises about 70% micropores and about 30% mesopores.

In still other embodiments, the pore structure comprises from 20% to 50% micropores and from 50% to 80% mesopores. For example, in some embodiments, from 20% to 40% of the total pore volume resides in micropores and from 60% to 80% of the total pore volume resides in mesopores. In other embodiments, from 25% to 35% of the total pore volume resides in micropores and from 65% to 75% of the total pore volume resides in mesopores. For example, in some embodiments about 30% of the total pore volume resides in micropores and about 70% of the total pore volume resides in mesopores.

In still other embodiments, from 30% to 50% of the total pore volume resides in micropores and from 50% to 70% of the total pore volume resides in mesopores. In other embodiments, from 35% to 45% of the total pore volume resides in micropores and from 55% to 65% of the total pore volume resides in mesopores. For example, in some embodiments, about 40% of the total pore volume resides in micropores and about 60% of the total pore volume resides in mesopores.

In other variations of any of the foregoing methods, the carbon materials do not have a substantial volume of pores greater than 30 nm. For example, in certain embodiments the carbon materials comprise less than 50%, less than 40%, less than 30%, less than 25%, less than 20%, less than 15%, less than 10%, less than 5%, less than 2.5% or even less than 1% of the total pore volume in pores greater than 30 nm.

In some embodiments, the carbon materials have a porosity that contributes to their enhanced electrochemical performance. Accordingly, in one embodiment, the carbon material comprises a pore volume residing in pores less than 30 angstroms of at least 1.8 cc/g, at least 1.2 cc/g, at least 0.6 cc/g, at least 0.30 cc/g, at least 0.25 cc/g, at least 0.20 cc/g or at least 0.15 cc/g. In other embodiments, the carbon material comprises a pore volume residing in pores greater than 30 angstroms of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g, or at least 0.5 cc/g.

In other embodiments, the carbon material comprises a pore volume of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g or at least 0.50 cc/g for pores ranging from 30 angstroms to 300 angstroms.

In yet other embodiments, the carbon materials comprise a total pore volume of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g, at least 0.60 cc/g, at least 0.55 cc/g, at least 0.50 cc/g, at least 0.45 cc/g, at least 0.40 cc/g, at least 0.35 cc/g, at least 0.30 cc/g, at least 0.25 cc/g or at least 0.20 cc/g.

In one embodiment the carbon material comprises a pore volume of at least 0.35 cc/g, at least 0.30 cc/g, at least 0.25 cc/g, at least 0.20 cc/g or at least 0.15 cc/g for pores less than 30 angstroms. In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores greater than 30 angstroms.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 30 angstroms to 500 angstroms.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 30 angstroms to 1000 angstroms.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 30 angstroms to 2000 angstroms.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 30 angstroms to 5000 angstroms.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 30 angstroms to 1 micron.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 30 angstroms to 2 microns.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 30 angstroms to 3 microns.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 30 angstroms to 4 microns.

In other embodiments, the carbon material comprises a pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g for pores ranging from 30 angstroms to 5 microns.

In yet other embodiments, the carbon material comprises a total pore volume of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g.

In other embodiments, the carbon material comprises a pore volume (e.g., mesopore volume) of at least 7 cc/g, at least 5 cc/g, at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.0 cc/g, at least 0.8 cc/g, at least 0.6 cc/g, at least 0.4 cc/g, at least 0.2 cc/g, at least 0.1 cc/g.

In yet other embodiments, the carbon materials comprise a pore volume residing in pores of less than 30 angstroms of at least 0.2 cc/g and a pore volume residing in pores of between 30 and 300 angstroms of at least 0.8 cc/g. In yet other embodiments, the carbon materials comprise a pore volume residing in pores of less than 30 angstroms of at least 0.5 cc/g and a pore volume residing in pores of between 30 and 300 angstroms of at least 0.5 cc/g. In yet other embodiments, the carbon materials comprise a pore volume residing in pores of less than 30 angstroms of at least 0.6 cc/g and a pore volume residing in pores of between 30 and 300 angstroms of at least 2.4 cc/g. In yet other embodiments, the carbon materials comprise a pore volume residing in pores of less than 30 angstroms of at least 1.5 cc/g and a pore volume residing in pores of between 30 and 300 angstroms of at least 1.5 cc/g.

In certain embodiments a mesoporous carbon material having low pore volume in the micropore region (e.g., less than 60%, less than 50%, less than 40%, less than 30%, less than 20% microporosity) is provided. In some embodiments, the carbon material comprises a BET specific surface area of 100 m²/g, at least 200 m²/g, at least 300 m²/g, at least 400 m²/g, at least 500 m²/g, at least 600 m²/g, at least 675 m²/g or at least 750 m²/g.

In other embodiments, the mesoporous carbon material comprises a total pore volume of at least 0.50 cc/g, at least 0.60 cc/g, at least 0.70 cc/g, at least 0.80 cc/g or at least 0.90 cc/g. In yet other embodiments, the mesoporous carbon material comprises a tap density of at least 0.30 g/cc, at least 0.35 g/cc, at least 0.40 g/cc, at least 0.45 g/cc, at least 0.50 g/cc or at least 0.55 g/cc.

Embodiments of the present disclosure provide carbon material having low total PIXE impurities (excluding the electrochemical modifier). Thus, in some embodiments the total PIXE impurity content (excluding the electrochemical modifier) of all other PIXE elements in the carbon material (as measured by proton induced x-ray emission) is less than 1000 ppm. In other embodiments, the total PIXE impurity content (excluding the electrochemical modifier) of all other PIXE elements in the carbon material is less than 800 ppm, less than 500 ppm, less than 300 ppm, less than 200 ppm, less than 150 ppm, less than 100 ppm, less than 50 ppm, less than 25 ppm, less than 10 ppm, less than 5 ppm or less than 1 ppm. In further embodiments of the foregoing, the carbon materials are activated.

Embodiments of the present disclosure provide carbon material having low total TXRF impurities (excluding the electrochemical modifier). Thus, in some embodiments the total TXRF impurity content (excluding the electrochemical modifier) of all other TXRF elements in the carbon material (as measured by total reflection x-ray fluorescence) is less than 1000 ppm. In other embodiments, the total TXRF impurity content (excluding the electrochemical modifier) of all other TXRF elements in the carbon material is less than 800 ppm, less than 500 ppm, less than 300 ppm, less than 200 ppm, less than 150 ppm, less than 100 ppm, less than 50 ppm, less than 25 ppm, less than 10 ppm, less than 5 ppm or less than 1 ppm. In further embodiments of the foregoing, the carbon materials are activated.

In one embodiment, the carbon materials comprise a total impurity content of less than 500 ppm of elements having atomic numbers ranging from 11 to 92 as measured by proton induced x-ray emission. In another embodiment, the carbon materials comprise a total impurity content of less than 100 ppm of elements having atomic numbers ranging from 11 to 92 as measured by proton induced x-ray emission.

In one embodiment, the carbon materials comprise a total impurity content of less than 500 ppm of elements having atomic numbers ranging from 11 to 92 as measured by total reflection x-ray fluorescence. In another embodiment, the carbon materials comprise a total impurity content of less than 100 ppm of elements having atomic numbers ranging from 11 to 92 as measured by total reflective x-ray fluorescence.

In addition to low content of undesired PUCE or TXRF impurities, the carbon materials of certain embodiments of the present methods may comprise high total carbon content. In addition to carbon, the carbon material may also comprise oxygen, hydrogen, nitrogen and the electrochemical modifier. In some embodiments, the carbon material comprises at least 75% carbon, 80% carbon, 85% carbon, at least 90% carbon, at least 95% carbon, at least 96% carbon, at least 97% carbon, at least 98% carbon or at least 99% carbon on a weight/weight basis. In some other embodiments, the carbon material comprises less than 10% oxygen, less than 5% oxygen, less than 3.0% oxygen, less than 2.5% oxygen, less than 1% oxygen or less than 0.5% oxygen on a weight/weight basis. In other embodiments, the carbon material comprises less than 10% hydrogen, less than 5% hydrogen, less than 2.5% hydrogen, less than 1% hydrogen, less than 0.5% hydrogen or less than 0.1% hydrogen on a weight/weight basis. In other embodiments, the carbon material comprises less than 5% nitrogen, less than 2.5% nitrogen, less than 1% nitrogen, less than 0.5% nitrogen, less than 0.25% nitrogen or less than 0.01% nitrogen on a weight/weight basis. The oxygen, hydrogen and nitrogen content of the disclosed carbon materials can be determined by combustion analysis. Techniques for determining elemental composition by combustion analysis are well known in the art.

Certain embodiments provide carbon material with a total ash content that may, in some instances, have an effect on the electrochemical performance of the carbon material. Accordingly, in some embodiments, the ash content of the carbon material ranges from 0.1% to 0.001% weight percent ash, for example in some specific embodiments the ash content of the carbon material is less than 0.1%, less than 0.08%, less than 0.05%, less than 0.03%, than 0.025%, less than 0.01%, less than 0.0075%, less than 0.005% or less than 0.001%.

In some embodiments, the ash content of the carbon material is less than 0.03% as calculated from total reflection x-ray fluorescence data. In another embodiment, the ash content of the carbon material is less than 0.01% as calculated from total reflection x-ray fluorescence data.

In other embodiments, the carbon material comprises a total PIXE or TXRF impurity content of less than 500 ppm and an ash content of less than 0.08%. In further embodiments, the carbon material comprises a total PIXE or TXRF impurity content of less than 300 ppm and an ash content of less than 0.05%. In other further embodiments, the carbon material comprises a total PIXE or TXRF impurity content of less than 200 ppm and an ash content of less than 0.05%. In other further embodiments, the carbon material comprises a total PIXE or TXRF impurity content of less than 200 ppm and an ash content of less than 0.025%. In other further embodiments, the carbon material comprises a total PIXE or TXRF impurity content of less than 100 ppm and an ash content of less than 0.02%. In other further embodiments, the carbon material comprises a total PIXE or TXRF impurity content of less than 50 ppm and an ash content of less than 0.01%.

The amount of individual PIXE or TXRF impurities present in the carbon materials in embodiments provided can be determined by proton induced x-ray emission or total reflective x-ray fluorescence, respectively. Individual PIXE or TXRF impurities may contribute in different ways to the overall electrochemical performance of the carbon materials produced. Thus, in some embodiments, the level of sodium present in the carbon material is less than 1000 ppm, less than 500 ppm, less than 100 ppm, less than 50 ppm, less than 10 ppm, or less than 1 ppm. As noted above, in some embodiments other impurities such as hydrogen, oxygen and/or nitrogen may be present in levels ranging from less than 10% to less than 0.01%.

In some embodiments, the carbon material comprises undesired PIXE or TXRF impurities near or below the detection limit of the proton induced x-ray emission or total reflection x-ray fluorescence analyses, respectively. For example, in some embodiments the carbon material comprises less than 50 ppm sodium, less than 15 ppm magnesium, less than 10 ppm aluminum, less than 8 ppm silicon, less than 4 ppm phosphorous, less than 3 ppm sulfur, less than 3 ppm chlorine, less than 2 ppm potassium, less than 3 ppm calcium, less than 2 ppm scandium, less than 1 ppm titanium, less than 1 ppm vanadium, less than 0.5 ppm chromium, less than 0.5 ppm manganese, less than 0.5 ppm iron, less than 0.25 ppm cobalt, less than 0.25 ppm nickel, less than 0.25 ppm copper, less than 0.5 ppm zinc, less than 0.5 ppm gallium, less than 0.5 ppm germanium, less than 0.5 ppm arsenic, less than 0.5 ppm selenium, less than 1 ppm bromine, less than 1 ppm rubidium, less than 1.5 ppm strontium, less than 2 ppm yttrium, less than 3 ppm zirconium, less than 2 ppm niobium, less than 4 ppm molybdenum, less than 4 ppm, technetium, less than 7 ppm rubidium, less than 6 ppm rhodium, less than 6 ppm palladium, less than 9 ppm silver, less than 6 ppm cadmium, less than 6 ppm indium, less than 5 ppm tin, less than 6 ppm antimony, less than 6 ppm tellurium, less than 5 ppm iodine, less than 4 ppm cesium, less than 4 ppm barium, less than 3 ppm lanthanum, less than 3 ppm cerium, less than 2 ppm praseodymium, less than 2 ppm, neodymium, less than 1.5 ppm promethium, less than 1 ppm samarium, less than 1 ppm europium, less than 1 ppm gadolinium, less than 1 ppm terbium, less than 1 ppm dysprosium, less than 1 ppm holmium, less than 1 ppm erbium, less than 1 ppm thulium, less than 1 ppm ytterbium, less than 1 ppm lutetium, less than 1 ppm hafnium, less than 1 ppm tantalum, less than 1 ppm tungsten, less than 1.5 ppm rhenium, less than 1 ppm osmium, less than 1 ppm iridium, less than 1 ppm platinum, less than 1 ppm silver, less than 1 ppm mercury, less than 1 ppm thallium, less than 1 ppm lead, less than 1.5 ppm bismuth, less than 2 ppm thorium, or less than 4 ppm uranium.

In some specific embodiments, the carbon material comprises less than 100 ppm sodium, less than 300 ppm silicon, less than 50 ppm sulfur, less than 100 ppm calcium, less than 20 ppm iron, less than 10 ppm nickel, less than 140 ppm copper, less than 5 ppm chromium and less than 5 ppm zinc as measured by proton induced x-ray emission or total reflection x-ray fluorescence. In other specific embodiments, the carbon material comprises less than 50 ppm sodium, less than 30 ppm sulfur, less than 100 ppm silicon, less than 50 ppm calcium, less than 10 ppm iron, less than 5 ppm nickel, less than 20 ppm copper, less than 2 ppm chromium and less than 2 ppm zinc.

In other specific embodiments, the carbon material comprises less than 50 ppm sodium, less than 50 ppm silicon, less than 30 ppm sulfur, less than 10 ppm calcium, less than 2 ppm iron, less than 1 ppm nickel, less than 1 ppm copper, less than 1 ppm chromium and less than 1 ppm zinc.

In some other specific embodiments, the carbon material comprises less than 100 ppm sodium, less than 50 ppm magnesium, less than 50 ppm aluminum, less than 10 ppm sulfur, less than 10 ppm chlorine, less than 10 ppm potassium, less than 1 ppm chromium and less than 1 ppm manganese.

In some embodiments, the carbon materials comprise less than 10 ppm iron. In other embodiments, the carbon materials comprise less than 3 ppm nickel. In other embodiments, the carbon materials comprise less than 30 ppm sulfur. In other embodiments, the carbon materials comprise less than 1 ppm chromium. In other embodiments, the carbon materials comprise less than 1 ppm copper. In other embodiments, the carbon materials comprise less than 1 ppm zinc.

Embodiments of the disclosed carbon materials have a relatively high surface area and may impart this feature onto the composition as a whole. While not wishing to be bound by theory, it is thought that such high surface area may contribute, at least in part, to their superior electrochemical performance. Accordingly, in some embodiments, the carbon material comprises a BET specific surface area of at least 100 m²/g, at least 200 m²/g, at least 300 m²/g, at least 400 m²/g, at least 500 m²/g, at least 600 m²/g, at least 1000 m²/g, at least 1500 m²/g, at least 2000 m²/g, at least 2400 m²/g, at least 2500 m²/g, at least 2750 m²/g or at least 3000 m²/g. In other embodiments, the BET specific surface area ranges from about 100 m²/g to about 3000 m²/g, for example from about 500 m²/g to about 1000 m²/g, from about 1000 m²/g to about 1500 m²/g, from about 1500 m²/g to about 2000 m²/g, from about 2000 m²/g to about 2500 m²/g or from about 2500 m²/g to about 3000 m²/g. For example, in some embodiments of the foregoing, the carbon material is activated.

In certain embodiments, the carbon material comprises a BET specific surface area of at least 500 m²/g. In another embodiment, the carbon material comprises a BET specific surface area of at least 1500 m²/g.

In still other examples, the carbon material comprises less than 100 ppm sodium, less than 100 ppm silicon, less than 10 ppm sulfur, less than 25 ppm calcium, less than 1 ppm iron, less than 2 ppm nickel, less than 1 ppm copper, less than 1 ppm chromium, less than 50 ppm magnesium, less than 10 ppm aluminum, less than 25 ppm phosphorous, less than 5 ppm chlorine, less than 25 ppm potassium, less than 2 ppm titanium, less than 2 ppm manganese, less than 0.5 ppm cobalt and less than 5 ppm zinc as measured by proton induced x-ray emission or total reflection x-ray fluorescence, and wherein all other elements having atomic numbers ranging from 11 to 92 are undetected by proton induced x-ray emission or total reflection x-ray fluorescence.

In another embodiment, carbon material has a tap density between 0.1 and 1.0 g/cc, between 0.2 and 0.8 g/cc, between 0.3 and 0.5 g/cc or between 0.4 and 0.5 g/cc. In another embodiment, the carbon material has a total pore volume of at least 0.1 cm³/g, at least 0.2 cm³/g, at least 0.3 cm³/g, at least 0.4 cm³/g, at least 0.5 cm³/g, at least 0.6 cm³/g, at least 0.7 cm³/g, at least 0.75 cm³/g, at least 0.9 cm³/g, at least 1.0 cm³/g, at least 1.1 cm³/g, at least 1.2 cm³/g, at least 1.3 cm³/g, at least 1.4 cm³/g, at least 1.5 cm³/g or at least 1.6 cm³/g.

The pore size distribution is one parameter that may have an effect on the electrochemical performance of carbon materials. For example, certain embodiments provide carbon materials having mesopores with a short effective length (i.e., less than 10 nm, less than 5, nm or less than 3 nm as measured by TEM) which decreases ion diffusion distance and may be useful to enhance ion transport and maximize power.

In one embodiment, the carbon material comprises a fractional pore volume of pores at or below 100 nm that comprises at least 50% of the total pore volume, at least 75% of the total pore volume, at least 90% of the total pore volume or at least 99% of the total pore volume. In other embodiments, the carbon material comprises a fractional pore volume of pores at or below 50 nm that comprises at least 50% of the total pore volume, at least 75% of the total pore volume, at least 90% of the total pore volume or at least 99% of the total pore volume. In other embodiments, the carbon material comprises a fractional pore volume of pores at or below 30 nm that comprises at least 50% of the total pore volume, at least 75% of the total pore volume, at least 90% of the total pore volume or at least 99% of the total pore volume. In other embodiments, the carbon material comprises a fractional pore volume of pores ranging from 50 nm to 30 nm that comprises at least 50% of the total pore volume, at least 75% of the total pore volume, at least 90% of the total pore volume or at least 99% of the total pore volume.

In another embodiment, the carbon material comprises a fractional pore surface area of pores at or below 100 nm that comprises at least 50% of the total pore surface area, at least 75% of the total pore surface area, at least 90% of the total pore surface area or at least 99% of the total pore surface area. In another embodiment, the carbon material comprises a fractional pore surface area of pores at or below 50 nm that comprises at least 50% of the total pore surface area, at least 75% of the total pore surface area, at least 90% of the total pore surface area or at least 99% of the total pore surface area. In another embodiment, the carbon material comprises a fractional pore surface area of pores at or below 30 nm that comprises at least 50% of the total pore surface area, at least 75% of the total pore surface area, at least 90% of the total pore surface area or at least 99% of the total pore surface area. In another embodiment, the carbon material comprises a fractional pore surface area of pores ranging from 50 nm to 30 nm that comprises at least 50% of the total pore surface area, at least 75% of the total pore surface area, at least 90% of the total pore surface area or at least 99% of the total pore surface area.

In another embodiment, the carbon material comprise a fractional pore surface area of pores between 30 and 300 angstroms that comprises at least 40% of the total pore surface area, at least 50% of the total pore surface area, at least 70% of the total pore surface area or at least 80% of the total pore surface area. In another embodiment, the carbon material have a fractional pore surface area of pores at or below 30 nm that comprises at least 20% of the total pore surface area, at least 30% of the total pore surface area, at least 40% of the total pore surface area or at least 50% of the total pore surface area.

In another embodiment, the carbon material has pores predominantly in the range of 1000 angstroms or lower, for example 100 angstroms or lower, for example 50 angstroms or lower. Alternatively, the carbon material comprises micropores in the range of 0-30 angstroms and mesopores in the range of 30-300 angstroms. The ratio of pore volume (e.g., mesopore volume) or pore surface in the micropore range compared to the mesopore range can be in the range of 95:5 to 5:95. Alternatively, the ratio of pore volume (e.g., mesopore volume) or pore surface in the micropore range compared to the mesopore range can be in the range of 20:80 to 60:40.

In some embodiments, the carbon materials (e.g., particles) exhibit a surface functionality of less than 20 mEq per 100 gram of carbon material, less than 10 mEq per 100 gram of carbon material, less than 5 mEq per 100 gram of carbon material as determined by Boehm titration or less than 1 mEq per 100 gram of carbon material as determined by Boehm titration. In other embodiments, the carbon materials exhibit a surface functionality of greater than 20 mEq per 100 gram of carbon material as determined by Boehm titration.

The specific capacity (Q, Ah/gram carbon) of a mesoporous carbon material is defined by the amount of reaction product that can form on the pore surfaces. If the mixture of reaction products is constant, the current generated during reaction product formation is directly proportional to the volume of a reaction product. The high mesopore volume of mesoporous carbon material provides a reservoir for reaction products (e.g., lead sulfate or sulfate ions) while still maintaining electrochemical activity in pores present in the material. Such a high mesopore volume provides a significant increase in the energy density of a device (e.g., lead acid battery) comprising the carbon materials. In some embodiments, the pore structure of carbon materials comprises pores ranging from 2-50 nm, 10-50 nm, 15-30 nm or even 20-30 nm.

Without wishing to be bound by theory, it is thought that particle characteristics of the carbon material impart desirable characteristics unto the composition. Specifically, carbon materials as disclosed herein do not typically form aggregates as in other carbon materials (e.g., carbon black). In this respect, the carbon materials as disclosed herein can exist within the composition as discrete particles having a particle size (i.e., substantially non-agglomerated, non-aggregated, or non-clustered). In some embodiments, the carbon material has a particle size (e.g., at least one detectable particle) greater than about 7.5 microns. In some embodiments, the particle size is greater than about 10 microns. In more specific embodiments, the carbon material has a particle size greater than about 15 microns, greater than about 20 microns, greater than about 30 microns, greater than about 45 microns, greater than about 50 microns, greater than about 60 microns, greater than about 70 microns, greater than about 80 microns, greater than about 90 microns, greater than about 100 microns or greater than about 150 microns.

In another aspect, the carbon material has an aggregate size less than about 100 microns, about 90 microns, about 80 microns, about 70 microns, about 60 microns, about 50 microns, about 40 microns, about 30 microns, about 25 microns, about 20 microns, about 15 microns, or about 10 microns. In some embodiments, the particle size is determined by optical microscopy, laser diffraction, scanning electron microscopy or combinations thereof. In some embodiments, aggregation may be determined as several particles all being in relatively close proximity or touching to form a larger collective structure. In some embodiments, close proximity may be within 1-2 nm, 1-3 nm, 1-4 nm, 1-5 nm, or 1-10 nm.

In some embodiments, the concentration of the carbon material ranges from about 0.20% to about 20.0% by weight of the composition. In some embodiments, the concentration of the carbon material ranges from about 0.20% to about 15.0%, from about 0.20% to about 13.0%, from about 0.20% to about 12.0%, from about 0.20% to about 10.0%, from about 0.20% to about 7.0%, from about 0.20% to about 6.5%, from about 0.20% to about 6.0%, from about 0.20% to about 5.5%, from about 0.20% to about 5.3%, from about 0.20% to about 4.7%, from about 0.20% to about 4.5%, from about 0.20% to about 4.0%, from about 0.20% to about 3.7%, from about 0.20% to about 3.5%, from about 0.20% to about 3.0%, from about 0.20% to about 2.7%, from about 0.20% to about 2.5%, from about 0.20% to about 2.0%, from about 0.20% to about 1.75%, from about 0.20% to about 1.5%, from about 0.20% to about 1.25%, from about 0.20% to about 1.0%, from about 0.20% to about 0.75%, from about 0.20% to about 0.5%, from about 0.25% to about 15.0%, from about 0.50% to about 15.0%, from about 0.75% to about 15.0%, from about 1.0% to about 15.0%, from about 1.25% to about 15.0%, from about 1.5% to about 15.0%, from about 1.75% to about 15.0%, from about 2.0% to about 15.0%, from about 2.25% to about 15.0%, from about 2.5% to about 15.0%, from about 2.75% to about 15.0%, from about 3.0% to about 15.0%, from about 3.5% to about 15.0%, from about 4.0% to about 15.0%, from about 4.5% to about 15.0%, from about 5.0% to about 15.0% or from about 7.5% to about 15.0% by weight of the composition.

In some embodiments, the concentration of the carbon material is greater than about 0.20%, about 0.25%, about 0.50%, about 0.25%, about 0.75%, about 1.0%, about 1.25%, about 1.5%, about 1.75%, about 2.0%, about 2.25%, about 2.5%, about 2.75%, about 3.0%, about 3.25%, about 3.5%, about 3.75%, about 4.0%, about 4.25%, about 4.5%, about 4.75%, about 5.0%, about 5.25%, about 5.5%, about 5.75%, about 6.0%, about 6.5%, about 7.0%, about 7.5%, about 8.0%, about 8.5%, about 9.0%, about 9.5%, about 10.0%, about 10.5%, about 11.0%, about 12.0%, about 13.0%, about 14.0%, about 15.0%, about 20.0%, about 25.0%, about 30.0%, about 35.0% or about 40.0% by weight of the composition.

In some embodiments, the concentration of the carbon material is about 1.0% by weight of the composition. In some embodiments, the concentration of the carbon material is about 1.5% by weight of the composition. In some embodiments, the concentration of the carbon material is about 2.0% by weight of the composition.

In certain embodiments, the composition comprises Carbon Material 1 or Carbon Material 2. Carbon Material 1 and Carbon Material 2 have the following characteristics:

| | Surface Area | Particle Size | Pore Volume |
|---|---|---|---|
| | (m²/g) | (average) | (cc/g) |
| Carbon | 700 | 60 μm | 0.7 |
| Material 1 | | (discrete particles) | |
| Carbon | 1700 | 60 μm | 1.15 |
| Material 2 | | (discrete particles) | |

In certain embodiments, the composition comprises Agglomerated Carbon 1 or Agglomerated Carbon 2. Agglomerated Carbon 1 and Agglomerated Carbon 2 have the following characteristics:

| | Surface Area | Aggregate Size | Pore Volume |
|---|---|---|---|
| | (m²/g) | (average) | (cc/g) |
| Agglomerated | 1500 | 185 μm | 1.50 |
| Carbon 1 | | (agglomerated particles) | |
| Agglomerated | 120 | 175 μm | 0.25 |
| Carbon 2 | | (agglomerated particles) | |

### C. Expander

The expander of the composition can be selected to impart desirable characteristics unto the mixture. For example, the lignin can be selected to increase mechanical strength, plasticity or ease of handling. In these ways, the expander is not particularly limited in any way. The composition of the expander as disclosed herein may be a single component or a mixture of components.

Accordingly, in some embodiments, the expander comprises barium sulfate, strontium sulfate, lignin, sulfonated naphthalene condensate or combinations thereof. In other related embodiments, the expander comprises barium sulfate. In more specific embodiments, the expander comprises lignin. In other more specific embodiments, the expander comprises barium sulfate and lignin.

The lignin, as disclosed herein, includes synthetic lignin, naturally occurring lignin and combinations thereof. For example, lignin may include oxylignin and kraft lignin. In some embodiments, the lignin comprises Vanisperse A, Vanisperse HT-1 or combinations thereof.

In some other embodiments, the expander comprises sulfonated naphthalene condensate. For example, the sulfonated naphthalene condensate may be sodium naphthalene sulfonate formaldehyde condensate, potassium naphthalene sulfonate formaldehyde condensate, calcium naphthalene sulfonate formaldehyde condensate, ammonium naphthalene sulfonate formaldehyde condensate, and combinations thereof. In other embodiments, the sulfonated naphthalene condensate has the formula —CH₂(C₁₀H₅(SO₃M))ₘ—, wherein M is Na⁺, K⁺, Ca²⁺, or NH₄⁺ and m is an integer greater than 0.

In some embodiments, the composition further comprises polyaspartic acid and salts thereof. In some more specific embodiments, the polyaspartic acid has the following structure:

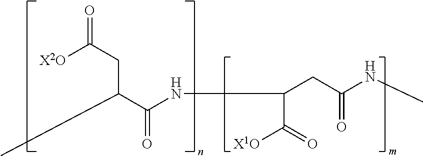

wherein

X¹ and X² are, at each occurrence, independently H, Na⁺, K⁺, Ca²⁺, or NH₄⁺;

n and m are each independently an integer of 0 or greater, provided that at least one of n and m are not 0. It is understood that in the foregoing embodiments, when X¹ and/or X² is a positive ion (e.g., Li⁺, Na⁺, K⁺, Ca²⁺, Mg²⁺ or NH₄⁺), the remaining part of the chemical structure may be negatively charged (e.g., having an O⁻) to result in a neutral overall charge. Alternatively, in some of the foregoing embodiments, the polyaspartic acid may have a net charge depending on the pH of the composition. In some embodiments, the polyaspartic acid further comprises one or more residues or moieties derived from asparagine, fumaric acid, maleic acid (or salts thereof) or combinations thereof. In some more specific embodiments, the composition further comprises aspartic acid, asparagine, fumaric acid, maleic acid or combinations thereof. In some embodiments, the aspartic acid, asparagine, fumaric acid, maleic acid or combinations thereof are in the form of a salt with sodium, potassium, calcium, ammonium or combinations thereof.

In some embodiments, the composition comprises polyaspartic acid or salts thereof at a concentration ranging from greater than 0% to about 0.50% by weight of the composition. In some specific embodiments, the composition comprises polyaspartic acid or salts thereof at a concentration ranging from greater than 0% to about 0.35% by weight of the composition.

In some embodiments, the composition further comprises carbon black. For example, in some embodiments, the composition comprises carbon black at a concentration up to about 0.3% by weight of the composition. In some embodiments, the composition further comprises carbon black at a concentration ranging from greater than about 0.01% to about 0.5% by weight of the composition. In some embodiments, the composition further comprises carbon black at a concentration ranging from greater than about 0.05% to about 0.3% by weight of the composition. In some embodiments, the composition further comprises carbon black at a concentration ranging from greater than about 0.09% to about 0.2% by weight of the composition. In some embodiments, the composition comprises carbon black at a concentration ranging from about 0.04% to about 1.2%, from about 0.04% to about 1.1%, from about 0.04% to about 1.0%, from about 0.04% to about 0.9%, from about 0.04% to about 0.8%, from about 0.04% to about 0.7%, from about 0.04% to about 0.6%, from about 0.04% to about 0.5%, from about 0.05% to about 1.2%, from about 0.75% to about 1.2%, from about 0.1% to about 1.2%, from about 0.2% to about 1.2%, from about 0.3% to about 1.2%, from about 0.4% to about 1.2%, from about 0.5% to about 1.2%, from about 0.6% to about 1.2%, from about 0.7% to about 1.2%, from about 0.8% to about 1.2%, from about 0.9% to about 1.2%, from about 1.0% to about 1.2% or from about 1.1% to about 1.2% by weight of the composition.

Additionally, the concentration of the expander can be selected to impart desirable properties unto the composition (or paste comprising the same) or electrode. Accordingly, in some embodiments, the expander has a concentration ranging from greater than 0% to about 3.5% by weight of the composition.

In more specific embodiments, the composition comprises barium sulfate at a concentration ranging from about 0.01% to about 2.0% by weight of the composition. In other embodiments, the composition comprises barium sulfate at a concentration ranging from about 0.02% to about 1.5% by weight of the composition. In some embodiments, the composition comprises barium sulfate at a concentration ranging from about 0.04% to about 1.3% by weight of the composition. In some embodiments, the composition comprises barium sulfate at a concentration ranging from about 0.04% to about 1.2%, from about 0.04% to about 1.1%, from about 0.04% to about 1.0%, from about 0.04% to about 0.9%, from about 0.04% to about 0.8%, from about 0.04% to about 0.7%, from about 0.04% to about 0.6%, from about 0.04% to about 0.5%, from about 0.05% to about 1.2%, from about 0.75% to about 1.2%, from about 0.1% to about 1.2%, from about 0.2% to about 1.2%, from about 0.3% to about 1.2%, from about 0.4% to about 1.2%, from about 0.5% to about 1.2%, from about 0.6% to about 1.2%, from about 0.7% to about 1.2%, from about 0.8% to about 1.2%, from about 0.9% to about 1.2%, from about 1.0% to about 1.2% or from about 1.1% to about 1.2% by weight of the composition.

In other embodiments, the composition comprises lignin at a concentration ranging from about 0.04% to about 1.0% by weight of the composition. In some embodiments, the composition comprises lignin at a concentration ranging from about 0.19% to about 0.90% by weight of the composition. In some embodiments, the composition comprises lignin at a concentration ranging from about 0.2% to about 0.80%, from about 0.2% to about 0.70%, from about 0.2% to about 0.60%, from about 0.2% to about 0.50%, from about 0.2% to about 0.40%, from about 0.2% to about 0.30%, from about 0.30% to about 0.80%, from about 0.40% to about 0.80%, from about 0.50% to about 0.80%, from about 0.60% to about 0.80%, from about 0.70% to about 0.80% or from about 0.75% to about 0.80% by weight of the composition.

### E. Preparation of the Compositions

Lead materials (e.g., leady oxide, porous metallic lead, metallic lead, lead sulfate) can be made by methods known in the art or obtained from commercial sources. The compositions as described herein can be made using methods known in the art, including as detailed in the present disclosure.

Particles of carbon can be made by the polymer gel methods. The polymer gels may be prepared by a sol gel process, e.g., the polymer gel may be prepared by co-polymerizing one or more polymer precursors (e.g., phenol, resorcinol, catechol, hydroquinone, phloroglucinol, formaldehyde, acetaldehyde, propionaldehyde, butyraldehyde, benzaldehyde, cinnamaldehyde and the like) in an appropriate solvent under acidic conditions. The sol gel polymerization process is generally performed under catalytic conditions using, e.g., ammonium carbonate, ammonium bicarbonate, ammonium acetate, or ammonium hydroxide as a catalyst.

A wide variety of other polymer precursors are also available and described in the art. Exemplary polymer precursor materials as disclosed herein include

(a) alcohols, phenolic compounds, and other mono- or polyhydroxy compounds; and

(b) aldehydes, ketones, and combinations thereof.

Representative polymer precursors include, but are not limited to, polyhydroxy benzene, resorcinol (i.e., 1,3-dihydroxy benzene), catechol, hydroquinone, phloroglucinol, sugars (e.g., glucose), polyols (e.g., mannitol), aldehydes (e.g., formaldehyde, acetaldehyde, propionaldehyde, butyraldehyde, ethenone and other ketenes, acrylaldehyde, 2-butenal, 3-butenal, benzaldehyde, salicylaldehyde, hydrocinnamaldehyde, and the like), ketones (e.g., propanone, 2-butanone, propenone, 2-butenone, 3-butenone, methyl benzyl ketone, ethyl benzyl ketone and the like), bisphenols (e.g., bisphenol A) and the like.

Certain embodiments of the carbon materials can be prepared according to and have properties as described in co-owned U.S. Pat. Nos. 8,293,818; 7,816,413; 8,404,384; 8,916,296; 8,654,507; 9,269,502; 9,409,777; and PCT Pub. No. WO 2007/061761, WO 2017/066703 which are hereby incorporated in its entirety.

### F. Characterization of Carbon Materials

The properties of the carbon material can be measured using techniques known in the art. For example, structural properties of the carbon material can be measured using Nitrogen sorption at 77K, a method known to those of skill in the art. The Micromeretics ASAP 2020 is used to perform detailed micropore and mesopore analysis, which reveals a pore size distribution from 0.35 nm to 50 nm in some embodiments. The system produces a nitrogen isotherm starting at a pressure of 10⁻⁷ atm, which enables high resolution pore size distributions in the sub 1 nm range. The software generated reports utilize a Density Functional Theory (DFT) method to calculate properties such as pore size distributions, surface area distributions, total surface area, total pore volume, and pore volume within certain pore size ranges.

The impurity content of the carbon materials can be determined by any number of analytical techniques known to those of skill in the art. One particular analytical method useful within the context of the present disclosure is proton induced x-ray emission (PIXE). This technique is capable of measuring the concentration of elements having atomic numbers ranging from 11 to 92 at low ppm levels. Accordingly, in one embodiment the concentration of impurities present in the carbon materials is determined by PIXE analysis.

Another useful analytical method is total reflection x-ray fluorescence (TXRF). This technique is capable of measuring the concentration of elements having atomic numbers ranging from 11 to 92 at low ppm levels. Accordingly, in one embodiment the concentration of impurities present in the carbon materials is determined by TXRF analysis.

### G. Electrodes and Cells

Accordingly, the present disclosure provides electrical energy storage devices having longer active life and improved power performance relative to devices containing other carbon materials. The disclosed compositions comprising carbon materials find utility in electrodes for use in lead acid batteries. Accordingly, one embodiment of the present disclosure is a lead acid battery (e.g., hybrid lead-carbon-acid battery) comprising at least one cell, wherein the at least one cell comprises carbon material according to any one of the embodiments disclosed herein and a lead-based positive electrode. The battery further comprises separators between the cells, an acid electrolyte (e.g., aqueous sulfuric acid), and a casing to contain the battery.

One embodiment provides an electrode comprising the composition as disclosed in any one of the embodiments disclosed herein. Another embodiment provides an electrode comprising a negative active material, the negative active material comprising the composition of any of the embodiments described herein. In some embodiments, negative active material has a BET specific surface area greater than about 1.5 m²/g. In some specific embodiments, the negative active material has a BET specific surface area greater than about 1.75 m²/g. In some specific embodiments, the negative active material has a BET specific surface area greater than about 2.0 m²/g. In some embodiments, negative active material has a BET specific surface area ranging from about 1.5 m²/g to about 5.0 m²/g, from about 1.5 m²/g to about 3.0 m²/g, from about 1.5 m²/g to about 3.5 m²/g, from about 1.5 m²/g to about 4.5 m²/g, from about 2.0 m²/g to about 5.0 m²/g, from about 2.5 m²/g to about 5.0 m²/g, from about 3.0 m²/g to about 5.0 m²/g or from about 3.5 m²/g to about 7.5 m²/g.

In some specific embodiments, the negative active material has a total pore volume greater than about 0.003 cc/g. In some embodiments, the negative active material has a total pore volume greater than about 0.0035 cc/g. In certain embodiments, the negative active material has a total pore volume greater than about 0.004 cc/g. In some embodiments, the negative active material has a total pore volume ranging from about 0.003 cc/g to about 0.010 cc/g, from about 0.0035 cc/g to about 0.010 cc/g, from about 0.004 cc/g to about 0.010 cc/g, from about 0.0045 cc/g to about 0.010 cc/g, from about 0.005 cc/g to about 0.010 cc/g, from about 0.001 cc/g to about 0.005 cc/g, from about 0.002 cc/g to about 0.005 cc/g, from about 0.002 cc/g to about 0.003 cc/g, from about 0.002 cc/g to about 0.0045 cc/g or from about 0.002 cc/g to about 0.004 cc/g.

In some more embodiments, from about 30% to about 80% of the total pore volume of the negative active material is mesopore volume. In some embodiments, from about 40% to about 60% of the total pore volume of the negative active material is mesopore volume.

In some embodiments, from about 35% to about 75%, from about 40% to about 75%, from about 45% to about 75%, from about 40% to about 65%, from about 44% to about 65%, from about 20% to about 75%, from about 25% to about 75%, from about 25% to about 55%, from about 25% to about 50%, or from about 30% to about 60% of the total pore volume of the negative active material is mesopore volume

In some embodiments the battery comprises a highly conductive current collector; a composition (e.g., paste) according to embodiments disclosed herein adhered to and in electrical contact with at least one surface of the current collector, and a tab element extending above the top edge of the negative or positive electrode. For example, each positive electrode may comprise a lead-based current collector and a lead dioxide-based active material paste adhered to, and in electrical contact with, the surfaces thereof, and a tab element extending above the top edge of the positive electrode.

A negative electrode may comprise a conductive current collector; a composition as disclosed herein; and a tab element extending from a side, for example from above a top edge, of the negative electrode. Negative electrode tab elements may be electrically secured to one another by a cast-on strap, which may comprise a connector structure. The active material may be in the form of a sheet that is adhered to, and in electrical contact, with the current collector matrix. In order for the particles to be adhered to and in electrical contact with the current collector matrix, the particles may be mixed with a suitable binder substance such as PTFE or ultra-high molecular weight polyethylene (e.g., having a molecular weight numbering in the millions, usually between about 2 and about 6 million). In some embodiments, the binder material does not exhibit thermoplastic properties or exhibits minimal thermoplastic properties.

In certain embodiments, each battery cell comprises four positive electrodes that are lead-based and comprise lead dioxide active material. Each positive electrode comprises a highly conductive current collector comprising porous carbon material (e.g., carbon material, a lead species and an expander) adhered to each face thereof and lead dioxide contained within the carbon. Also, in this embodiment, the battery cell comprises three negative electrodes, each of which comprises a highly conductive current collector comprising a composition according to embodiments as disclosed herein.

In other embodiments, each cell comprises a plurality of positive electrodes and a plurality of negative electrodes that are placed in alternating order. Between each adjacent pair of positive electrodes and the negative electrodes, there is placed a separator. Each of the positive electrodes is constructed so as to have a tab extending above the top edge of each respective electrode; and each of the negative electrodes has a tab extending above the top edge of each of the respective negative electrodes. In certain variations, the separators are made from a suitable separator material that is intended for use with an acid electrolyte, and that the separators may be made from a woven material such as a non-woven or felted material, or a combination thereof. In other embodiments, the material of the current collector is sheet lead, which may be cast or rolled and punched or machined.

Each cell may comprise alternating positive and negative plates, and an electrolyte may be disposed in a volume between the positive and negative plates. Additionally, the electrolyte can occupy some or all of the pore space in the materials included in the positive and negative plates. In one embodiment, the electrolyte includes an aqueous electrolytic solution within which the positive and negative plates may be immersed. The electrolyte may include a solution of sulfuric acid and distilled water. Other acids, however, may be used to form the electrolytic solutions of the disclosed batteries.

In another embodiment, the electrolyte may include a silica gel. This silica gel electrolyte can be added to the battery such that the gel at least partially fills a volume between the positive and negative plate or plates of cell.

In some other variations, the positive and negative plates of each cell may include a current collector packed or coated with a chemically active material. Chemical reactions in the active material disposed on the current collectors of the battery enable storage and release of electrical energy. The composition of this active material, and not the current collector material, determines whether a particular current collector functions either as a positive or a negative plate.

The composition of the chemically active material also depends on the chemistry of the device. For example, lead acid batteries may include a chemically active material comprising, for example, an oxide or salt of lead. In certain embodiments, the chemically active material may comprise lead dioxide (PbO₂). The chemically active material may also comprise various additives including, for example, varying percentages of free lead, structural fibers, conductive materials, carbon, and expanders to accommodate volume changes over the life of the battery. In certain embodiments, the constituents of the chemically active material for lead acid batteries may be mixed with sulfuric acid and water to form a paste, slurry, or any other type of coating material.

The chemically active material in the form of a paste or a slurry, for example, may be applied to the current collectors of the positive and negative plates. The chemically active material may be applied to the current collectors by dipping, painting, pressing, extruding, pasting or via any other suitable coating/pasting technique.

In certain embodiments, the positive and negative plates of a battery are formed by first depositing the chemically active material on the corresponding current collectors to make the plates. While not necessary in all applications, in certain embodiments, the chemically active material deposited on current collectors may be subjected to curing and/or drying processes. For example, a curing process may include exposing the chemically active materials to elevated temperature and/or humidity to encourage a change in the chemical and/or physical properties of the chemically active material.

Accordingly, one embodiment provides a cell comprising:

a) at least one positive electrode comprising positive active material;

b) at least one negative electrode according to embodiments disclosed herein,

wherein:

the positive electrode and the negative electrode are separated by an inert porous separator.

In some embodiments, the cell has an operating voltage ranging from about 1 to about 4 volts. In other embodiments, the cell has an operating voltage ranging from about 1.5 to 3 volts. In still other embodiments, the cell has an operating voltage of about 2 volts.

In certain embodiments, a capacity returned to the cell after charging for 15 minutes at 2.4 V is greater than 15% of the rated C/20 capacity when the cell is charged from 80% state of charge.

In some other embodiments, the cell produces a peak current greater than a current equivalent to a 5C rate about 10 milliseconds to 5 seconds after applying a constant 2.4 V charge when the cell is charged from 80% state of charge. In certain embodiments, the cell produces a peak current greater than a current equivalent to a 6C rate about 10 milliseconds to 5 seconds after applying a constant 2.4 V charge when the cell is charged from 80% state of charge. In some embodiments, the cell produces a peak current greater than a current equivalent to a 7C rate about 10 milliseconds to 5 seconds after applying a constant 2.4 V charge when the cell is charged from 80% state of charge. In another embodiment, the cell produces a peak current greater than a current equivalent to a 8C rate about 10 milliseconds to 5 seconds after applying a constant 2.4 V charge when the cell is charged from 80% state of charge. In still another embodiment, the cell produces a peak current greater than a current equivalent to a 9C rate about 10 milliseconds to 5 seconds after applying a constant 2.4 V charge when the cell is charged from 80% state of charge.

In certain embodiments, the cell has a charge power of at least 10 W/Ah when applying a current equivalent to a 2.5 C rate for 10 seconds when the cell is charged from 90% state of charge. In other embodiments, the cell has a charge power of at least 12 W/Ah when applying a current equivalent to a 2.5 C rate for 10 seconds when the cell is charged from 70% state of charge. In some embodiments, the cell has a charge power of at least 13 W/Ah when applying a current equivalent to a 2.5 C rate for 10 seconds when the cell is charged from 50% state of charge. In more specific embodiments, the cell has a charge power of at least 14 W/Ah when applying a current equivalent to a 2.5 C rate for 10 seconds when the cell is charged from 20% state of charge.

In some embodiments, the cell has a recharge time of less than 8 hours when discharged at a C/20 rate to 20% state of charge and recharged at 2.6 V with a current limitation equivalent to a C/2 rate. In some embodiments, the cell has a recharge time of less than 7 hours when discharged at a C/20 rate to 20% state of charge and recharged at 2.6 V with a current limitation equivalent to a C/2 rate. In some embodiments, the cell has a recharge time of less than 6 hours when discharged at a C/20 rate to 20% state of charge and recharged at 2.6 V with a current limitation equivalent to a C/2 rate. In certain specific embodiments, the cell has a recharge time of less than 5 hours when discharged at a C/20 rate to 20% state of charge and recharged at 2.6 V with a current limitation equivalent to a C/2 rate.

In some embodiments, the cell has a recharge time of less than 5 hours when discharged at a C/20 rate to 20% state of charge and recharged at 2.6 V with a current limitation equivalent to a C/1.25 rate. In some embodiments, the cell has a recharge time of less than 5 hours when discharged at a C/20 rate to 20% state of charge and recharged at 2.6 V with a current limitation equivalent to a C/1 rate.

In other embodiments, the cell maintains a voltage greater than 1.7 V for more than about 1,500 cycles between about 50% and about 100% state of charge, wherein a cycle comprises a 60 second 2C discharge and a 60 second 2.4V charge with no current limitation. In some other embodiments, the cell maintains a voltage greater than 1.7 V for more than about 2,500 cycles between about 50% and about 100% state of charge, wherein a cycle comprises a 60 second 2C discharge and a 60 second 2.4V charge with no current limitation. In some embodiments, the cell maintains a voltage greater than 1.7 V for more than about 4,000 cycles between about 50% and about 100% state of charge, wherein a cycle comprises a 60 second 2C discharge and a 60 second 2.4V charge with no current limitation. In still other embodiments, the cell is discharged for a 60 second 2C discharge thereby discharging a capacity and charged at 2.4V with no current limitation for a time necessary to recharge the cell with the capacity, wherein the time necessary is less than about 30 seconds. In other embodiments, the cell is discharged for a 60 second 2C discharge thereby discharging a capacity and charged at 2.4V with no current limitation for a time necessary to recharge the cell with the capacity, wherein the time necessary is less than about 25 seconds. In some embodiments, the cell is discharged for a 60 second 2C discharge thereby discharging a capacity and charged at 2.4V with no current limitation for a time necessary to recharge the cell with the capacity, wherein the time necessary is less than about 20 seconds.

In some embodiments, the cell has been subjected to about 1 to 4,000 cycles, wherein a cycle comprises the 60 second 2C discharge and the 2.4V charge with no current limitation.

Certain specific embodiments provide a first cell having a negative electrode comprising a composition according to any one of the foregoing embodiments, wherein the first cell has at least a 25% increase in cycle life compared to a second cell, wherein cycle life is a number of cycles performed while an observed voltage remains within a range of 1.6V to 2.67V, wherein a cycle comprises testing a cell with the following:

a first low-power discharge at 1.1 W₁ for about 120 seconds;

a first high-power discharge at 2.2 W₁ for about 60 seconds;

a first low-power charge at 1.1 W₁ for about 120 seconds;

a first high-power charge at 2.2 W₁ for about 60 seconds;

a second low-power discharge at 1.1 W₁ for about 120 seconds;

a second high-power discharge at 2.2 W₁ for about 60 seconds;

a second low-power charge at 1.1 W₁ for about 120 seconds;

a second high-power charge at 2.2 W₁ for a time required for a first capacity to equal to a second capacity;

wherein

the first capacity is the total capacity discharged during the first low-power discharge step, the first high-power discharge step, the second low-power discharge step and the second high-power discharge step;

the second capacity is the total capacity charged during the first low-power charge step, the first high-power charge step, the second low-power charge step and the second high-power charge step;

W₁ is a power value determined by a 1C rated current multiplied by a nominal cell voltage; and

the second cell comprises a negative electrode comprising a composition that is identical to the composition of the negative electrode of the first cell except that the negative electrode of the second cell does not include the carbon material.

In certain embodiments, the nominal cell voltage ranges from about 1.0 V to about 3.0 V, for example 2.0 V. In certain embodiments, the nominal cell voltage ranges from about 0.1 V to about 10.0 V, from about 0.5 V to about 5.0 V, from about 0.75 V to about 7.5 V, from about 0.75 V to about 5.0 V, from about 1.0 V to about 5.0 V, from about 1.5 V to about 3.0 V, from about 0.5 V to about 2.5 V or from about 0.5 V to about 2.0 V.

In some embodiments of the foregoing, the first cell of has a 30% cycle life increase compared to the second cell. In some embodiments, the first cell has at least a 40%, at least a 50%, at least a 60%, at least a 70%, at least an 80%, at least a 90% or at least a 100% cycle life increase compared to the second cell.

One embodiment provides a first cell having a negative electrode comprising a composition according embodiments disclosed herein, wherein the first cell having a first recharge time that is at least 30% less than a second recharge time of a second cell, the second cell comprises a negative electrode comprising a composition that is identical to the composition the embodiment disclosed herein except the negative electrode of the second cell does not include the carbon material, wherein the first recharge time is the time required to replenish a capacity removed from the first cell during a 60 second 2C discharge by a 2.4V charge with no current limitation and the second recharge time is the time required to replenish a capacity removed from the second cell during a 60 second 2C discharge by a 2.4V charge with no current limitation.

In some embodiments, the first recharge time is at least 40% less than the second recharge time. In certain embodiments, the first recharge time is at least 50% less than the second recharge time.

After assembling the positive and negative plates to form cells, the battery may be subjected to a charging (i.e., formation) process. During this charging process, the composition of the chemically active materials may change to a state that provides an electrochemical potential between the positive and negative plates of the cells. For example, in a lead acid battery, the PbO active material of the positive plate may be electrically driven to lead dioxide (PbO₂), and the active material of the negative plate may be converted to porous metallic or sponge metallic lead. Conversely, during subsequent discharge of a lead acid battery, the chemically active materials of both the positive and negative plates convert to lead sulfate.

The compositions of the present disclosure include a network of pores, which can provide a large amount of surface area for each current collector. For example, in certain embodiments of the above described devices the carbon materials and the resultant composition are mesoporous, and in other embodiments the carbon materials and resultant composition are microporous. Current collectors comprising the compositions may exhibit a greater amount of surface area provided by conventional current collectors. Further, a composition may be fabricated to exhibit any combination of physical properties described above.

Some embodiments provide a first cell having a negative electrode comprising a composition according to embodiments disclosed herein, wherein the first cell has at least a 10% increase of dynamic charge acceptance after a history of charge as measured using average charge current normalized by C/20 capacity compared to a second cell, wherein the dynamic charge acceptance cycle and the second cell comprises a negative electrode comprising a composition that is identical to the composition of the negative electrode of the first cell except that the negative electrode of the second cell does not include the carbon material.

Other embodiments provide a first cell having a negative electrode comprising a composition according to embodiments disclosed herein, wherein the first cell has at least a 10% increase of average charge current normalized by C/20 capacity of dynamic charge acceptance after a history of charge compared to a second cell, wherein the dynamic charge acceptance cycle and the second cell comprises a negative electrode comprising a composition that is identical to the composition of the negative electrode of the first cell except that the negative electrode of the second cell has carbon black instead of the carbon material.

In some of the foregoing embodiments, the carbon black has a surface area of about 1500 m²/g, an aggregate size of about 185 μm and a pore volume of about 1.50 cc/g. In some embodiments, the carbon black has a surface area of about 120 m²/g, an aggregate size of about 175 μm and a pore volume of about 0.25 cc/g. In some embodiments, the carbon black is Agglomerated Carbon 1. In other embodiments, the carbon black is Agglomerated Carbon 2.

In certain embodiments, the first cell has at least a 15% increase of dynamic charge acceptance after a history of charge as measured using average charge current normalized by C/20 capacity compared to a second cell. In some other embodiments, the first cell has at least a 20% increase of dynamic charge acceptance after a history of charge as measured using average charge current normalized by C/20 capacity compared to a second cell. In some more specific embodiments, the first cell has at least a 25% increase of dynamic charge acceptance after a history of charge as measured using average charge current normalized by C/20 capacity compared to a second cell. In some embodiments, the first cell has at least a 30% increase of dynamic charge acceptance after a history of charge as measured using average charge current normalized by C/20 capacity compared to a second cell. In some other embodiments, the first cell has at least a 35% increase of dynamic charge acceptance after a history of charge as measured using average charge current normalized by C/20 capacity compared to a second cell. In some more specific embodiments, the first cell has at least a 5%, at least a 10%, at least a 40%, at least a 45%, at least a 50%, at least a 55%, at least a 60%, at least a 65%, at least a 70%, at least a 75%, at least a 80%, at least a 85%, at least a 90%, or at least a 95% increase of dynamic charge acceptance after a history of charge as measured using average charge current normalized by C/20 capacity compared to a second cell.

The substrate (i.e., support) for the active material may include several different material and physical configurations. For example, in certain embodiments, the substrate may comprise an electrically conductive material, glass, or a polymer. In certain embodiments, the substrate may comprise lead or polycarbonate. The substrate may be formed as a single sheet of material. Alternatively, the substrate may comprise an open structure, such as a grid pattern having cross members and struts.

The substrate may also comprise a tab for establishing an electrical connection to a current collector. Alternatively, especially in embodiments where substrate includes a polymer or material with low electrical conductivity, a carbon layer may be configured to include a tab of material for establishing an electrical connection with a current collector.

The compositions may be physically attached to the substrate such that the substrate can provide support for the composition. In one embodiment, the composition may be laminated to the substrate. For example, the composition and substrate may be subjected to any suitable laminating process, which may comprise the application of heat and/or pressure, such that the composition becomes physically attached to the substrate. In certain embodiments, heat and/or pressure sensitive laminating films or adhesives may be used to aid in the lamination process.

In other embodiments, the composition may be physically attached to the substrate via a system of mechanical fasteners. This system of fasteners may comprise any suitable type of fasteners capable of fastening a carbon layer to a support. For example, a composition may be joined to a support using staples, wire or plastic loop fasteners, rivets, swaged fasteners, screws, etc. Alternatively, compositions can be sewn to a support using wire thread, or other types of thread. In some of the embodiments, the composition may further comprise a binder (e.g., Teflon and the like) to facilitate attachment of the composition to the substrate.

In addition to the two-layered current collector (i.e., a composition plus substrate) described above, the presently disclosed embodiments include other types of current collectors in combination with the two-layered current collector. For example, current collectors suitable for use with the presently disclosed embodiments may be formed substantially from carbon alone. That is, a carbon current collector consistent with this embodiment would lack a support backing. The carbon current collector may, however, comprise other materials, such as, metals deposited on a portion of the carbon surface to aid in establishing electrical contact with the carbon current collector.

Other current collectors may be formed substantially from an electrically conductive material, such as lead and lead alloys. The current collector may be made from lead and may be formed to include a grid pattern of cross members and struts. In one embodiment, the current collector may include a radial grid pattern such that struts intersect cross members at an angle. Current collector may also include a tab useful for establishing electrical contact to the current collector.

In one embodiment, the current collector may be made from lead and may be formed to include a hexagonal grid pattern. Specifically, the structural elements of the current collector may be configured to form a plurality of hexagonally shaped interstices in a hexagonally close packed arrangement. The current collector may also include a tab useful for establishing electrical contact to the current collector.

Consistent with the present disclosure, cells may be configured to include several different current collector arrangements. In one embodiment, one or more negative plates of a cell may comprise a current collector having a carbon layer disposed on a substrate. In this embodiment, one or more positive plates of a cell may include a carbon current collector (e.g., a carbon layer not including a substrate) or a lead grid current collector (e.g., a lead grid collector not including a layer of carbon).

In another embodiment, one or more positive plates of a cell may include a current collector comprising a carbon layer deposited on a substrate. In this embodiment, one or more negative plates of a cell may include a carbon current collector (e.g., a carbon collector not including a substrate) or a lead grid current collector (e.g., a lead grid collector not including a layer of carbon).

In yet another embodiment, both one or more negative plates and one or more positive plates may include a current collector comprising a carbon layer deposited on a substrate. Thus, in this embodiment, the two-layered current collector may be incorporated into both the positive and the negative electrode plates.

By incorporating the compositions into the positive and/or negative plates of a battery, corrosion of the current collectors may be suppressed. As a result, batteries consistent with the present disclosure may offer significantly longer service lives. Additionally, the disclosed carbon current collectors may be pliable, and therefore, they may be less susceptible to damage from vibration or shock as compared to current collectors made from graphite plates or other brittle materials. Batteries including carbon current collectors may perform well in vehicular applications, or other applications, where vibration and shock are common.

In another embodiment, the composition comprising carbon material may also comprise certain metal and metal oxide additives that enhance electrochemical performance. To this end, the cathode paste comprising lead and lead oxides can be mixed intimately with carbon materials disclosed herein. Minor additions of certain other elements such as tin, antimony, bismuth, arsenic, tungsten, silver, zinc, cadmium, indium, silicon, oxides thereof, compounds comprising the same or combinations thereof offer the potential to increase the chemical energy storage efficiency of the positive active material. Some of these metal elements and their oxides act to replicate the lead dioxide crystal structure and provide additional nucleation sites for the charge discharge processes as well as an additional conductive network within the lead dioxide active material. These materials can be located within the pores of the carbon material and on the carbon material surface before the paste is applied. These metals can act as conductivity aids for the lead dioxide positive active material as well as increasing the efficiency of the lead dioxide active material through this increased conductivity network within the cathode. In certain embodiments, impurities such as arsenic, cobalt, nickel, iron, chromium and tellurium are minimized in the carbon and the electrode because they increase oxygen evolution on the cathode during the charge cycle.

In other embodiments, the composition does not contain significant quantities of metallic impurities such as sodium, potassium and especially calcium, magnesium, barium, strontium, chromium, nickel, iron and other metals, which form highly insoluble sulfate salts. These impurities will precipitate inside the pores of the carbon material and effectively impede its effectiveness. Sodium and potassium will neutralize an equi-molar amount of hydrogen ions and render them ineffective.

In another embodiment of the disclosure, the carbon material in the composition for use in the hybrid carbon lead energy storage device may be structured with a predominance of mesopores, that when mixed into the positive or negative electrodes will enhance the electrochemical performance. Without being bound by theory, these mesoporous carbon materials offer the ability to promote fluid electrolyte to fully penetrate the electrode. By increasing the fluid penetration within the electrode structure, the diffusion distances between the electrolyte ions (e.g., sulfate) and the active material is reduced and the chemical charge and discharge process can proceed more efficiently. In addition, the carbon material used in this embodiment may also comprise a number of micropores in conjunction with the mesopores.

Some embodiments provide use of the compositions, the electrodes, the cells, or the first cells as disclosed herein in an electrical energy storage device. In some embodiments, the electrical energy storage device is a battery. For example, in some embodiments, the electrical energy storage device is in a microhybrid, start-stop hybrid, mild-hybrid vehicle, vehicle with electric turbocharging, vehicle with regenerative braking, hybrid vehicle, an electric vehicle, a battery powered vehicle, industrial motive power such as forklifts, electric bikes, golf carts, aerospace applications, a power storage and distribution grid, a solar or wind power system, a power backup system such as emergency backup for portable military backup, hospitals or military infrastructure, manufacturing backup or a cellular tower power system. In some embodiments, the microhybrid, start-stop hybrid, mild-hybrid vehicle, vehicle with electric turbocharging, vehicle with regenerative braking, hybrid vehicle, electric vehicle or battery powered vehicle is a 3 wheeled vehicle. In other specific embodiments, the microhybrid, start-stop hybrid, mild-hybrid vehicle, vehicle with electric turbocharging, vehicle with regenerative braking, hybrid vehicle, electric vehicle or battery powered vehicle is an electronic rickshaw.

Certain embodiments provide a battery comprising the cell or the first cell of any one the embodiments disclosed herein. In some more specific embodiments, the battery further comprises an electrolyte. For example, the electrolyte comprises sulfuric acid, water, silica gel or combinations thereof. One embodiment provides use of the foregoing battery in a microhybrid, start-stop hybrid, mild-hybrid vehicle, vehicle with electric turbocharging, vehicle with regenerative braking, hybrid vehicle, electric vehicle, battery powered vehicle, industrial motive power such as forklifts, electric bikes, golf carts, aerospace applications, a power storage and distribution grid, a solar or wind power system, a power backup system such as emergency backup for portable military backup, hospitals or military infrastructure, and manufacturing backup or a cellular tower power system.

In some embodiments, the microhybrid, start-stop hybrid, mild-hybrid vehicle, vehicle with electric turbocharging, vehicle with regenerative braking, hybrid vehicle, electric vehicle or battery powered vehicle is an electric scooter or electric bicycle. In certain embodiments, the microhybrid, start-stop hybrid, mild-hybrid vehicle, vehicle with electric turbocharging, vehicle with regenerative braking, hybrid vehicle, electric vehicle or battery powered vehicle is a 2 wheeled vehicle.

In some of the foregoing embodiments, the use increases the cycle life of the battery by greater than about 25%. In certain embodiments, the use increases the cycle life of the battery by greater than about 50%. In some other embodiments, the use increases the cycle life of the battery by greater than about 100%. In certain other embodiments, use increases the cycle life of the battery by greater than about 200%. In some specific embodiments, the use increases the cycle life of the battery by greater than about 400%. In more specific embodiments, the use increases the cycle life of the battery by greater than about 25%, 50%, 75%, 100%, 150%, 200%, 300%, and 400%. In some of the foregoing embodiments, the increase is relative to a use without regenerative braking.

In some embodiments, the use increases the single charge drive time of the battery by greater than about 25%. In certain embodiments, the use increases the single charge drive time of the battery by greater than about 50%. In some other embodiments, the use increases the single charge drive time of the battery by greater than about 100%. In certain other embodiments, the use increases the single charge drive time of the battery by greater than about 200%. In some more specific embodiments, the use increases the single charge drive time of the battery by greater than about 5%, 10%, 15%, 20%, 25%, 30%, 35%, 40%, 45%, 50%, 55%, 60%, 65%, 70%, 75%, 80%, 85%, 90%, 95%, 100%, 150%, or 200%. In some of the foregoing embodiments, the increase is relative to a use without regenerative braking.

“Drive time” refers to the period of time a vehicle is operated. “Single charge drive time” refers to the time a battery operated, battery assisted, or electric vehicle can be operated without being charged from an external input (i.e., plugged in).

In some embodiments, the use increases the retained capacity of the battery by greater than about 5%. In some embodiments, the use increases the retained capacity of the battery by greater than about 25%. In certain specific embodiments, the use increases the retained capacity of the battery by greater than about 50%. In certain more specific embodiments, the use increases the retained capacity of the battery by greater than about 5%, 10%, 15%, or 20%. In some of the foregoing embodiments, the retained capacity is relative to an equivalent number of cycles on a system that is the same in all other respects except for the type of carbon used (e.g., low structured carbon black or expanded graphite).

In some other embodiments, the use increases the total drive time by greater than about 50%. In some embodiments, the use increases the total drive time by greater than about 200%. In some embodiments, the use increases the total drive time by greater than about 300%. In some embodiments, the use increases the total drive time by greater than about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 250%, or 300%. In any of the foregoing embodiments, the drive time is of the battery or of the vehicle.

In some embodiments, the increase is compared to a use without regenerative braking. In certain embodiments, the increase is compared to an equivalent battery or vehicle comprising alternative carbon material having a BET specific surface area less than 100 m²/g, a total pore volume of less than about 0.1 cc/g and/or a particle size less than about 5 microns. In some embodiments, the alternative carbon material is carbon black or graphite.

In some embodiments, the increase is compared after an equivalent number of cycles. In some embodiments, the use further comprises regenerative braking. In some embodiments, the regenerative braking maintains the same or similar individual charge, drive time, and total cycle life relative to a battery having a mass that is at least 10% greater than the battery comprising a composition comprising a lead component (e.g., leady oxide, porous metallic lead, metallic lead and/or lead sulfate), a carbon material at a concentration ranging from less than about 0.20% or greater than about 5.0% by weight of the composition, the carbon material having a BET specific surface area less than about 100 m²/g, a total pore volume of less than about 0.1 cc/g and a particle size less than about 5 microns and an expander.

In some embodiments, the regenerative braking maintains the same or similar individual charge, drive time, and total cycle life relative to a battery having a mass that is at least 30% greater than a battery according to any of the foregoing embodiments. In certain embodiments, the regenerative braking maintains the same or similar individual charge, drive time, and total cycle life relative to a battery having a mass that is at least 40% greater than a battery according to any of the foregoing embodiments. In certain embodiments, the regenerative braking maintains the same or similar individual charge, drive time, and total cycle life relative to a battery having a mass that is at least 5%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300%, 400% 500%, 600%, 700%, 800%, 900%, or 1000% greater than a battery according to any of the foregoing embodiments. In certain embodiments, the regenerative braking maintains the same or similar individual charge, drive time, and total cycle life relative to a battery having a mass that is at least 50% to 100% greater than a battery according to any of the foregoing embodiments. As used herein above, 100% greater is synonymous with 2× greater, 50% greater is synonymous with 1.5× greater, etc.

“Regenerative braking” or “regen” refers to conversion of kinetic energy (e.g., of a vehicle) to electrical or chemical energy. In some embodiments, the kinetic energy of the vehicle is converted to generate and store chemical or electrical energy in a battery. Regenerative braking captures kinetic energy of the vehicle as it decelerates. In conventional vehicles, kinetic energy is usually dissipated as heat at the vehicle's brakes or engine during deceleration. Regenerative braking converts the captured kinetic energy into electrical energy in the form of a stored charge in the vehicle's battery. This stored energy can be used later to power an electric motor. Consequently, regenerative braking also reduces fuel usage and emission production. In certain vehicle configurations, the engine can be disconnected from the rest of the powertrain thereby allowing more of the kinetic energy to be converted into stored electrical energy.

One embodiment provides a vehicle comprising at least two wheels, a battery comprising a composition comprising leady oxide, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander.

Another embodiment provides a vehicle comprising at least two wheels, a battery comprising a composition comprising porous metallic lead, a carbon material at a concentration ranging from less than 0.10% or greater than about 5.0% by weight of the composition, the carbon material having a BET specific surface area greater than about 100 m²/g, a total pore volume of greater than about 0.1 cc/g and a particle size greater than about 5 microns, and an expander.

Another embodiment provides a vehicle comprising at least two wheels, a battery comprising a composition comprising metallic lead, lead sulfate, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander.

One embodiment provides a method for operating a vehicle having at least two wheels and a battery, the method comprising converting kinetic energy of one or more wheels to electrical energy and applying the electrical energy to the battery, wherein the battery comprises a composition comprising leady oxide, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander. In some embodiments, converting kinetic energy comprises regenerative braking.

A different embodiment provides a method for operating a vehicle having at least two wheels and a battery, the method comprising converting kinetic energy of one or more wheels to electrical energy and applying the electrical energy to the battery, wherein the battery comprises a composition comprising porous metallic lead, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander. In some embodiments, converting kinetic energy comprises regenerative braking.

Another embodiment provides a method for operating a vehicle having at least two wheels and a battery, the method comprising converting kinetic energy of one or more wheels to electrical energy and applying the electrical energy to the battery, wherein the battery comprises a composition comprising metallic lead, lead sulfate, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander. In some embodiments, converting kinetic energy comprises regenerative braking.

One embodiment provides a method for operating a vehicle having at least two wheels and a battery, the method comprising applying a current to the battery during regenerative braking of one or more of the wheels, wherein the battery comprises a composition comprising leady oxide, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander.

A different embodiment provides a method for operating a vehicle having at least two wheels and a battery, the method comprising applying a current to the battery during regenerative braking of one or more of the wheels, wherein the battery comprises a composition comprising porous metallic lead, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander.

Another embodiment provides a method for operating a vehicle having at least two wheels and a battery, the method comprising applying a current to the battery during regenerative braking of one or more of the wheels, wherein the battery comprises a composition comprising metallic lead, lead sulfate, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander.

One embodiment provides a method for operating a vehicle having a battery, the method comprising transitioning the vehicle from a non-regenerative braking state to a regenerative braking state, wherein the battery comprises a composition comprising leady oxide, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander.

A different embodiment provides a method for operating a vehicle having a battery, the method comprising transitioning the vehicle from a non-regenerative braking state to a regenerative braking state, wherein the battery comprises a composition comprising porous metallic lead, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander.

Another embodiment provides a method for operating a vehicle having a battery, the method comprising transitioning the vehicle from a non-regenerative braking state to a regenerative braking state, wherein the battery comprises a composition comprising metallic lead, lead sulfate, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander.

In certain embodiments, the method increases the cycle life of the battery by greater than about 25%. In certain embodiments, the method increases the cycle life of the battery by greater than about 50%. In some other embodiments, the method increases the cycle life of the battery by greater than about 100%. In certain other embodiments, the method increases the cycle life of the battery by greater than about 200%. In some specific embodiments, the method increases the cycle life of the battery by greater than about 400%. In more specific embodiments, the method increases the cycle life of the battery by greater than about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 300%, and 400%. In some of the foregoing embodiments, the increase is relative to a method without converting kinetic energy of one or more wheels to electrical energy.

In some embodiments, the method increases the single charge drive time of the battery by greater than about 25%. In certain embodiments, the method increases the single charge drive time of the battery by greater than about 50%. In some other embodiments, the method increases the single charge drive time of the battery by greater than about 100%. In certain other embodiments, the method increases the single charge drive time of the battery by greater than about 200%. In some more specific embodiments, the method increases the single charge drive time of the battery by greater than about 5%, 10%, 15%, 20%, 25%, 30%, 35%, 40%, 45%, 50%, 55%, 60%, 65%, 70%, 75%, 80%, 85%, 90%, 95%, 100%, 150%, or 200%. In some of the foregoing embodiments, the increase is relative to a method without converting kinetic energy of one or more wheels to electrical energy.

In some embodiments, the method increases the retained capacity of the battery by greater than about 5%. In some embodiments, the method increases the retained capacity of the battery by greater than about 25%. In certain specific embodiments, the method increases the retained capacity of the battery by greater than about 50%. In certain more specific embodiments, the method increases the retained capacity of the battery by greater than about 5%, 10%, 15%, or 20%. In some of the foregoing embodiments, the retained capacity is relative to an equivalent number of cycles on a system that is the same in all other respects except for the type of carbon used (e.g., low structured carbon black or expanded graphite).

In some other embodiments, the method increases the total drive time by greater than about 50%. In some embodiments, the method increases the total drive time by greater than about 200%. In some embodiments, the method increases the total drive time by greater than about 300%. In some embodiments, the method increases the total drive time by greater than about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 250%, or 300%.

In some of the foregoing embodiments, the regenerative braking increases the total cycle life of the battery by about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 300%, and 400%.

In some of the foregoing embodiments, the retained capacity of the battery is increased by about 5%, 10%, 15%, or 20%. In some of the foregoing embodiments, the total drive time is increased by about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 250%, or 300%. In some foregoing embodiments, the increase is relative to a method that does not include regenerative braking.

In some of the foregoing embodiments, the increase is relative to a method wherein the battery comprises a composition comprising leady oxide, a carbon material at a concentration ranging from less than 0.10% or greater than about 5.0% by weight of the composition, the carbon material having a BET specific surface area less than about 100 m²/g, a total pore volume of less than about 0.1 cc/g and a particle size less than about 5 microns, and an expander.

In some of the foregoing embodiments, the increase is relative to a method wherein the battery comprises a composition comprising porous metallic lead, a carbon material at a concentration ranging from less than 0.10% or greater than about 5.0% by weight of the composition, the carbon material having a BET specific surface area less than about 100 m²/g, a total pore volume of less than about 0.1 cc/g and a particle size less than about 5 microns, and an expander.

In some of the foregoing embodiments, the increase is relative to a method wherein the battery comprises a composition comprising metallic lead, lead sulfate, a carbon material at a concentration ranging from less than 0.10% or greater than about 5.0% by weight of the composition, the carbon material having a BET specific surface area less than about 100 m²/g, a total pore volume of less than about 0.1 cc/g and a particle size less than about 5 microns, and an expander.

As detailed above, some embodiments of the methods described herein relate to regenerative braking. Accordingly, one additional embodiment includes a regenerative braking system for a vehicle, the system comprising a battery comprising a composition comprising leady oxide, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander. In some embodiments, the composition comprises a carbon according to any one of the foregoing embodiments.

Another embodiment provides a regenerative braking system for a vehicle comprising a battery comprising a composition comprising porous metallic lead, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander. In certain embodiments, the composition comprises a carbon according to any one of the foregoing embodiments.

Still another embodiment provides a regenerative braking system for a vehicle comprising a battery comprising a composition comprising metallic lead, lead sulfate, a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns, and an expander. In some specific embodiments, the composition comprises a carbon according to any one of the foregoing embodiments.

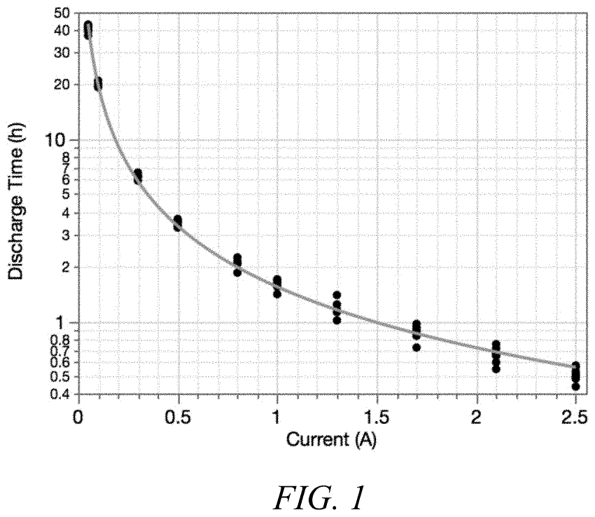

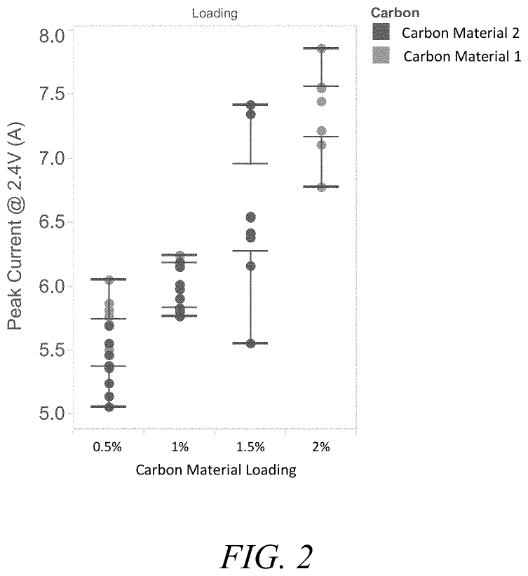

FIGS. 1-2 show various performance characteristics for lead acid batteries that contain carbon materials according to embodiments disclosed herein (e.g., Carbon Material 1 and Carbon Material 2). The various performance characteristics include current as a function of discharge time (FIG. 1), and peak current as a function of the carbon material concentration (FIG. 2).

### EXAMPLES

### Example 1

### Preparation of Lead Acid Paste

Lead-acid pastes were prepared utilizing an Eirich mixer with leady oxide (20% free-lead content), sulfuric acid, and additives as shown in Table 1 below. Resulting pastes were applied to PbCaSn alloy grids, humid cured at 50° C. and 98% humidity for 24 hours, and dry cured at 60° C. and 0% humidity for 24 hours. NAM and PAM compositions were independently formed through tank formation profiles. Lead-acid 2V cells consist of 1 NAM electrode sandwiched between 2 PAMs with porous polypropylene separator and 1.27 s.g. H₂SO₄ electrolyte. Cells are placed in a 25° C. water bath for the duration of electrochemical testing.

TABLE 1
Components of lead acid pastes used in cells for 2V devices

| Test | | | |
|---|---|---|---|
| Sample | # of cells | NAM | PAM |
| I-1 | 6 | No Carbon Material | No additive |
| I-2 | 10 | 1.0 wt% Carbon Material 1 | No additive |
| I-3 | 2 | No Carbon Material | 1.0 wt% tetrabasic lead sulfate |
| I-4 | 6 | 1.0 wt% Carbon Material 1 | 1.0 wt% tetrabasic lead sulfate |
| I-5 | 4 | No Carbon Material | 1.0 wt% tetrabasic lead sulfate, |
| | | | 3.0 wt% lead dioxide |
| I-6 | 4 | 1.0 wt% Carbon Material 1 | 1.0 wt% tetrabasic lead sulfate, |
| | | | 3.0 wt% lead dioxide |

### Example 2

### High Rate Partial State of Charge Cycle Testing

Cells prepared according to Example 1 were initially tested for a C/20 capacity followed by either a constant current (CC) or constant voltage (CV) High Rate Partial State of Charge (HRPSoC) test.

CC-HRPSoC discharges the cell to 50% state of charge and is cycled using a 60 second 2C discharge step and 60 second 2C charge step until the total voltage reaches 1.7V. After reaching 1.7V, the cell was recharged and a subsequent C/20 capacity test was conducted. If the new capacity was >70% the initial C/20 capacity, the CC-HRPSoC cycling was restarted.

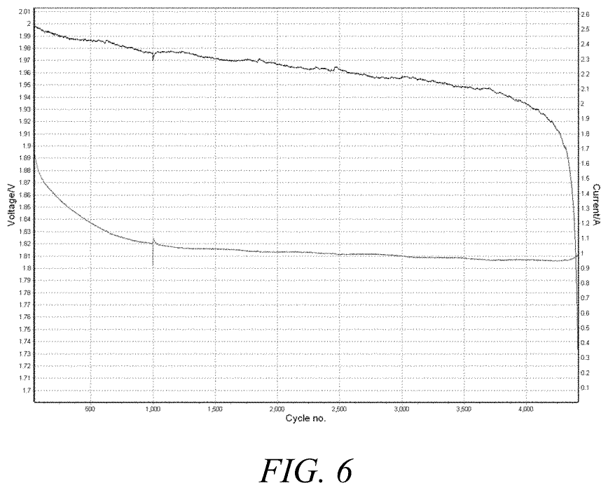

CV-HRPSoC testing similarly discharged the cell to 50% state of charge and cycled using a 60 second 2C discharge, but then utilized a 60 second 2.4V charging step until the total voltage reached 1.7V. After reaching 1.7V, the cell was recharged and a subsequent C/20 capacity test was conducted. If the new capacity was >70% the initial capacity, the CV-HRPSoC cycling was restarted (FIG. 6).

### Results for CC-HRPSoC

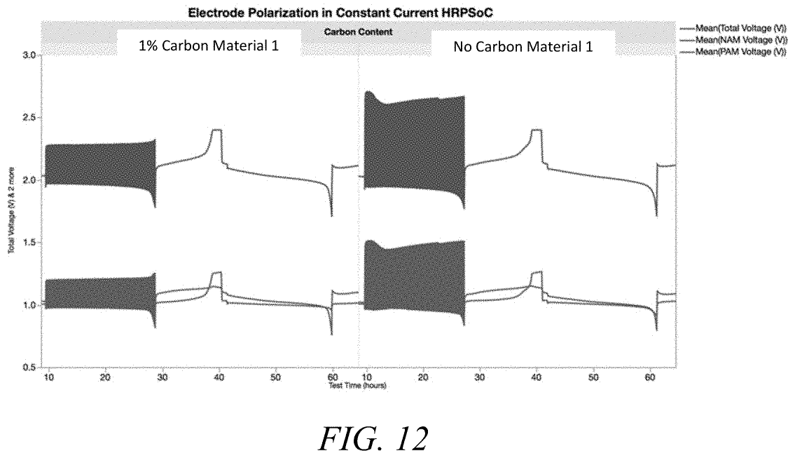

During CC-HRPSoC testing, reference electrode data showed a significant depolarization effect on Test Sample I-2. In FIG. 12, Test Sample I-1 shows voltages as high as 1.5V during charging steps Test Sample I-2 only experiences a maximum voltage of 1.1V under the same conditions. The total voltage drops to 1.7V during cycling which was shown to be driven by the PAM voltage for both electrodes as well as the subsequent C/20 capacity test.

### Results for CV-HRPSoC

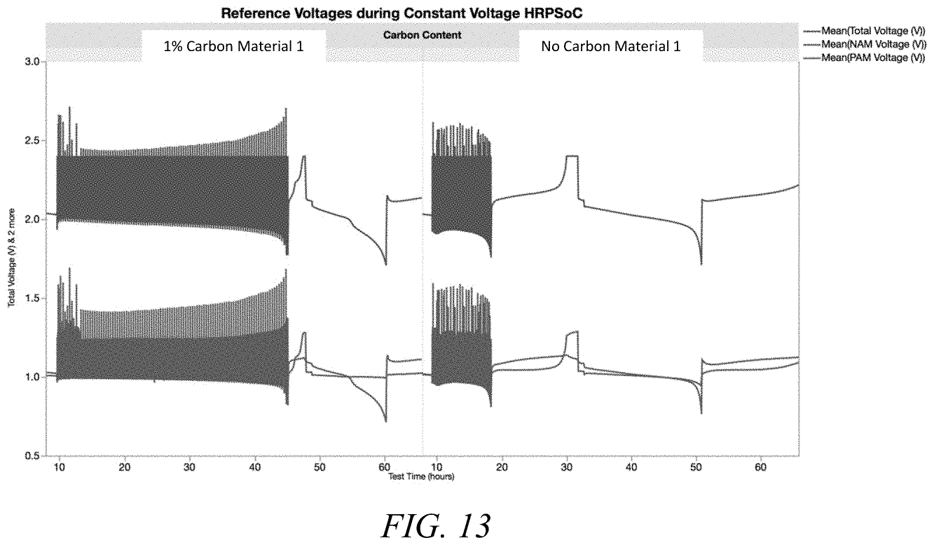

During CV-HRPSoC testing, reference electrode data does not show the same distinction in electrode polarization as shown in CC-HRPSoC. However, a much greater differentiation in cycle life is observed between Test Samples I-2, I-4 and I-6 and Test Samples I-1, I-3 and I-5 across all PAM types (Table 2). The cycle life end conditions and subsequent C/20 capacity tests are both PAM driven regardless of NAM composition (FIG. 13), which is similar to CC-HRPSoC 2V testing.

TABLE 2
Number of cycles for CV-HRPSoC Test

| Test Sample | Number of Cycles |
|---|---|
| I-I | 260 |
| I-2 | 1670 |
| I-3 | 1530 |
| I-4 | 3150 |
| I-5 | 2970 |
| I-6 | 4800 |

Further analysis revealed the capacity required to recharge the cells after CV-HRPSoC cycling varied depending on NAM composition (FIG. 13). This suggested that cycling does not remain at a 50% state of charge as CC-HRPSoC should, and that the NAM composition affects the state of charge at which the cell is cycled. The end of cycling state of charge was calculated as:

$$\% State of Charge = 100 \% - \frac{Recharge capacity after cycling}{Discharge capacity after cycling}$$

TABLE 3
State of Charge after CV-HRPSoC

| Test Sample | % State of Charge |
|---|---|
| I-1 | 31% |
| I-2 | 68% |
| I-3 | 30% |
| I-4 | 56% |
| I-5 | 39% |
| I-6 | 52% |

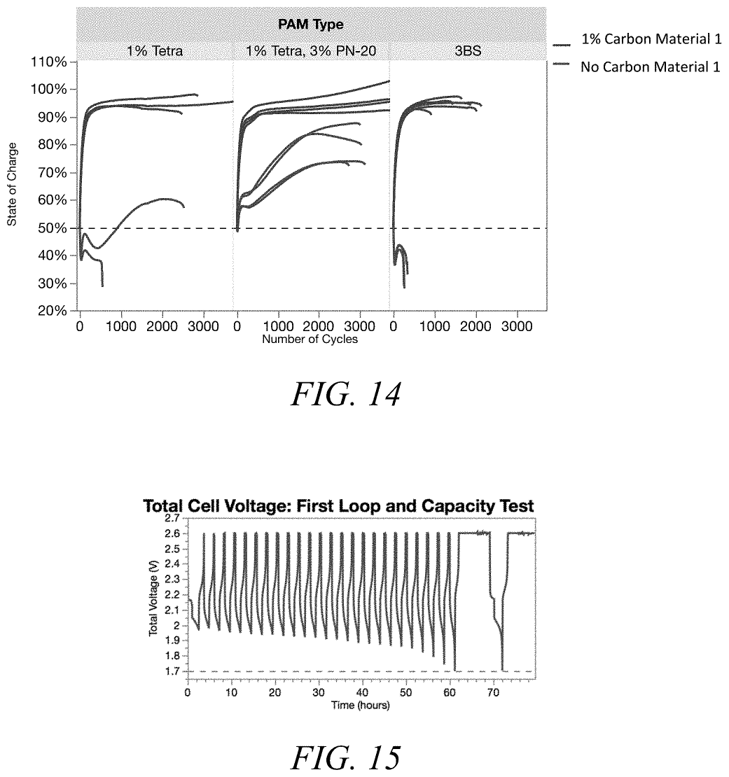

To better understand this characteristic, the difference between charge capacity and discharge capacity of each cycle was calculated and then combined over the life of the electrochemical profile for all Test Samples. This calculation provided a way to track the state of charge during constant voltage cycling over time. FIG. 14 provided a comparison between Test Samples I-2, I-4 and I-6 and Test Samples I-1, I-3 and I-5 across all PAM types. In Test Samples I-1, 1-3 and 1-5, the PAM type provides the biggest change in charge acceptance with Test Sample I-5 charging up over time and Test Sample I-1 discharging and failing in under 500 cycles. However, Test Samples I-2, I-4 and I-6 showed greatly increased charge acceptance across all types of PAMs, all of which charge to >90% state of charge in less than 300 cycles.

In all, CC-HRPSoC cycling showed that Carbon Material 1 helped depolarize charging steps for lead-acid cells. CV-HRPSoC cycling showed that Carbon Material 1 increased charge acceptance in constant voltage charging applications and allowed more rapid charging across all PAM types.

### Example 3

### Motive Cycling

A motive-style duty cycling test was used to cycle between 20% and 80% of the cell capacity at relatively slow rates. Cells tested were prepared according to the components listed in Table 4, below:

TABLE 4
Components of electrodes

| Component | Test Sample III-1 | Test Sample III-2 |
|---|---|---|
| Leady Oxide | 98.1 wt% | 98.1 wt% |
| Barium Sulfate | 0.6 wt% | 0.6 wt% |
| Lignin | 0.2 wt% | 0.2 wt% |
| Carbon Black | 0.1 wt% | 0.1 wt% |
| Carbon Material 1 | — | 1 wt% |
| Agglomerated | 1 wt% | — |
| Carbon 1 | | |

All electrodes were hand-pasted, humid cured at 50° C. and 98% RH for 24 hours, and tank formed. All PAMs consisted of 1% Tetra L2 seeding and 3% PN-20 red lead. Cells were assembled with H₂SO₄ (1.27 specific gravity) and tested on a Maccor using an electrochemical screening profile prior to motive duty cycling.

The Motive Cycling Test followed the following steps:

1. Rest for 1 hour at open circuit voltage

2. Discharge at 800 mA until discharge voltage drops to 1.7 V and record initial capacity

3. Charge at 2.6 V (800 mA current-limit) until 125% capacity

4. Rest 1 minute

5. Discharge at 800 mA until 20% state-of-charge*

6. Rest for 1 minute

7. Charge at 2.6 V (800 mA current-limit) until 80% state-of-charge*

8. Rest for 1 minute

9. Repeat Steps 5-8 until discharge voltage drops to 1.7 V

10. Charge at 2.6 V (800 mA current-limit) until 125% capacity

11. Discharge at 800 mA until 1.7 V and record capacity
a. If capacity is >70% of initial capacity, resume cycling at Step 3
b. If capacity is <70% of initial capacity, terminate testing
c. If this is the tenth capacity check, terminate testing
   *State-of-charge end conditions were determined by the amp-hours discharged and charged relative to the initial capacity measurement.

In order to consolidate the results obtained from Motive Cycling Test, much of the data was analyzed by loop statistics rather than by cycle statistics. For clarification, one cycle is recorded as a discharge and recharge (Steps 5-8) while one loop is recorded each time the cell voltage drops to 1.7 V (FIG. 15).

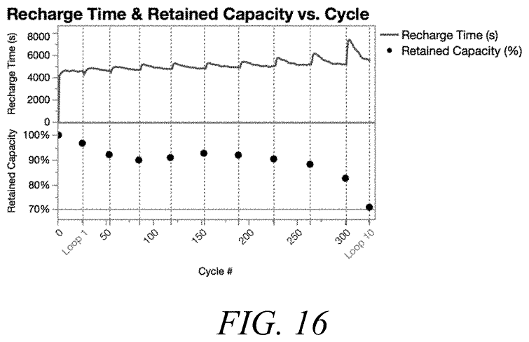

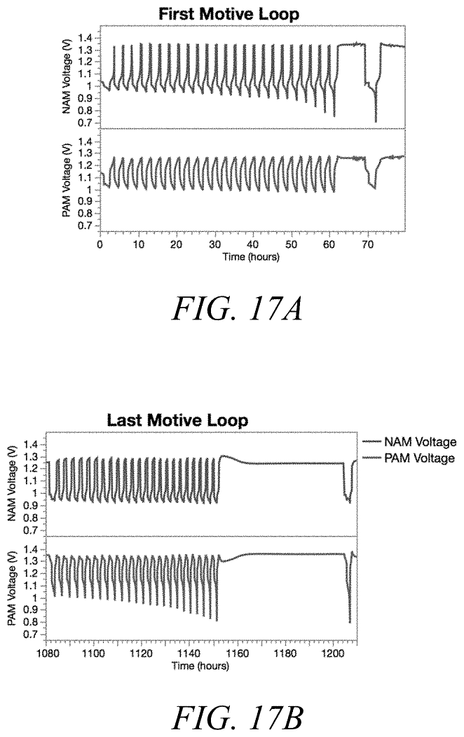

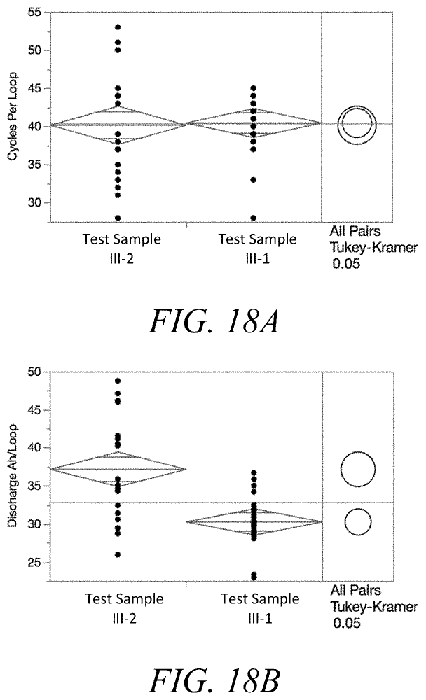

By using a capacity-based end condition during charging steps, the recharge time for each cycle can be measured. In FIG. 16, the recharge time is plotted against the cycle number. The retained capacity is measured at the end of each loop and cycling proceeds for 10 loops unless the retained capacity drops below 70%.

The number of cycles, amp-hours discharged, maximum and minimum recharge times, and retained capacity were measured for each loop. As the motive duty cycling proceeded, the maximum and minimum charge times tended to increase as the electrodes deteriorate and the retained capacity decreased.

Using a reference electrode, the PAM and NAM voltages were separated to determine which electrode was dropping in voltage as well as which electrode was limiting the cell's capacity. For both Test Sample III-1 and Test Sample III-2, the first loop showed a drop in NAM voltage while cycling to bring the total voltage to 1.7 V with a NAM-limited capacity test. Over the course of the duty profile, the PAM began to dominate the voltage drop as well as being the capacity-limiting electrode.

Deconstruction of the cells showed that the PAM material had significantly shed from the grid causing a large increase in inter-particle resistance and a loss of active mass. The recharge time between cycling and capacity tests increased from the first to last motive loop due to the increase in cell resistance.

A comparison of initial screening tests and electrode properties are listed in Table 5. While both NAM batches have similar masses, the C/20 and 1C capacities of Test Sample III-1 cells are lower than Test Sample 111-2 cells.

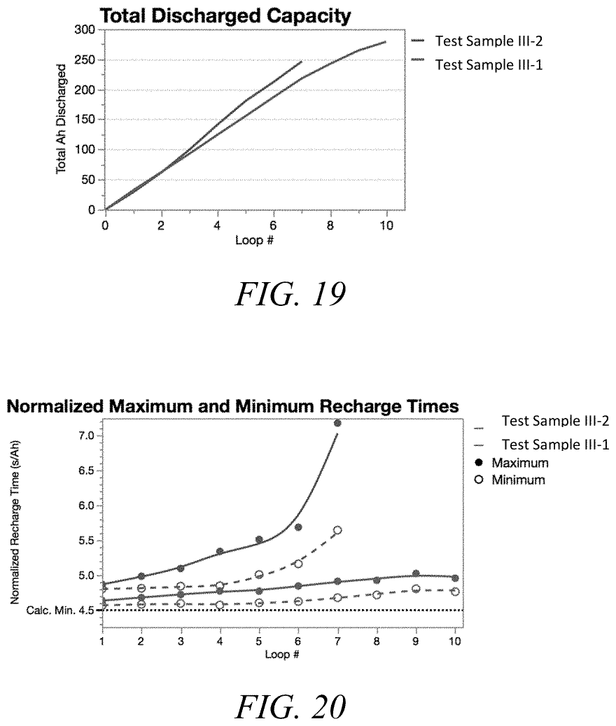

Since the motive cycle test is relative to the capacity of the cell, the total amp-hours discharged per cycle will be lower with lower capacity cells. As shown in FIGS. 22A and 22B, the average number of cycles per loop is equivalent between Test Samples III-1 and III-2 which leads to a greater number of amp-hours discharged per loop for the higher capacity Test Sample 111-2 cells. However, Test Sample III-1 cells were able to retain their capacities more effectively than Test Sample 111-2 cells allowing the Test Sample III-1 cells to cycle for a greater number of loops and total number of cycles. Due to the increase in total cycles, Test Sample III-1 cells discharged a greater number of total amp-hours throughout the motive cycle testing (FIG. 19; average of 4 cells).

TABLE 5
Summary of electrode properties

| | Test Sample III-1 | Test Sample III-2 |
|---|---|---|
| NAM Mass | 11.9 g | 11.9 g |
| C/20 Capacity | 1.6 Ah | 1.8 Ah |
| 1C Capacity | 1.3 Ah | 1.6 Ah |

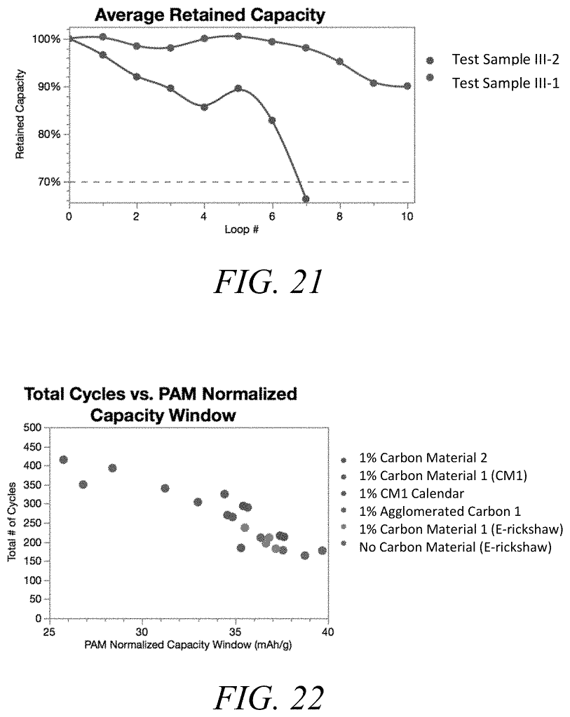

In order to compare the recharge times between cells, the recharge time is normalized based on the absolute capacity each cell recharges (which is a function of the cell's total capacity). In FIG. 20, Test Sample III-2 had higher normalized recharge times than Test Sample III-1 (average of 4 cells). The absolute minimum for a normalized recharge time is calculated to be 4.5 s/Ah with an 800 mA current-limit in this motive duty. Test Sample III-1 recharge times were more stable throughout the lifetime of the cell testing, which reached an average maximum recharge time of 5.0 s/Ah at Loop 9. Test Sample III-2 average recharge time achieved a maximum of 7.2 s/Ah at Loop 7. FIG. 21 plots the average retained capacity measured at the end of each loop, which highlights the ability of Test Sample III-1 to maintain a higher capacity throughout the Motive Cycling Test.

Through the use of reference electrodes, the motive cycling test is shown to fail due to PAM deterioration. Across multiple 2V builds, the properties of the PAM have a large impact on the total cycle life of each cell. FIG. 22 shows the correlation between the total number of cycles and the PAM normalized capacity window. The PAM normalized capacity window is calculated by dividing the capacity discharged each motive cycle (which is 60% of the total NAM-limited capacity) by the total mass of the PAM. This calculation is a way to quantify the degree of capacity change that occurs on the PAM during each cycle. A smaller PAM normalized capacity window relates to a smaller portion of the PAM being cycled with each motive cycle.

This calculation suggests the total cycle life of each cell was a function of the PAM normalized capacity window. The smaller the window of PAM utilization on each cycle, the longer the cell was able to cycle until it PAM fails. Within the current system, the NAM formulation doesn't have a measurable effect on the total cycle life of a cell regardless of the presence of high structured carbon additives. Therefore, differences in total amp-hours discharged, total number of cycles, or PAM-limited retained capacities are not solely attributable to NAM formulation.

### Example 4

### Lead Acid Electrochemical Screening Profile

Electrochemical testing and time-varied high-rate partial-state-of-charge micro cycling was utilized to screen and test 2V lead-acid cells. Lead-acid electrodes were hand-pasted, cured at 50° C. and 98% RH for 24 hours, and tank formed. NAM materials were prepared with 1 wt % Carbon Material 1 (Test Sample IV-4) and without any Carbon Material 1 (Test Sample IV-2).

Cells were assembled and tested on the Maccor using the following tests, discussed in more detail below:
1. C/20 Capacity Test
2. Initial Recharge
3. Static Charge Acceptance at 80% State of Charge
4. Motive Power Recharge at 20% State-of-Charge
5. Gassing Overvoltage Scan
6. 1C Capacity Test
7. Hybrid Pulse Power Capability Test (HPPC)
8. Time-Varied High-Rate Partial-State-of-Charge Micro Cycling (TV-HRPSoC Micro)

### C/20 Capacity Test

The C/20 Capacity Test applied a 100 mA constant current discharge until the cell voltage dropped to 1.7V. Depending on the mass of the NAM in the cell, this test ranged from 17-23 hours. A typical cell had a C/20 capacity of 2 Ah.

### Initial Recharge

After being completely discharged by the C/20 capacity test, the Initial Recharge began by applying a 2.67V constant voltage charge with a current limit of 800 mA until 125% of the C/20 capacity was applied to the cell. Due to the current limit, the cell was effectively charged with an 800 mA constant current charge step as the cell voltage slowly rose. When the cell voltage reached the set charge voltage, the program then became a constant voltage charge step held at 2.67V and the current decayed.

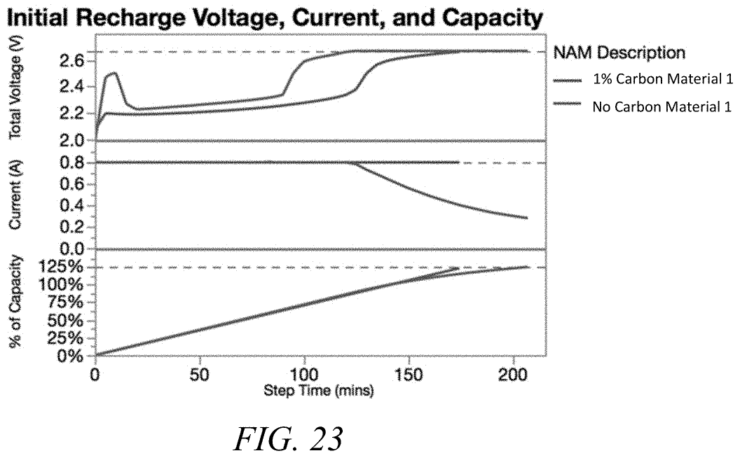

The amount of time the charge step took to reach 125% of the C/20 capacity was measured. Test Sample IV-2 took longer to complete this step than cells containing Test Sample IV-1. With 1 wt % Carbon Material 1 in the NAM, the charge step reached the 125% capacity end condition even before the total voltage reaches 2.67V. The performance of Test Sample IV-1 is illustrated in FIG. 23 with parameter limits represented by dotted lines.

### Static Charge Acceptance

After the initial recharge described above, the cells were discharged at a C/20 rate to 80% state-of-charge (SoC). Static Charge Acceptance used a 2.4V constant voltage charge for 15 minutes starting at an 80% SoC. The peak current achieved during this step was measured as well as the total amp-hours applied to the cell. This step did not have any current limit and doesn't reach 100% SoC. FIG. 2 shows increased loading of Carbon Material 1 and Carbon Material 2 have increased peak current during static charge acceptance testing.

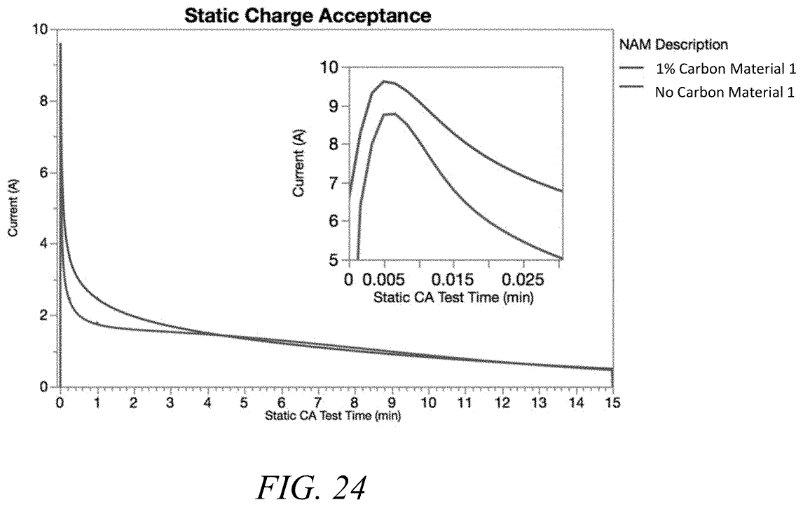

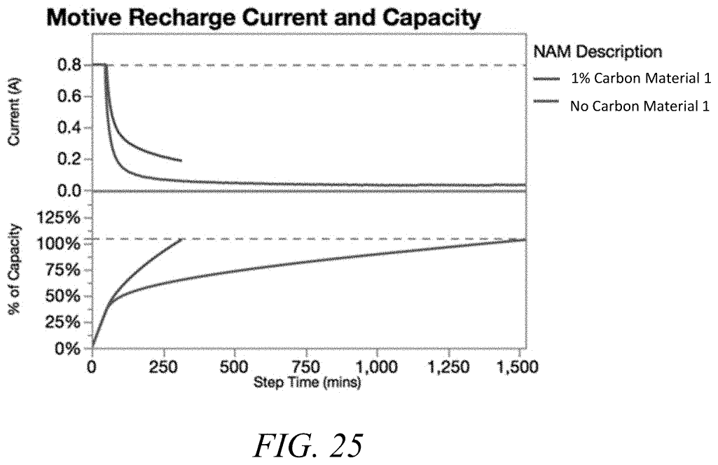

FIG. 24 shows the current produced by the 2.4V charge starting at 80% SoC. The inset of FIG. 24 is a zoom view of the peak current that occurs in the first couple seconds of the test. An increase in peak current was observed for Test Sample IV-1, but the total 15 minute capacity did not show a statistically significant separation between cells containing either Test Sample IV-1 or IV-2. Rather, the 15 minute capacity appears to be a function of the initial C/20 cell capacity.

### Motive Power Recharge

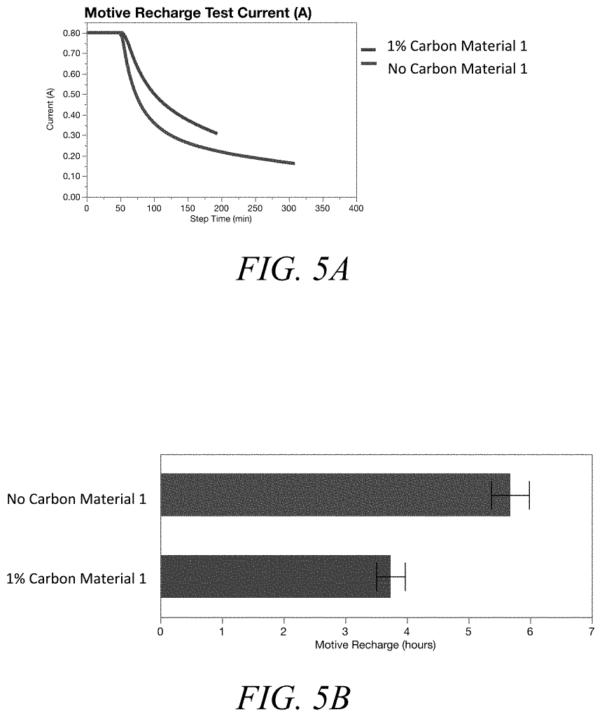

The cells containing Test Samples IV-1 and V-2 were discharged to a 20% SoC using a C/20 rate. Starting at a 20% SoC, a 2.6V constant voltage charge with an 800 mA current limit was applied until 105% of the C/20 capacity was reached. It was observed that, similarly to the initial recharge step, the current limit acted as a constant current charge step until the cell voltage reached 2.6V. When the cell voltage reached 2.6V, it became a constant voltage recharge. Due to the lower charge voltage, the recharge spent less time acting as a constant current charge and revealed a bigger difference between Test Samples IV-1 and IV-2 (see also FIGS. 5A, 5B, & 10).

### Gassing Overvoltage Scan

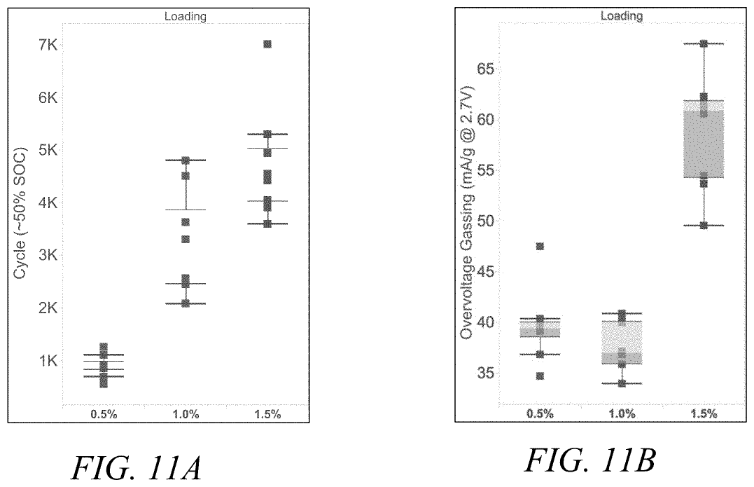

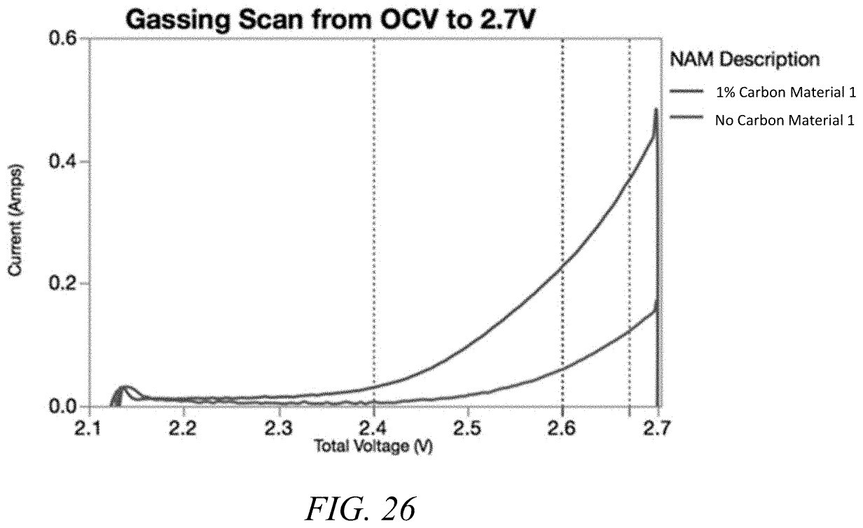

After recharging to full states of charge, the cells were scanned from open-circuit voltage to 2.7V at a 0.5 mV/s rate. The current was measured as a function of voltage to understand at what voltage the gassing current became significant and the extent of gassing is at 2.7V. High surface area carbons increase the severity of gassing, which is observed by the increase in gassing current in cells Test Sample IV-1. At 2.4V, the current difference was small. However, the extent of gassing separation was exaggerated as the voltage rose to 2.7V (see FIG. 26). The cells rested at open-circuit after the gassing scan was completed (see also FIGS. 11A and 11B).

### IC Capacity Test

The 1C Capacity Test used a constant 1.0 A discharge until the cell voltage dropped to 1.7V. This test ranged from 1-2 hours depending on NAM mass.

### Hybrid Pulse Power Capability (HPPC)

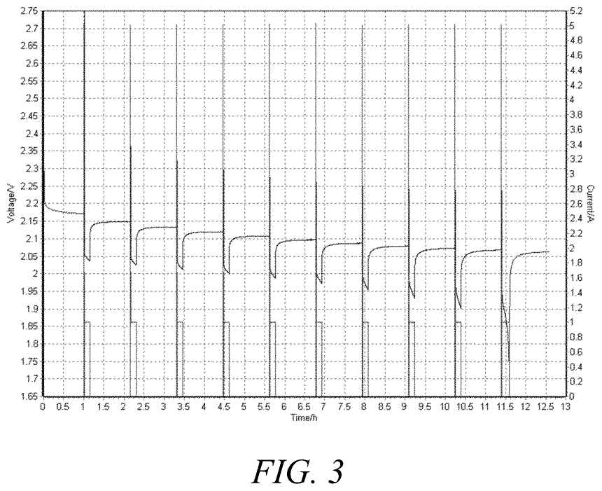

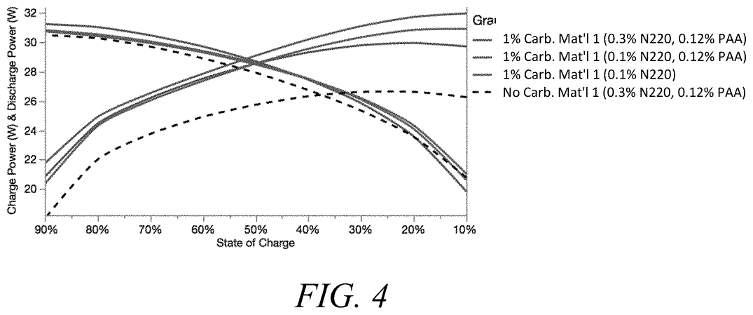

The HPPC test measured the capability of a cell to charge and discharge at high rates across multiple states-of-charge. The HPPC test is carried out at 10% state-of-charge increments, the cell experienced a 7.5 A (7.5C) discharge for 1 second and a 2.5 A (2.5C) charge for 10 seconds (FIG. 3). The voltage was measured in order to calculate the discharge power and charge power at each state-of-charge. The introduction of 1 wt % Carbon Material 1 had a beneficial effect on charge power, but discharge power showed only a minimal difference (FIG. 4).

### Time-Varied HRPSoC MicroCycling

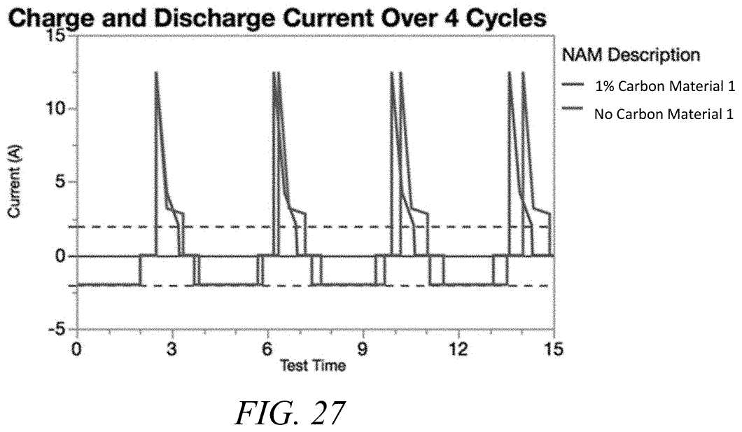

Cycle life testing started at a 50% state-of-charge, and was achieved by using a 1C discharge after HPPC testing was applied. Each cycle pulled a 2.0 A (2C) constant current discharge for 60 seconds followed by a 2.4V constant voltage recharge that was capacity limited to input the same capacity that was discharged in order to maintain a 50% state-of-charge throughout cycling. Due to the capacity end condition, the charge step time varied depending on the current allowed at 2.4V. This difference in charge time can be seen in FIG. 27.

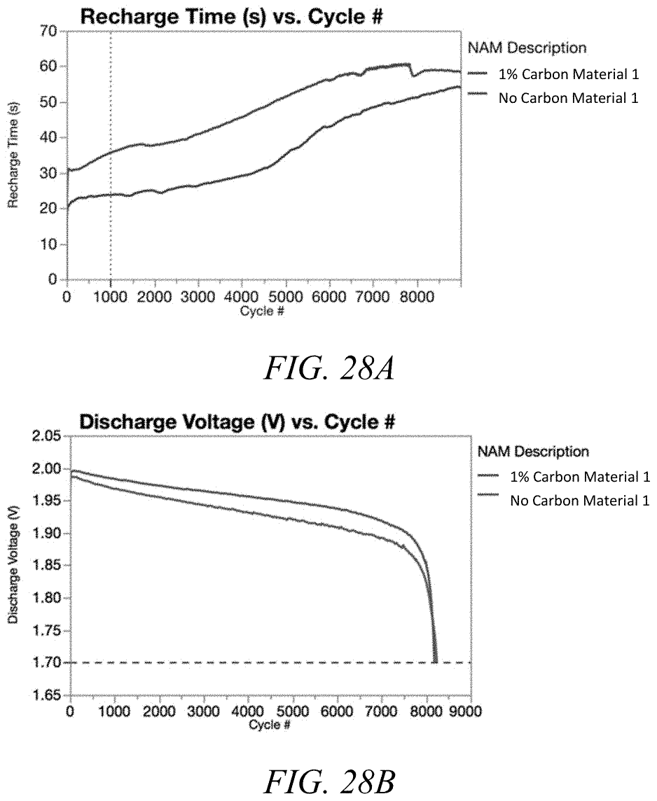

The charge time for each charge cycle was recorded and plotted as a function of cycle number. Cell stability during rapid recharge cycles were thusly observed. The charge time after 1000 cycles was also captured showing that a Test Sample IV-1 cell charges substantially faster than a Test Sample IV-2 cell. Also, a semi-stable region of ˜4000 cycles for Test Sample IV-1 was observed that maintains rapid recharge capabilites while Test Sample IV-2 cells have continually increasing recharge times (see FIG. 28A).

Cycling proceeds as long as the total voltage is above 1.7V. Regardless of carbon content, cells cycled for the same number of cycles. However, due to the difference in charging time, the Test Sample IV-2 cells take more time to complete the test. After reaching 1.7V, 1C capacity was measured at 1 A constant-current discharge to determine the amount of capacity lost due to cycling.

This combination of tests described above revealed advantageous and unexpected benefits of carbon materials (e.g., Carbon Material 1) in a lead-acid NAM (e.g., effectively reducing charging times). The greatest disparity is observed for the Motive Recharge Test showing a 5-fold reduction in the recharge time between the Test Sample IV-1 cell and the Test Sample IV-2 cell. Micro-Cycling recharge times were reduced for Test Sample IV-1 cells.

### Example 5

### Frequency Regulation

Frequency Regulation is an International Electrotechnical Commission (IEC) standard electrochemical profile that examines high-power cycling at partial-states-of-charge (PSoC) for on-grid energy storage applications (i.e., IEC 61427-2 testing protocol).

Multiple tests of frequency regulation tests were used to determine watt-hour efficiency and cycle life for test samples. The IEC 61427-2 test uses two tiers of constant power charge and discharge steps at a PSoC. Each low-power step is 2 minutes in length and each high-power step is 1 minute in length.

The last low-power charge step (starting at minute 10) used a higher constant power that lasted the same amount of time (2 minutes). The power was tailored to balance the net Amp-hours and the power remained equal to or less than the high-power steps. The last low-power charge step was extended for a time that was sufficient to balance the net Amp-hours. An additional stabilization charge step was added in every k amount of cycles to restore the state-of-charge.

Multiple versions of frequency regulation were designed and implemented as described in Table 6. Each version was utilized either to help develop a new and properly balanced test or to generate electrochemical characterization data. The constant power steps were scaled in order to achieve a state-of-charge swing of 10%. All tests began at 55% state-of-charge according to the 1C discharge capacity measured in the screening profile.

The Time Balanced and Power Balanced outputs were used to determine more balanced testing and the Cycle Life (Power Balanced version), Watt-Hour Efficiency and Cycle Life (Time Balanced version) were used for electrochemical characterization.

TABLE 6
Parameters used for multiple different versions of the Frequency Regulation tests

| Version | State of Charge Stabilization Mechanism | Output |
|---|---|---|
| Unbalanced | None | Time Balanced |
| Time Balanced | Constant +1:15 low-power charge time | Cycle Life |
| Time Variable | Variable charge time to balance net capacity | WattHr Efficiency |
| Max Power | Maximum Power for final charge step | Power Balanced |
| Power Balanced | Elevated Power for final charge step | Cycle Life |

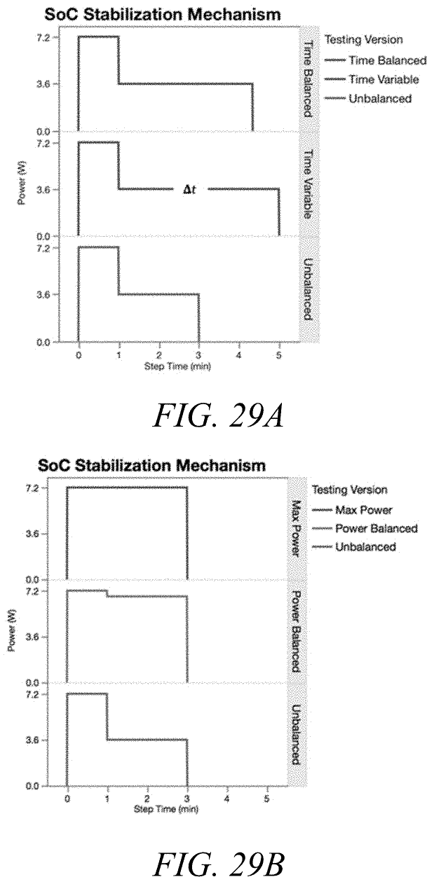

The state-of-charge stabilization mechanism during the last charge step for each version of frequency regulation testing is shown in FIGS. 29A and 29B as constant power profiles. Profiles could either vary the length of the last low-power charge time (FIG. 29A) or the power of the last charge step (FIG. 29B) in comparison to the unbalanced profile.

### Unbalanced Frequency Regulation

The Unbalanced version of the Frequency Regulation test kept the charge and discharge steps equivalent in both power and time. The imbalance in capacity was measured in to develop a capacity balanced test. Testing was implemented on cells containing the following components:

| | Carbon | Carbon | Barium | |
|---|---|---|---|---|
| | Material 1 | Black † | Sulfate | Lignin |
| Test Sample V-1 | 1.0 wt% | 0.1 wt% | 1.0 wt% | 0.2 wt% |

†Carbon black was Agglomerated Carbon 2
‡Lignin was Vanisperse HT-1 (Borregaard LignoTech, Sarpsborg, Norway)

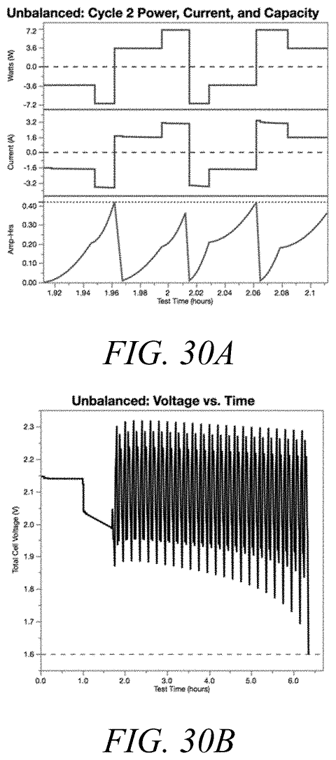

Testing was terminated once the total cell voltage dropped to 1.6V. Testing showed the average charge current was 1.6 A for low-power steps and 3.1 A for high-power steps while the average discharge current was 1.8 A for low-power steps and 3.7 A for high-power steps. Thus, the charge steps only provided 86% of the discharged capacity (as seen in FIGS. 30A and 30B). The cells were only able to cycle for 24 cycles due to the imbalance in charge capacity/discharge capacity.

To create the Time Balanced test only the final low-power charge step was increased in duration. Using average currents listed above, the Frequency Regulation test required 86 mAh from the final low-power step. Extension of the low-power step for an extra 1.25 minutes, generated a 1.6 A current and 86 mAh over 3.25 minutes.

### Time Balanced Frequency Regulation

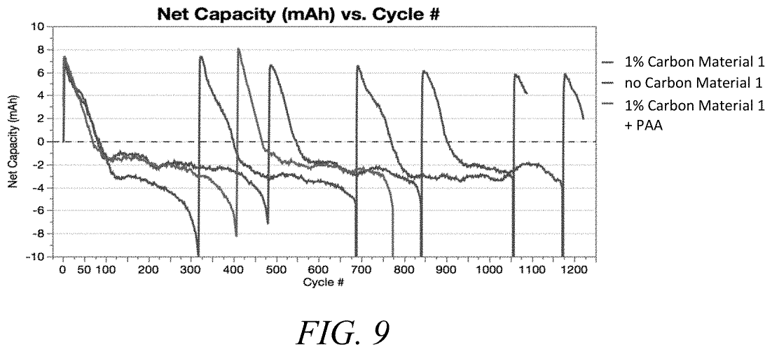

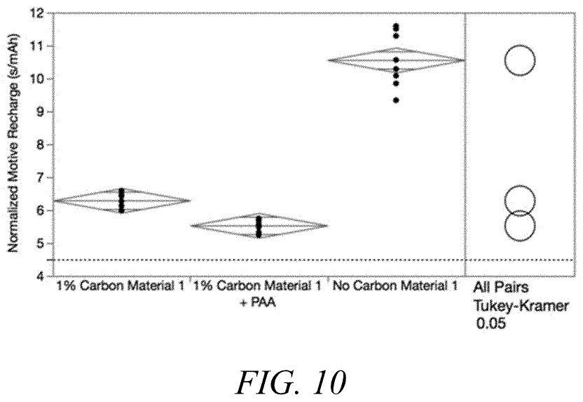

Using the extra 1.25 minutes of charge time to balance the capacity, the Time Balanced Frequency Regulation was implemented on three cell types outlined according to Table 7, below. Each cell type provided 4 cells for this test. A capacity test was added to the end of cycling to measure the retained capacity after failure. The cycle life and retained capacity for each build is summarized in Table 8. Table 8 also summarizes the statistics and variability for the Time Balanced Frequency Regulation test. The maximum voltage achieved during cycling is reported as the Max Voltage on Charge in the right-most column below (see FIG. 9).

TABLE 7
Components of electrodes used in Time Balanced Frequency Regulation Testing

| Test Sample No. | NAM Components |
|---|---|
| V-1 | 1.0% Carbon Material 1, 0.1% Carbon Black†,0.2% Lignin‡ |
| V-2 | 0.3% Carbon Black†, 0.2% Lignin‡, 0.12% polyaspartic acid |
| V-3 | 1.0% Carbon Material 1, 0.1% Carbon Black†, 0.2% Lignin‡, |
| | 0.12% polyaspartic acid* |

†Carbon black was Agglomerated Carbon 2
‡Lignin was Vanisperse HT-1 (Borregaard LignoTech, Sarpsborg, Norway)
*Baypure DS 100 (40% solution)

TABLE 8
Summary of test cells used in Time Balanced Frequency Regulation.

| Test | Cycles until | | Retained | | |
|---|---|---|---|---|---|
| Sample | 1.6V | | Capacity | | MaxVoltage |
| No. | Failure | σ (Cycles) | (Ah) | σ (Capacity) | on Charge |
| V-1 | 265 | ±30 | 93% | ±1% | 2.75 V |
| V-2 | 206 | ±30 | 94% | ±3% | 2.75 V |
| V-3 | 286 | ±60 | 90% | ±6% | 2.73 V |

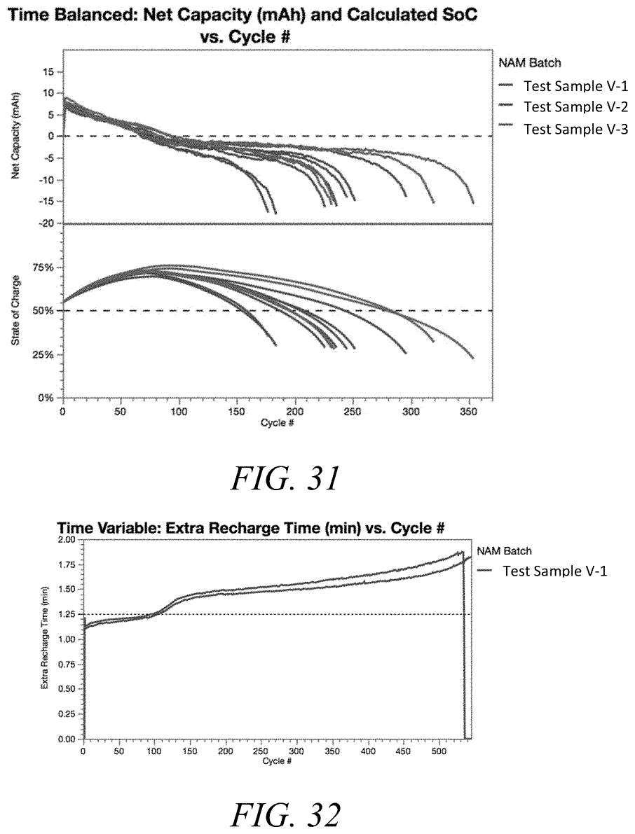

In order to evaluate the state-of-charge balance, the net capacity was calculated for each cycle by subtracting the total capacity discharged from the total capacity charged. The net capacity is then graphed as a function of cycle number (FIG. 31 bottom panel). This graph reveals three regions that appear to be governed by different mechanisms. The first region is from the beginning of cycling until cycle 100 where the cell initially has a low resistance to charge but then slowly gains charge resistance at a fairly constant rate. The second region appears to maintain a steady resistance to charging in a region that is “net negative” for capacity balance. The third region is the rapid decay towards failure of the test cell. A net capacity calculation can be used to create an effective state-of-charge for the cells over the course of testing (FIG. 31, top panel).

The magnitude of difference between the net capacity and net zero capacity in the second region directly correlates with the cycle life of the test cell. Cells that have a net capacity closer to zero have a longer cycle life.

Cells containing Test Samples V-1 and V-3 exhibit net capacities that are closer to zero in this second region than cells containing Test Sample V-2, which suggests that the cells with Test Samples V-1 and V-3 have less resistance to charging when the second region's cycling mechanism becomes dominant. All cells end up with a net negative capacity in the second region.

### Time Variable Frequency Regulation

The automated cycling procedure automatically balanced the charge capacity against the discharge capacity by increasing the step time of the last low-power charge until the state-of-charge was replenished. The net capacity remained zero throughout the test and the recharge time required to balance the state-of-charge was measured over the course of cycling. As the number of cycles increases, the increase in charge resistance is measured as the increased time to balance the state-of-charge (FIG. 32). Initial testing was used for cells including Test Sample V-1.

Cells were cycled for 550 cycles before falling to 1.6V while retaining 98% of the initial capacity. The maximum voltage measured during this test was 2.80 V, which is slightly higher than the maximum voltage of 2.75V observed for the Time Balanced Frequency Regulation test. Also, the Time Variable Frequency Regulation test doubled the cycle life (i.e., until 1.6V) compared to the Time Balanced Frequency Regulation test.

This test allows calculation of watt-hour (Wh) efficiency as shown in the equation below:

$$Watt Hour Efficiency \% = \frac{Total Watt Hour Discharged}{Total Watt Hour Charged} \times 100 \%$$

In some of the other tests described above, all cells exhibited equivalent watt-hour efficiencies since all constant-power discharge and charge steps lasted for a fixed amount of time. A summary of the calculated watt-hour efficiency is described in Table 4.

TABLE 9
Summary of the calculated watt-hour efficiency according to tests described above

| | | Discharge | Charge Watt- | Watt-Hour |
|---|---|---|---|---|
| Test Version | Cells | Watt-Hour | Hour | Efficiency |
| Unbalanced | All cells | 0.48 Wh/cycle | 0.48 Wh/cycle | 100% |
| Time Balanced | All cells | 0.48 Wh/cycle | 0.55 Wh/cycle | 86.5% |
| Max Power | All cells | 0.48 Wh/cycle | 0.60 Wh/cycle | 80.0% |
| Power Balanced | All cells | 0.48 Wh/cycle | 0.58 Wh/cycle | 82.1% |
| Time Variable | Test Sample | 261.52 Wh total | 309.72 Wh total | 84.4% |
| | V-1 (12) | | | |
| | Test Sample | 259.36 Wh total | 306.12 Wh total | 84.7% |
| | V-1 (18) | | | |

### Max Power and Power Balanced Frequency Regulation

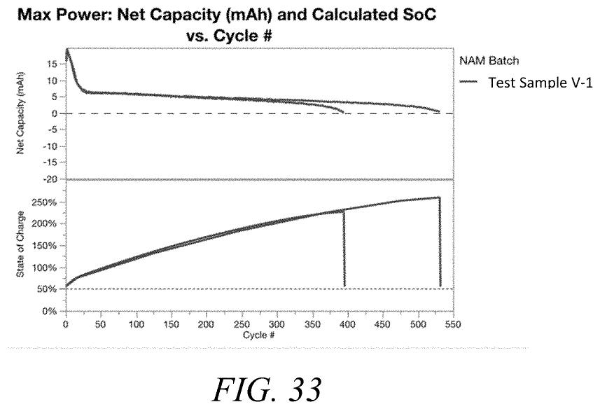

Test samples were tested for their ability to handle high voltages and high currents by testing the maximum charge power in accordance with the IEC standard to observe the change in cycling. Initial testing was carried out on cells containing Test Sample V-1 after subjecting them to the Unbalanced Frequency Regulation as described above. It was observed that cells maintained functional voltages for an average of 475 cycles prior to dropping to 1.6V while retaining 87% of the initial capacity. Charging voltages reached a maximum voltage of 2.95V, the highest voltage of any of the test versions. Cycling was evaluated by calculating the net capacity for each cycle and the effective state-of-charge for each cell as a function of cycle life (FIG. 33). A similar three regions appear in the net capacity graph as they did in Time Balanced Frequency Regulation (section above), but with the second region existing in a net positive capacity balance instead of a net negative capacity balance. The state-of-charge far exceeds 100% due to this net positive capacity compensation, which leads to a cell failure from overcharging.

### Example 6

### Nitrogen Sorption of Negative Active Material

In order to better characterize the differences of carbon products when utilized in a lead-acid paste, a series of adsorption experiments were conducted using the Micromeritics Tristar II 3020 adsorption system. The effects of carbon loading on lead-acid negative active materials (NAMs) was quantified utilizing BET specific surface area (SSA) and pore volume (PV). The experimental design focuses on both cured and formed NAM electrodes that incorporate Carbon Material 1 and Carbon Material 2. The addition of high surface area carbon increases the overall surface area of the NAM electrodes with Carbon Material 2 providing the largest boost in surface area as carbon loading increases.

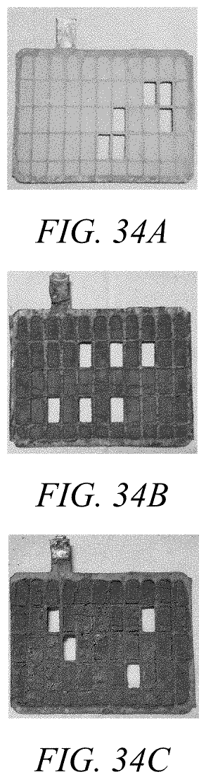

In order to produce reliable measurements, initial focus was on the preparation of the NAM samples. Electrode samples were removed from pasted lead grids at varying points in lead-acid 2V fabrication. Once a lead paste is applied to a lead grid, the electrode can exist in three major states: cured, formed, and cycled (FIGS. 34A-C). Cured electrodes mostly consist of leady oxide and have not experienced any applied currents/voltages. Formed electrodes have been prepared into a 2V cell assembly and have completed the constant current formation electrochemical protocol. These electrodes will mostly consist of porous, metallic lead. Cycled electrodes have experienced multiple electrochemical testing profiles after formation and will consist of varying amounts of metallic lead and lead sulfate depending on electrolyte interactions and the state of charge. Cycled electrodes were not investigated in these experiments.

### Sample Mass

The Micromeritics Tristar II 3020 adsorption system requires samples with a high enough surface area to produce reliable adsorption measurements. The disclosed lead electrodes have low surface areas in both cured and formed states. Sample mass was varied to ensure samples were producing results above the instrument's lower limit of quantification. Sample sizes of 1 rectangular punch-out and 3 rectangular punch-outs (˜200 mg and ˜600 mg) from cured NAMs were tested for SSA, PV, and DFT graphs.

TABLE 10
Summary of BET specific surface area (SSA), pore volume (PV)
and mass of Test Sample electrodes

| Test Sample | | | |
|---|---|---|---|
| No. | Mass (mg) | SSA (m²/g) | PV (cm³/g) |
| VI-1a | 216.9 | 21.61 | 0.0206 |
| VI-2a | 193.5 | 21.00 | 0.0204 |
| VI-1b | 642.2 | 21.80 | 0.0222 |
| VI-2b | 566.6 | 21.56 | 0.0222 |

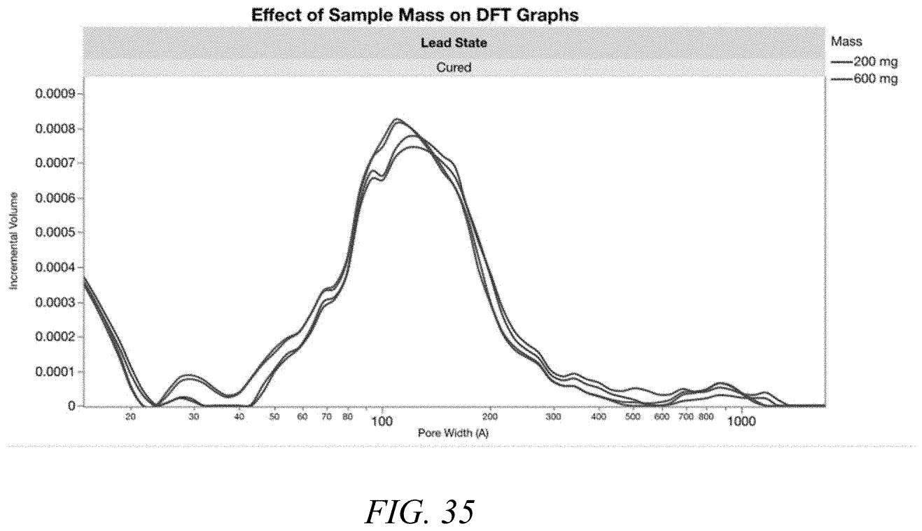

Surface area measurements for both sample masses are equivalent. However, the pore volume measurements show a slight increase with the higher mass loading. This is reflected in the graph (FIG. 35) which depicts a strong representation of bulk material pore structure. To ensure a better sampling of the average pore structure of a lead electrode, sorption testing as conducted with ˜600 mg of NAM.

### Form Factor

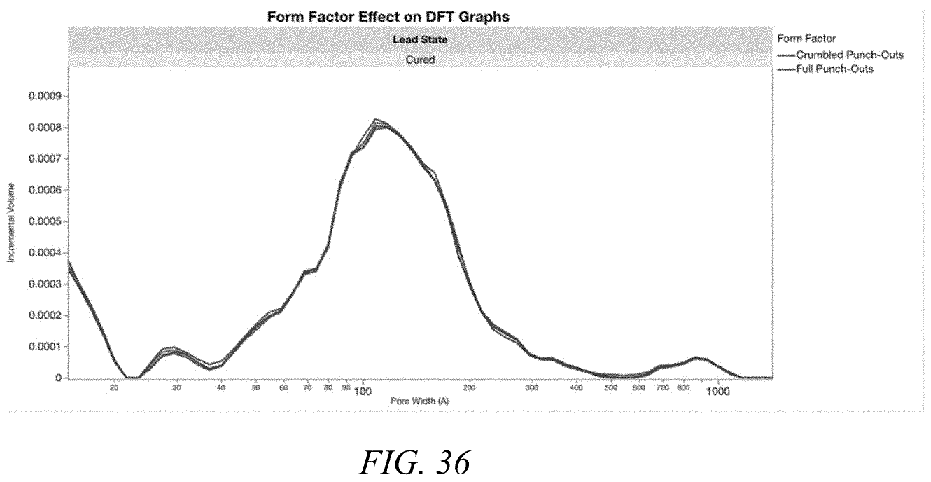

To understand the effect of sample form factor on the measured SSA and PV, intact punch-out samples were compared to crumbled punch-outs. No major difference was observed for measured SSA or pore structure (FIG. 36).

TABLE 11
BET specific surface area and pore volume for samples in
different forms having different compositions

| Test Sample | | | |
|---|---|---|---|
| No. | Form Factor | SSA (m²/g) | PV (cm³/g) |
| VI-1a | Crumbled | 21.95 | 0.0224 |
| VI-2a | Crumbled | 21.31 | 0.0221 |
| VI-1a | Full | 21.80 | 0.0222 |
| VI-2a | Full | 21.56 | 0.0222 |

### Degas Parameters

Cured NAM samples were placed under vacuum for 18 hours and 72 hours at 200° C.

TABLE 12
Samples tested using variable degas times

| Test Sample | | | |
|---|---|---|---|
| No. | Degas Time | SSA (m²/g) | PV (cm³/g) |
| VI-3 | 18 hours | 3.70 | 0.0080 |
| VI-4 | 18 hours | 3.87 | 0.0080 |
| VI-5 | 18 hours | 3.96 | 0.0087 |
| VI-3 | 72 hours | 3.60 | 0.0070 |
| VI-4 | 72 hours | 5.57 | 0.0076 |
| VI-5 | 72 hours | 3.82 | 0.0076 |

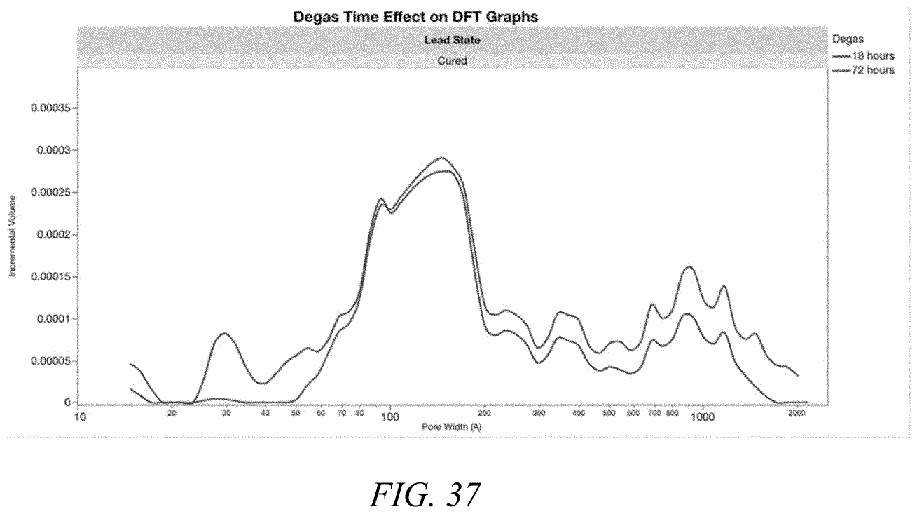

The adsorption testing revealed that the degas time has a negligible impact on the calculated BET specific surface area (SSA), but reduces the total pore volume (PV). FIG. 37 shows the decrease in total pore volume is due to a collapse of pores having a diameter 20 Å-90 Å.

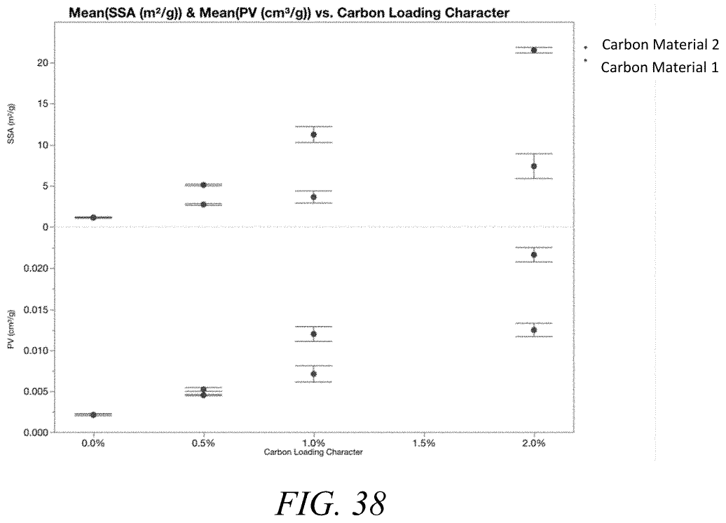

Initial experimentation showed that the carbon loading of both Carbon Material 1 and Carbon Material 2 in a lead paste had an effect on the total BET specific surface area and total pore volume of the cured NAMs. Adsorption samples were collected for 0.5%, 1.0%, and 2.0% carbon loadings for Carbon Material 1 and Carbon Material 2. A strong correlation between carbon loading and SSA and PV measurements is observed (FIG. 38). Also, the higher SSA and PV of Carbon Material 2 provide for higher SSA and PV NAMs.

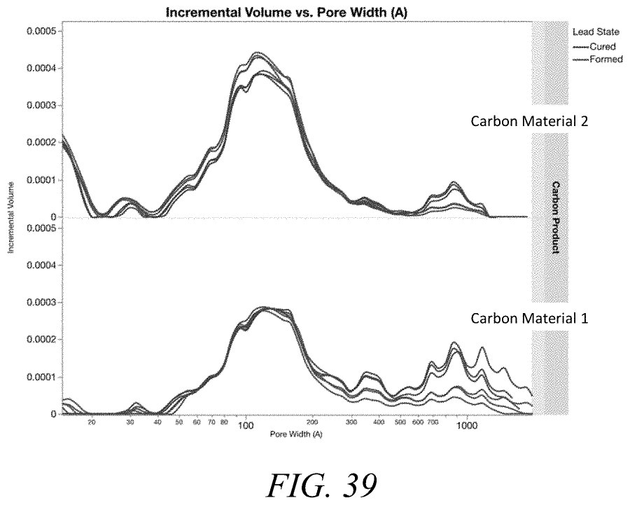

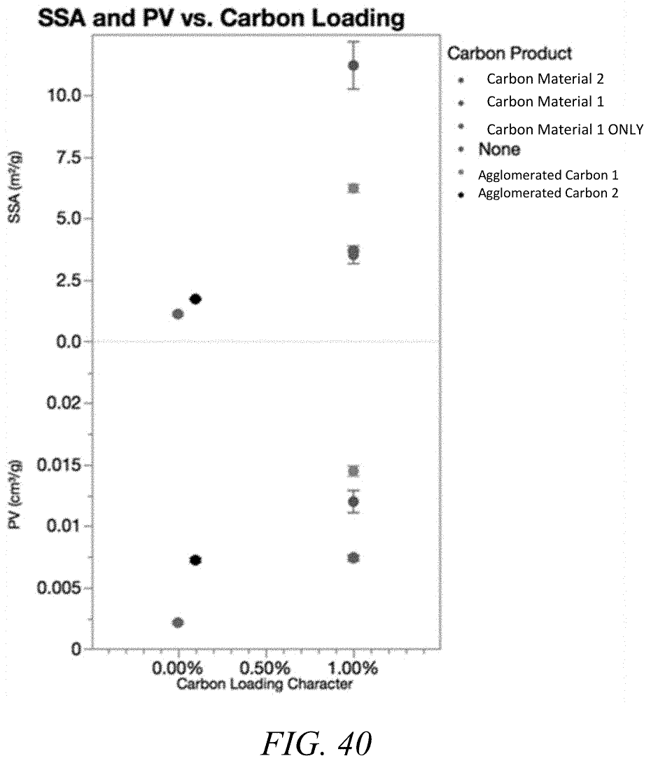

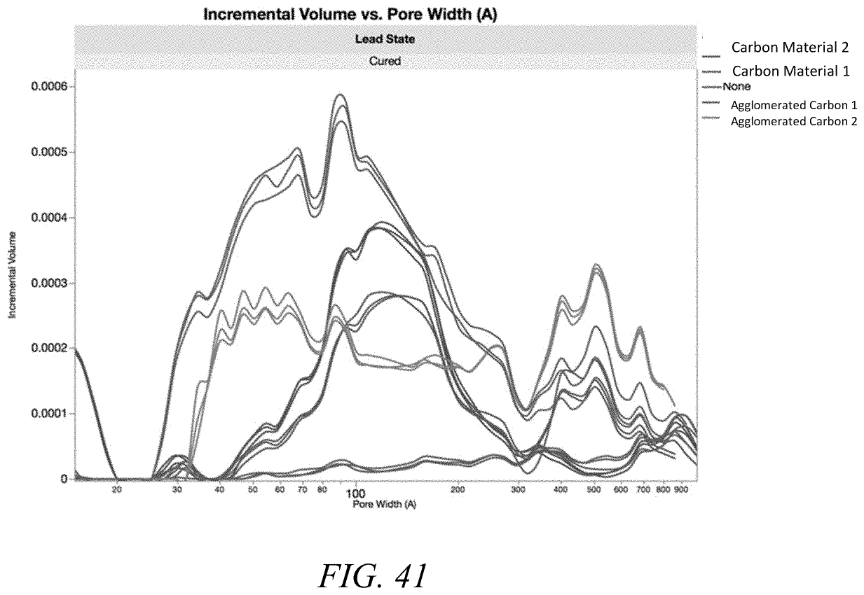

Sorption testing is also utilized to help understand the changing morphology of a NAM as it is formed from its cured state. Three NAMs for Carbon Material 1 and three NAMs for Carbon Material 2 were sampled before and after formation to analyze the change in SSA and PV (FIG. 39). Sorption data suggests a decrease in both SSA and PV after formation for Carbon Material 1 and Carbon Material 2. Through comparing DFTs, formation results in a decrease in pore volume most notably in the 600 Å-1000 Å range.

TABLE 13
Cured and formed samples containing Carbon Materials 1 and 2
were tested for BET specific surface area and pore volume

| | | Cured | | Formed | |
|---|---|---|---|---|---|
| | Test Sample | SSA | PV | SSA | PV |
| Carbon | No. | (m²/g) | (cm³/g) | (m²/g) | (cm³/g) |
| Carbon | VI-6 | 12.22 | 0.0129 | 10.77 | 0.0114 |
| Material 2 | VI-7 | 11.92 | 0.0126 | 9.79 | 0.0108 |
| | VI-8 | 12.03 | 0.0128 | 10.66 | 0.0114 |
| Carbon | VI-9 | 4.04 | 0.0077 | 2.51 | 0.0051 |
| Material 1 | VI-10 | 4.01 | 0.0076 | 2.89 | 0.0061 |
| | VI-11 | 3.92 | 0.0079 | 2.64 | 0.0056 |

BET SSA and PV measurements show carbon materials can be used to increase electrode SSA and PV. By changing the concentration and type of the added carbon material, the SSA and PV can be adjusted.

### Example 7

### Reference Electrodes

A 3-electrode system was used to provide individual voltages for both negative active material (NAM) and positive active material (PAM) electrodes in a lead-acid system. An Hg/Hg₂SO₄ reference electrode was implemented into multiple 2V lead-acid cells to determine the benefits of a 3-electrode electrochemical set up.

The reference electrode was coupled with the NAM to directly measure the NAM voltage and calculate the PAM voltage from the total cell voltage. The reference was used throughout the life of the battery to measure individual voltages during formation, capacity tests, charge acceptance, gassing, HPPC, and HRPSoC. Voltage drift of reference electrodes was observed and long-term stability of the reference electrodes was monitored.

Hg/Hg₂SO₄ electrodes were added to the 2V lead-acid test cells utilizing auxiliary channels on the batter testing terminals. All lead-acid cells use NAMs containing 1.0% Carbon Material 2 with 0.1% carbon black. Reference electrodes were numbered and their voltages were catalogued against a master reference electrode before and after use in sulfuric acid electrolyte.

Existing lead-acid formation studies were accompanied with reference electrode data. Formation studies proceeded through all electrochemical testing procedures stated above. Additional 2V cells were produced to investigate HRPSoC protocols, a symmetric 60 second 2C constant-current charge/discharge and an asymmetric 2C constant-current charge for 90 seconds and discharge for 60 seconds. Both protocols have a 3V limit, a 1.7V cycling cutoff, and a threshold of 70% capacity to allow for a recharge and continued cycling.

### Gassing Scan

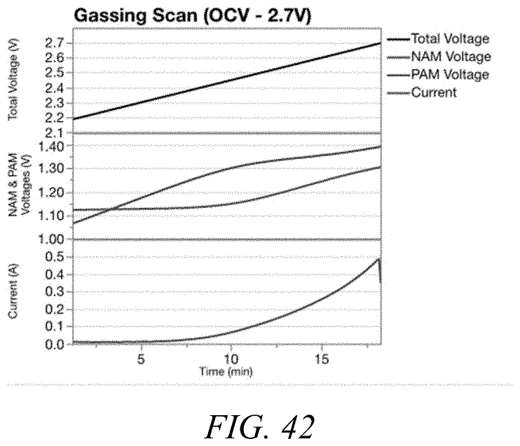

Reference electrodes were used to distinguish the voltages at which gassing rates accelerate as the total cell voltage is brought to 2.7V. Scanning showed an increase in current produced as the NAM voltage reaches 1.3V and the PAM voltage begins to increase above 1.15V (FIG. 42).

### High-Rate Partial-State-of-Charge Cycling (HRPSoC)

HRPSoC testing provided insight into the failure mechanisms of 2V cells under different duty cycles when reference electrodes were used. Electrode polarization during cycling was monitored and showed whether the PAM or NAM voltage drove the total voltage to drop below 1.7V and whether the PAM or NAM limited the total capacity to prevent recharging and continued cycling.

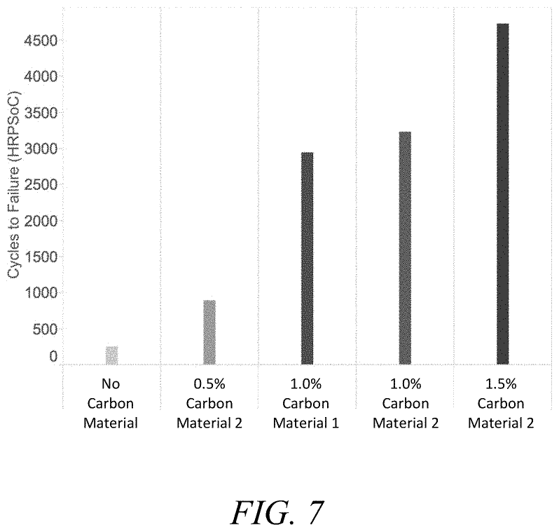

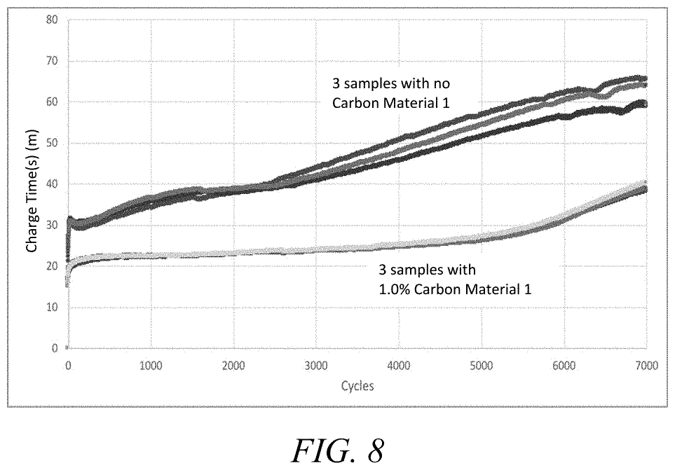

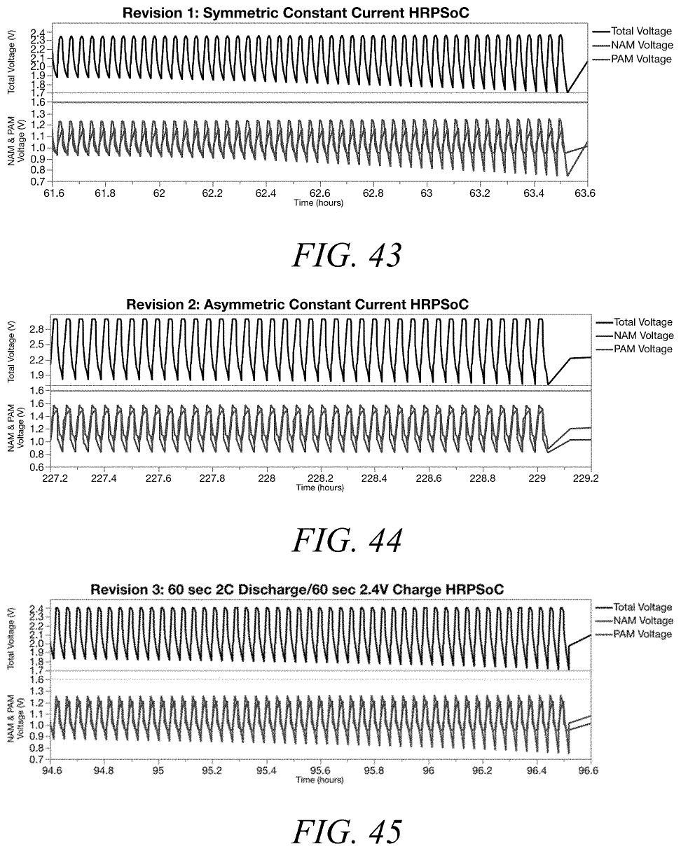

All three duty cycles tested showed the PAM voltage drove the cycling end condition of a 1.7V total voltage while the NAM voltage remained stable in comparison. This result suggested our 2V cells were PAM failing during our HRPSoC testing. FIGS. 43, 44 and 45 show PAM cycle voltages widen as cycling progressed over time while the NAM cycle voltages remained consistent. The total voltage dropped to 1.7V and triggered a cycling end condition (see also FIGS. 6-8).

### Example 8

### Motive Drive Cycle without Regenerative Braking

Two groups of 2V lead-acid cells were enhanced with Carbon Material 1 and assigned Group A and Group B, respectively. Group A and Group B cells were tested with a motive drive cycle with (Group A) and without (Group B) applying a regenerative charging current during braking events.

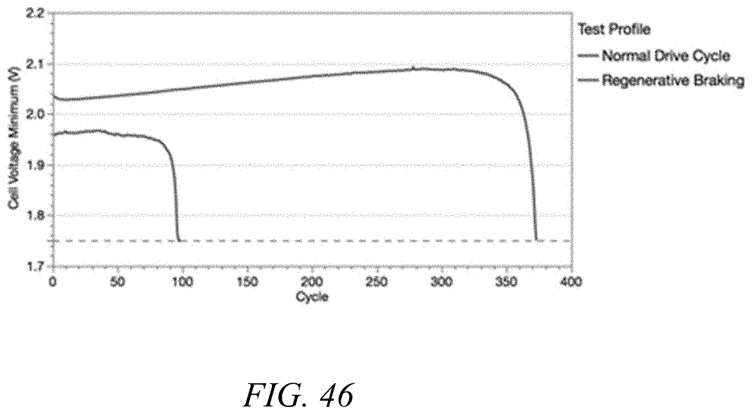

Group B cells cycled for and average of 73 cycles and Group A cycled for an average of 337 cycles, or a 362% increase in cycle life. The ending state of charge during cycling was approximately 65% for Group A and 10% for Group B. The results showing minimum cell voltage over the cycle testing for a Groups A and B are shown in FIG. 46.

### Example 9

### Comparative Regenerative Braking Profiles

One group of 2V lead-acid cells were prepared with Carbon Material 1 (Group C). Another group of 2V lead-acid cells were prepared with 0.1% of low structured carbon black (Group D). A third group of 2V lead-acid cells were prepared with expanded graphite (Group E). Groups C, D, and E were put through a regenerative braking profile with a minimum voltage as an end condition to measure time spent discharging (as a simulation of driving) as a function of cycle life.

Cells in Group D and Group E measured no difference in individual cycle drive times, total drive time, and cycle life. Cells in Group C measured a cycle life up to 3× longer than cells from both Group D and Group E while retaining above 70% of the initial capacity. Cells from Group C also provided up to a 28% extension in drive time per individual recharge (cycle) in comparison to cells from Group D and Group E (8.1 hours vs 6.3 hours). Cells from Group C measured a total drive time extension of up to 275% while retaining above 70% of the initial capacity compared to cells from both Group D and Group E (225 hours vs 60 hours). At the point of failure (equivalent number of cycles) for cells in Group D and Group E, cells in Group C measured a 14% improvement in capacity retention compared to cells in Group C and Group E (73% retained vs 64% retained).

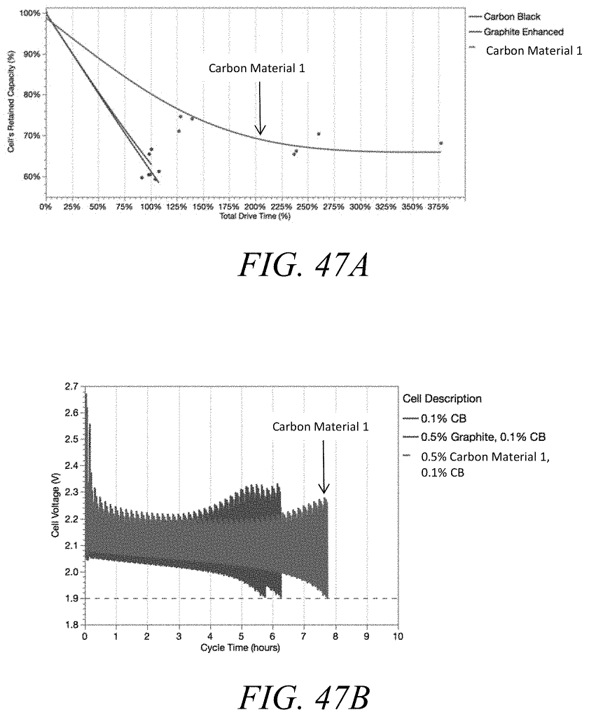

Results for the retained cell capacity as a function of the total drive time for Groups C, D, and E are shown in FIG. 47A. The cell voltage for a single discharge cycle for each group is shown in FIG. 47B.

### Example 10

### Reduced Battery Weight Enabled by Carbon & Regenerative Braking

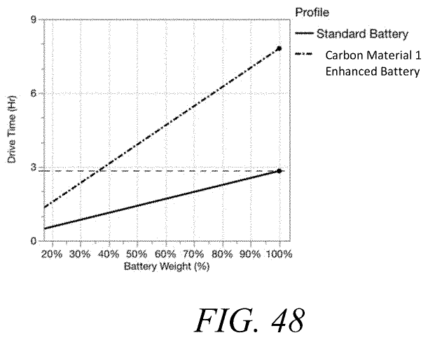

A group of 2V lead-acid cells are prepared with Carbon Material 1 (Group F) with a 50%-60% lower initial capacity than another group of 2V lead-acid cells with 0.1% loading of carbon black (Group G; FIG. 48). Group F cells are tested through a regenerative braking profile with a minimum voltage as an end condition. Group G cells are tested through the same motive drive cycle test without charging currents applied during braking events.

A reduction in total battery weight can be calculated based on available industry weights from batteries with varying capacities. This model suggests that a battery prepared with Carbon Material 1 enables regenerative braking to achieve the same usable drive time as a non-enhanced battery, with 60% reduction in total battery weight while maintaining a constant cycle life.

### Example 11

### Dynamic Charge Acceptance (DCA)

The dynamic charge acceptance of a cell after a history of charge (DCA_{C}) was measured for cells containing 0.5% Agglomerated Carbon 2 and compared to cells containing 0.5% Carbon Material 1. DCA_{C} was measured as follows:

1. The test cell was discharged to 1.75 V at a C/20 rate and capacity was measured

2. The test cell was charged at 2.47 V with a current limit equal to 5× the C/20 current until 80% of the discharged capacity was recharged

3. The test cell was allowed to rest at open-circuit for 20 hours

4. The test cell was charged at 2.47 V with a current limit equal to 33.3× the C/20 current for 10 seconds and the recharged capacity was measured

5. The test cell was allowed to rest at open circuit for 30 seconds

6. The test cell was discharged at a C/20 rate until the capacity charged in step 4 had been discharged

7. The test cell was allowed to rest at open circuit for 30 seconds

8. Steps 4-7 were repeated for a total of 20 cycles and DCA, was calculated by measuring the average charge current over the course of the 20 cycles and normalizing using C/20 capacity

After a history of charge, the A/Ah data points for cells containing 0.5% w/w Agglomerated Carbon 2 were compared to cells containing 0.5% w/w of Carbon Material 1. Cells containing 0.5% w/w of Carbon Material 1 provided a 20% improvement in dynamic charge acceptance (as measured using the average charge current normalized by C/20 capacity) after a history of charge.

Additionally, cells containing no additional carbon were compared to cells with 0.5% w/w Agglomerated Carbon 2 and 0.5% w/w of Carbon Material 1. The results for A/Ah data points comparing dynamic charge acceptance after a history of charge are shown in Table 14, below.

TABLE 14
Comparative dynamic charge acceptance results
for representative example compositions relative
to composition containing no additional carbon

| Sample | % Improvement |
|---|---|
| No Additional Carbon | — |
| 0.5% Agglomerated Carbon 2 | 13% |
| 0.5% Carbon Material 1 | 35% |

While the present disclosure has been described with reference to exemplary embodiments and examples, these embodiments and examples are not intended to limit the scope of the present disclosure. Rather, it will be apparent to those skilled in the art that various modifications and variations can be made in the present disclosure without departing from the spirit or scope of the invention. Thus, it is intended that the present disclosure cover the modifications and variations of the present disclosure provided they come within the scope of the appended claims and their equivalents.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A composition comprising:
leady oxide or metallic lead;
a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns; and
an expander.

2. The composition of claim 1, wherein the metallic lead is
porous metallic lead.

3. (canceled)

4. The composition of claim 1, wherein the composition further comprises polyaspartic acid or salts thereof, carbon black, or both.

5. The composition of claim 1, wherein the expander comprises barium sulfate, strontium sulfate, lignin, sulfonated naphthalene condensate or combinations thereof.

6.-10. (canceled)

11. The composition of claim 1, wherein the composition further comprises carbon black at a concentration up to about 0.3% by weight of the composition.

12. The composition of claim 1, wherein the composition further comprises carbon black at a concentration ranging from greater than about 0.01% to about 0.5% by weight of the compositions;
wherein the expander has a concentration ranging from greater than 0% to about 3.5% by weight of the composition;
wherein the concentration of the carbon material ranges from about 0.01% to about 4.5% by weight of the composition; or
a combination thereof.

13.-23. (canceled)

24. The composition of claim 1, wherein the carbon material has a BET specific surface area greater than about 200 m²/g;
wherein the carbon material has a total pore volume greater than about 0.2 cc/g;
wherein the carbon material has a particle size is greater than about 7.5 microns;
wherein the carbon material has an aggregate size less than 150 microns; or
a combination thereof.

25.-51. (canceled)

52. The composition of claim 1, wherein the particle size is determined by optical microscopy, laser diffraction, scanning electron microscopy or combinations thereof.

53.-57. (canceled)

58. The composition of claim 1, further comprising water, sulfuric acid, or both.

59. (canceled)

60. The composition of claim 1, wherein the carbon material comprises less than 30 ppm iron, less than 30 ppm copper, less than 20 ppm nickel, less than 20 ppm manganese, and less than 10 ppm chlorine as determined by TXRF;
wherein the carbon material has a total impurity content of less than 1000 ppm as determined by TXRF; or
both.

61.-65. (canceled)

66. The composition of claim 60, wherein the impurities are elements having an atomic number ranging from 11 to 92.

67. The composition of claim 1, wherein the ash content of the carbon material is less than 0.03% as calculated from total reflection x-ray fluorescence;
wherein the carbon material has a pore structure comprising micropores and mesopores and a total pore volume, and wherein from 20% to 90% of the total pore volume resides in micropores, from 10% to 80% of the total pore volume resides in mesopores and less than 10% of the total pore volume resides in pores greater than 300 angstroms; or
both.

68. (canceled)

69. (canceled)

70. An electrode comprising the composition of claim 1.

71. An electrode comprising a negative active material,
the negative active material comprising the composition of claim 1.

72. The electrode of claim 71, wherein the negative active material has a BET specific surface area greater than about 1.5 m²/g;
wherein the negative active material has a total pore volume greater than about 0.003 cc/g;
wherein from about 30% to about 80% of the total pore volume of the negative active material is mesopore volume; or
a combination thereof.

73.-79. (canceled)

80. A cell comprising:
a) at least one positive electrode comprising positive active material; and
b) at least one negative electrode according to claim 71,
wherein:
the positive electrode and the negative electrode are separated by an inert porous separator.

81. The cell of claim 80, wherein the cell has an operating voltage ranging from about 1 to about 4 volts;
wherein a capacity returned to the cell after charging for 15 minutes at 2.4 V is greater than 15% of the rated C/20 capacity when the cell is charged from 80% state of charge;
wherein the cell produces a peak current greater than a current equivalent to a 5C rate about 10 milliseconds to 5 seconds after applying a constant 2.4 V charge when the cell is charged from 80% state of charge;
wherein the cell has a recharge time of less than 8 hours when discharged at a C/20 rate to 20% state of charge and recharged at 2.6 V with a current limitation equivalent to a C/2 rate;
wherein the cell maintains a voltage greater than 1.7 V for more than about 1,500 cycles between about 50% and about 100% state of charge, wherein a cycle comprises a 60 second 2C discharge and a 60 second 2.4V charge with no current limitation;
wherein the cell is discharged for a 60 second 2C discharge thereby discharging a capacity and charged at 2.4V with no current limitation for a time necessary to recharge the cell with the capacity, wherein the time necessary is less than about 30 seconds;
wherein the cell has been subjected to about 1 to 4,000 cycles, wherein a cycle comprises the 60 second 2C discharge and the 2.4V charge with no current limitation; or
a combination thereof.

82.-106. (canceled)

107. A first cell having a negative electrode comprising a composition according to claim 1, wherein the first cell has at least a 25% increase in cycle life compared to a second cell, wherein cycle life is a number of cycles performed while an observed voltage remains within a range of 1.6V to 2.67V, wherein a cycle comprises testing a cell with the following:
a first low-power discharge at 1.1 W₁ for about 120 seconds;
a first high-power discharge at 2.2 W₁ for about 60 seconds;
a first low-power charge at 1.1 W₁ for about 120 seconds;
a first high-power charge at 2.2 W₁ for about 60 seconds;
a second low-power discharge at 1.1 W₁ for about 120 seconds;
a second high-power discharge at 2.2 W₁ for about 60 seconds;
a second low-power charge at 1.1 W₁ for about 120 seconds;
a second high-power charge at 2.2 W₁ for a time required for a first capacity to equal to a second capacity;
wherein
the first capacity is the total capacity discharged during the first low-power discharge step, the first high-power discharge step, the second low-power discharge step and the second high-power discharge step;
the second capacity is the total capacity charged during the first low-power charge step, the first high-power charge step, the second low-power charge step and the second high-power charge step;
W₁ is a power value determined by a 1C rated current multiplied by a nominal cell voltage; and
the second cell comprises a negative electrode comprising a composition that is identical to the composition of the negative electrode of the first cell except that the negative electrode of the second cell does not include the carbon material.

108. The first cell of claim 107 having at least a 30% cycle life increase compared to the second cell.

109.-115. (canceled)

116. A first cell having a negative electrode comprising a composition according to claim 1, wherein
the first cell having a first recharge time that is at least 30% less than a second recharge time of a second cell,
the second cell comprises a negative electrode comprising a composition that is identical to the composition according to claim 1 except the negative electrode of the second cell does not include the carbon material,
wherein
the first recharge time is the time required to replenish a capacity removed from the first cell during a 60 second 2C discharge by a 2.4V charge with no current limitation; and
the second recharge time is the time required to replenish a capacity removed from the second cell during a 60 second 2C discharge by a 2.4V charge with no current limitation.

117. The first cell of claim 116, wherein the first recharge time is at least 40% less than the second recharge time.

118.-123. (canceled)

124. A battery comprising the cell of claim 80.

125. The battery of claim 124 further comprising an electrolyte.

126. The battery of claim 125, wherein the electrolyte comprises sulfuric acid, water, silica gel, or a combination thereof.

127.-156. (canceled)

157. A regenerative braking system for a vehicle, the system comprising:
a battery comprising a composition, the composition comprising:
leady oxide or a metallic lead;
a carbon material at a concentration ranging from greater than 0.10% to about 5.0% by weight of the composition, the carbon material having a BET specific surface area greater than about 100 m²/g, a total pore volume of greater than about 0.1 cc/g and a particle size greater than about 5 microns; and
an expander.

158. The regenerative braking system of claim 157, wherein the metallic lead is
porous metallic lead.

159. (canceled)

160. A first cell having a negative electrode comprising a composition according to claim 1, wherein:
the first cell has at least a 10% increase of dynamic charge acceptance after a history of charge as measured using an average charge current normalized by C/20 capacity compared to a second cell, wherein the dynamic charge acceptance cycle and the second cell comprises a negative electrode comprising a composition that is identical to the composition of the negative electrode of the first cell except that the negative electrode of the second cell does not include the carbon material; or
wherein the first cell has at least a 10% increase of an average charge current normalized by C/20 capacity of dynamic charge acceptance after a history of charge compared to a second cell, wherein the dynamic charge acceptance cycle and the second cell comprises a negative electrode comprising a composition that is identical to the composition of the negative electrode of the first cell except that the negative electrode of the second cell has carbon black instead of the carbon material.

161. (canceled)

162. The first cell of claim 160, wherein the carbon black has a surface area of about 120 m²/g, an aggregate size of about 175 μm and a pore volume of about 0.25 cc/g;
wherein the first cell has at least a 15% increase of dynamic charge acceptance after a history of charge as measured using average charge current normalized by C/20 capacity compared to a second cell; or
both.

163.-167. (canceled)
